(19) United States
(12) Patent Application Publication
(10) Pub. No.: US 2010/0293048 A1
(43) Pub. Date: Nov. 18, 2010

(54) METHOD AND SYSTEM FOR CONTENT COMPOSITION

(75) Inventors: Adam Singolda, Beit Dagan (IL); Allon Pilberg, Ramat Gan (IL); Daniel Slutsky, Petach Tiqwa (IL); Yaniv Meoded, Kfar Saba (IL); Oded Arbel, Herzeliya (IL)

Correspondence Address: OLIFF & BERRIDGE, PLC, P.O. BOX 320850, ALEXANDRIA, VA, 22320-4850, US

(73) Assignee: TABOOLA.COM LTD., TEL AVIV (IL)

(21) Appl. No.: 12/446,017

(22) PCT Filed: Oct. 18, 2007
(86) PCT No.: PCT/IL07/01249

§ 371 Date: Sep. 24, 2009

Related U.S. Application Data
(60) Provisional application No. 60/852,648, filed on Oct. 19, 2006.
(60) Provisional application No. 60/924,361, filed on May 10, 2007.

(51) Int. Cl. G06F 17/30; G06Q 30/00; G06F 15/16

(52) U.S. Cl. 705/14.43; 705/14.49; 705/14.4; 707/802; 707/748; 709/231; 707/E17.044

(57) ABSTRACT

Systems and methods for associating content. In one embodiment, one or more techniques are used in associating content. In one embodiment, a unified content stream is created which includes two or more content items (or parts thereof) which have been associated with one another, for example a non-advertisement content item such as a video and associated advertisement(s).

### CROSS REFERENCE TO RELATED APPLICATIONS

This application claims the benefit of U.S. provisional applications Ser. No. 60/852,648 filed on Oct. 19, 2006 and Ser. 60/924,361 filed on May 10, 2007, the entire disclosures of which are hereby incorporated by reference herein.

### FIELD OF THE INVENTION

The present invention relates to the field of content, that includes, inter alia, video items, audio items, visual items, advertisements (“ads” or “Ads”), multimedia items, games, rich media items, etc.

### BACKGROUND OF THE INVENTION

With improvements to broadband network infrastructure and the increases in user generated content, the amounts of content available over a network are exploding exponentially. The textual data that are attached to content are often small and not very reliable, if they exist at all. Therefore, collections of items may in some cases be disorganized, and it may be hard in some cases to accurately identify the content of items.

As a result of these problems of disorganization and lack of information, it is difficult for advertisers to guarantee brand-image. Similarly, it is difficult for publishers to keep track of the vast amounts of content and to direct the flow of content toward individual interests. As a byproduct, many of the new items are often ‘starved’ and do not have the opportunity to get noticed, as face time is typically reserved to those items which are already popular.

### SUMMARY OF THE INVENTION

According to the present invention, there is provided a system for associating content, comprising: a content analysis module configured to apply at least one technique in order to associate a first content item with at least one other content item, each at least one technique generating at least one list of at least one associated content item for the first content item ; and a content composition module configured to perform at least one action selected from a group comprising: generating unified content including the first content item, or a part thereof, and at least one content item from at least one of the lists, or a part thereof; and determining, based on a plurality of the lists, at least one aggregated list of at least one content item associated with the first content item.

According to the present invention, there is also provided a system for providing a distribution channel of unified content, comprising a content storage library storing unified content files, each of which was generated from at least two separate content files; a transaction processing module, configured to provide a request for unified content files appropriate for a distribution channel which will be distributed by a distributor website; a content analysis module configured to receive the request and provide to the transaction module a list of descriptors of unified files appropriate for the distribution channel; and a streaming module configured to stream the listed unified files to the distributor website.

According to the present invention, there is further provided a method for associating content, comprising: applying at least one technique in order to associate a first content item with at least one other content item, each at least one technique generating at least one list of at least one associated content item for the first content item; and performing at least one action selected from a group comprising: generating unified content including the first content item, or a part thereof, and at least one content item from at least one of the lists, or a part thereof; and determining, based on a plurality of the lists, at least one aggregated list of at least one content item associated with the first content item.

According to the present invention, there is provided a method of providing a distribution channel of unified content, comprising: receiving a request for unified content files appropriate for a distribution channel which will be distributed by a distributor website; determining a list of descriptors of stored unified content files appropriate for the distribution channel, wherein each of the unified content files was generated from at least two separate content files; and streaming the listed unified files to the distributor website.

According to the present invention, there is also provided a program storage device readable by machine, tangibly embodying a program of instructions executable by the machine to perform a method for associating content, comprising: applying at least one technique in order to associate a first content item with at least one other content item, each at least one technique generating at least one list of at least one associated content item for the first content item; and performing at least one action selected from a group comprising: generating unified content including the first content item, or a part thereof, and at least one content item from at least one of the lists, or a part thereof; and determining, based on a plurality of the lists, at least one aggregated list of at least one content item associated with the first content item.

According to the present invention, there is further provided a computer program product comprising a computer useable medium having computer readable program code embodied therein for associating content, the computer program product comprising: computer readable program code for causing the computer to apply at least one technique in order to associate a first content item with at least one other content item, each at least one technique generating at least one list of at least one associated content item for the first content item; and computer readable program code for causing the computer to perform at least one action selected from a group comprising: generate unified content including the first content item, or a part thereof, and at least one content item from at least one of the lists, or a part thereof; and determine, based on a plurality of the lists, at least one aggregated list of at least one content item associated with the first content item.

According to the present invention, there is provided a program storage device readable by machine, tangibly embodying a program of instructions executable by the machine to perform a method of providing a distribution channel of unified content, comprising: receiving a request for unified content files appropriate for a distribution channel which will be distributed by a distributor website; determining a list of descriptors of stored unified content files appropriate for the distribution channel, wherein each of the unified content files was generated from at least two separate content files; and streaming the listed unified files to the distributor website.

According to the present invention, there is also provided a computer program product comprising a computer useable medium having computer readable program code embodied therein of providing a distribution channel of unified content, the computer program product comprising: computer readable program code for causing the computer to receive a request for unified content files appropriate for a distribution channel which will be distributed by a distributor website; computer readable program code for causing the computer to determine a list of descriptors of stored unified content files appropriate for the distribution channel, wherein each of the unified content files was generated from at least two separate content files; and computer readable program code for causing the computer to stream the listed unified files to the distributor website.

According to the present invention, there is further provided a method for associating content, comprising: an entity sending an input to a website which owns or virtually owns a system for associating content; if due to the input, the system is to output association results or part thereof for a first content item, the system performing at least one action selected from a group comprising: generating unified content including the first content item, or a part thereof, and including at least one content item or a part thereof which was associated with the first content item by the system; and determining, based on a plurality of lists of associated content items generated by the system, at least one aggregated list of at least one content item associated with the first content item; and the entity receiving at least one selected from a group comprising: the unified content or a part thereof, an identifier for downloading the unified content or a part thereof, at least one of the aggregated lists or a part thereof, and at least one associated content item listed on at least one of the aggregated lists.

According to the present invention, there is yet further provided a method of distributing a distribution channel of unified content, comprising: a distributor website transmitting a request for unified content files which are appropriate for a distribution channel to a website which owns or virtually owns a system for providing a distribution channel of unified content; the system determining a list of descriptors of stored unified content files appropriate for the distribution channel, wherein each of the unified content files was generated from at least two separate content files; and the system streaming the listed unified files to the distributor website.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates various system solutions, in accordance with certain embodiments of the invention;

FIG. 2 illustrates examples of system owners, in accordance with certain embodiments of the invention;

FIG. 3 illustrates an example of service coverage, in accordance with an embodiment of the invention;

FIG. 4 illustrates a system architecture, in accordance with an embodiment of the invention;

FIG. 5 is a flow diagram of a method of associating content, in accordance with an embodiment of the invention;

FIG. 6 is a block diagram of a content analysis module, in accordance with an embodiment of the invention;

FIG. 7 illustrates one example of operation of a text analysis module for enrichment, in accordance with an embodiment of the invention;

FIG. 8 illustrates an example of a 2-dimensional graphical view generated by a dimension reduction module, when applied to vectors generated by the text analysis module for enrichment, in accordance with an embodiment of the invention;

FIG. 9 (comprising both FIG. 9A and FIG. 9B) illustrates an example of graphs generated by multiple choices of dimensions in a dimension reduction module, when applied to vectors generated by the text analysis module for enrichment, in accordance with an embodiment of the invention;

FIG. 10 illustrates one example of operation of the text analysis module for classification, in accordance with an embodiment of the invention;

FIG. 11 illustrates one example of operation of an event handling module, in accordance with an embodiment of the invention;

FIG. 12 illustrates one example of a quick hits algorithm, in accordance with an embodiment of the invention;

FIG. 13 illustrates one example of a focused algorithm, in accordance with an embodiment of the invention;

FIG. 14 illustrates one example of a category algorithm, in accordance with an embodiment of the invention;

FIG. 15 illustrates one example of a collaborative filtering algorithm, in accordance with an embodiment of the invention;

FIG. 16 illustrates one example of an associative collaborative filtering algorithm, in accordance with an embodiment of the invention;

FIG. 17 illustrates one example of a method for a content composition module producing an aggregated list of associated content, in accordance with an embodiment of the invention;

FIG. 18 (comprising both FIG. 18A and FIG. 18B) is a flow diagram of a method of associating content, in accordance with an embodiment of the invention;

FIG. 19 is a flow diagram of a method of associating content, in accordance with an embodiment of the invention;

FIG. 20 illustrates a system architecture that is utilized in accordance with a certain mode of operation, in accordance with an embodiment of the invention;

FIG. 21 is a flow diagram of a sequence of operations in accordance with the system architecture of FIG. 20;

FIG. 22 is another flow diagram of a sequence of operations, related to FIG. 21, in accordance with the system architecture of FIG. 20;

FIG. 23 illustrates a system architecture that is utilized in accordance with a certain mode of operation, in accordance with an embodiment of the invention;

FIG. 24 is a flow diagram of a sequence of operations in accordance with the system architecture of FIG. 23;

FIG. 25 is another flow diagram of a sequence of operations, related to FIG. 24, in accordance with the system architecture of FIG. 23;

FIG. 26 illustrates a system architecture that is utilized in accordance with a certain mode of operation, in accordance with an embodiment of the invention;

FIG. 27 is a flow diagram of a sequence of operations in accordance with the system architecture of FIG. 26;

FIG. 28 is another flow diagram of a sequence of operations, related to FIG. 27, in accordance with the system architecture of FIG. 26;

FIG. 29 illustrates a system architecture that is utilized in accordance with a certain mode of operation, in accordance with an embodiment of the invention;

FIG. 30 is a flow diagram of a sequence of operations in accordance with the system architecture of FIG. 29;

FIG. 31 illustrates a system architecture that is utilized in accordance with a certain mode of operation, in accordance with an embodiment of the invention;

FIG. 32 is a flow diagram of a sequence of operations in accordance with the system architecture of FIG. 30;

FIG. 33 illustrates a system architecture that is utilized in accordance with a certain mode of operation, in accordance with an embodiment of the invention; and

FIG. 34 is a flow diagram of a sequence of operations in accordance with the system architecture of FIG. 33.

### DETAILED DESCRIPTION OF EXEMPLARY EMBODIMENTS

As used herein, the phrase “for example,” “such as” and variants thereof describe non-limiting embodiments of the present invention.

Unless defined otherwise, all technical and scientific terms used herein have the same meaning as commonly understood by one of ordinary skill in the art to which this invention belongs. Generally (although not necessarily), the nomenclature used herein are well known and commonly employed in the art.

In some embodiments, the terms online and offline as used herein should be understood to connote relative time durations to each other, where online comprises a shorter time duration than offline, for example a shorter time to respond. In any implementation of these embodiments, an appropriate decision may be made on the maximum time duration that may be considered online.

Reference in the specification to “one embodiment”, “an embodiment”, “some embodiments”, “another embodiment”, “other embodiments” or variations thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments”, or variations thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Some embodiments of the present invention are primarily disclosed as a method and it will be understood by a person of ordinary skill in the art that an apparatus such as a conventional data processor incorporated with a database, software and other appropriate components may be programmed or otherwise designed to facilitate the practice of the method of the invention.

Unless specifically stated otherwise, as apparent from the following discussions, it is appreciated that throughout the specification discussions, utilizing terms such as, “processing”, “computing”, “calculating”, “determining”, “generating”, “associating” “providing”, “applying”, “generating”, “matching”, “taking”, “selecting”, “receiving”, “adjusting”, “analyzing”, “evaluating”, “re-evaluating”, “changing”, “enhancing”, “creating”, “unifying”, “enriching”, “performing”, “searching”, “considering”, “becoming aware”, “ranking”, “optimizing”, “verifying”, “causing”, “outputting”, streaming, “facilitating”, “examining”, “sensing”, “storing”, “transmitting”, “using” or the like, refer to the action and/or processes of any combination of hardware, software and/or firmware. For example, in one embodiment, a computer or computing system, or processor or similar electronic computing device, may manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may use terms such as, processor, architecture, computer, apparatus, system, sub-system, module, unit and device (in single or plural form) for performing the operations described herein. These terms, as appropriate, refer to any combination of software, hardware and/or firmware configured to perform the operations as defined and explained herein. The module(s) (or counterpart terms specified above) may be specially constructed for the desired purposes, or may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The methods/processes/modules (or counterpart terms for example as specified above) presented herein are not inherently related to any particular system or other apparatus, unless specifically stated otherwise. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of some of the embodiments described herein.

Described herein are embodiments for associating content. Examples of types of content include inter-alia video items, audio items, visual items, advertisements, multimedia items, rich media items, games, etc. In various embodiments, an advertisement may include inter-alia video, audio, text, picture, visual, ecommerce, banner, etc. Depending on the embodiment, a content item may be associated with content item(s) of the same type, with content item(s) of predefined different type(s), with content item(s) of either the same type and/or of predefined different type(s), or with content item(s) of any type. For example in various embodiments, a video item may only be associated with other video item(s), may only be associated with advertisement(s), may only be associated with other video item(s) and/or advertisements, or may be associated with content item(s) regardless of type. Depending on the embodiment, the association may be performed online and/or offline.

In the description herein, the user who is using the content item is also called “content consumer”. Examples of a content consumer consuming (i.e. currently using) a content item includes inter-alia watching a streaming video item, listening to an audio item, playing an online game, etc. Continuing the example with existing websites, a content consumer may be watching a video on youtube.com™, listening to music on musicovery.com™ or playing a game on Yahoo!™ Games. Some of the embodiments described in more detail herein allow for association of content which considers any of the following inter-alia: previously or at the same time consumed content, usage patterns and/or other user data, the behavior and actions of consumers as they consume items and/or other events, and/or other understandings generated by systems of these embodiments.

Some of the embodiments described in more detail herein includes content unification, whereby a content stream (“unified content”) is created which includes two or more content items (or parts thereof) which have been associated with one another by systems of these embodiments. In some of these embodiments unified content is created by attaching some kind of embedded code to some or all of the associated content items.

In some cases of content unification, each unified content stream includes matched advertisement (“ad”) content item(s) (or part thereof) and non-advertisement content item(s) (or part thereof). Depending on the embodiment for these cases, a unified content stream may include a single or a multiplicity of non-advertisement content and a single or a multiplicity of ads resources. In various embodiments where the unified content includes ad(s)s and non-advertisement content item(s), a particular ad may precede non-advertisement content, follow non-advertisement content and/or be integrally combined/in-lined within the non-advertisement content. (In the description herein, a non-advertisement content item may be any content item which is not an advertisement and as such is not limited by type, unless appropriate to the context). For example, assuming the non-advertisement content item is a video item, then depending on the embodiment, one or more advertisements can be interlaced before the video starts, during the video, after the video and/or integrally combined within the video for instance as a banner or a video clip. As another example, assuming the non-advertisement content item is a video item, a dynamic ad may be attached in some part of an uploaded video—start, middle or the end. For instance, this could be an active Ad which allows advertisers to link Ecommerce website selling their items to relevant uploaded content). Continuing with this instance, in one embodiment where the uploaded video is a trailer for a full-length movie, an ad can be placed for a DVD of that movie which is sold on a website such as Amazon.com™

In embodiments with unified content streams, unified content streams can be distributed in any appropriate manner depending on the embodiment, including for example, syndicated using on-line business to business “B2B” or business to customer “B2C” Distribution Channels, websites hosting, through partner channels, and/or on a personal basis (emails, personal blogs, etc).

In other embodiments described in more detail herein, additionally or alternatively to content unification, an indication of associated content may be provided by systems of these embodiments.

In various embodiments, systems and methods may be designed and geared to support varying scales of deployment, for example small, medium or large scale deployments. For example in one embodiment, the system is designed to support large scale deployments geared to serve millions of simultaneous users thus allowing it to leverage the Internet user community as a content producing base.

The technology in some embodiments described herein is virtualized to allow, if desired, re-branding of the technology. For example, in some cases a unified content stream and/or indication of associated content may be re-branded one or more times prior to reaching the content consumer. Continuing with the example, in one embodiment, the technology manages non-advertisement content and/or ads resources to allow any of (non-advertisement) content creators, advertisers, distributors, entities with item sources, content consumers, etc. to submit and consume content. In this example the technology is completely virtualized in order to allow reselling of services by compartmentalizing the management of various entities (e.g. (non-advertisement) content creators, advertisers, distributors, content consumers, entities with items sources, etc) by different technology “resellers” (i.e. owners or virtual owners).

In one embodiment where there is full virtualization using a virtual hosting solution, multiple websites can be hosted on a single system with complete separation of user information, media and statistics.

In some embodiments of the invention, content items are linked to a source (“item source”). In various embodiments, a particular content item may be linked to the source, for example because the source owner produced the item, bought the item from the producer of the item, or otherwise received the item (for example without paying for the item to be linked to the source). An item may be linked strictly to the item source or the item may be allowed to be linked by the item source to another entity, thereby allowing for further distribution of the item.

In various embodiments an item source may be for instance an item repository located at a content producer (creator), a content distributor, a content publisher, etc. Different item sources may vary in one or more factors including the types of items, their size, how the item is linked to the item source, whether the item source is static or dynamic. For example, in one embodiment if the item source is dynamic then content items linked to the source may change while association is being performed by the system or during the interval between consecutive performances of associating by the system.

In other embodiments of the present invention, an item may be linked to more than one item source, or to none at all.

In some embodiments of the present invention an item from a specific item source may only be associated with items from that same specific item source. In other embodiments, the item may be associated with any item previously known to the system and/or currently provided to the system. For example, in some cases, two content items associated with one another are not necessarily linked to the same item source.

In one embodiment, a non-advertisement content item may only be associated with non-advertisement content linked to the same source as the content item, but may be associated with any advertisement content (not necessarily linked to the same item source). In other embodiments, however a content item may only be associated with content (advertisement or non-advertisement) linked to the same source or may be associated with any content (advertisement or non-advertisement).

In one embodiment where advertisement content is associated, the associated advertisement content may be known (i.e. taken from a database that is available as part of the system) and/or may be provided by advertisement web suppliers/web resource(s) (such as for example Google™ AdSense or Yahoo!™ Publisher).

Bearing this in mind, there follows additional description of various embodiments of the invention.

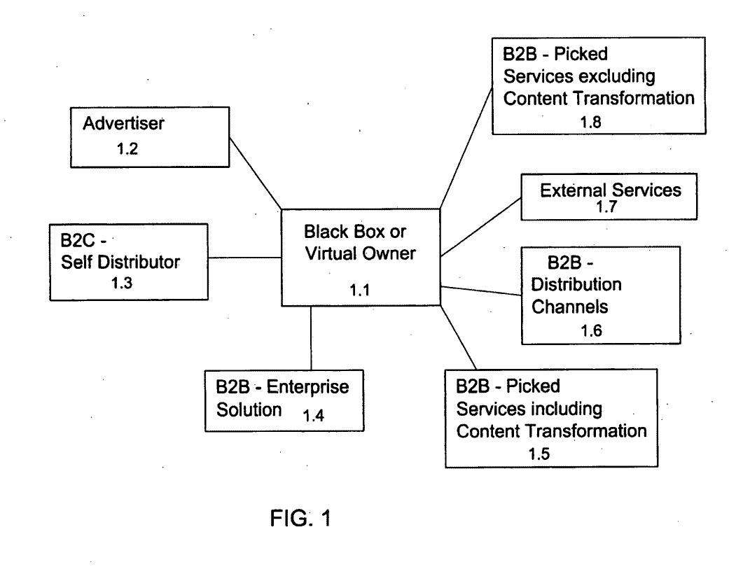

Turning to FIG. 1, FIG. 1 illustrates various system solutions, in accordance with certain embodiments of the invention.

In various embodiments, the system of the current invention can provide several solutions. The black box owner or virtual owner (see definition below) (1.1) may for example configure the system to service any of a large variety of entities: advertisers (1.2), (non-advertisement) content creators and self distributors (1.3), websites distributing content (1.6), publishers transforming their content, for example into revenue-content (1.5), publishers receiving any level of services from the system (1.4, 1.8), website builders, for example, using the web-toolkits zero-installation for immediate deployable solutions (1.7), content creators (i.e. producers), content consumers, etc.

For example in one embodiment of configuration 1.2, advertisers use the system to launch an advertiser campaign.

For example in one embodiment of (B2C—Business to Consumer) configuration 1.3, non-advertisement content creators and self distributors use the system to self distribute associated content (for example by email, personal web page, blogs, etc). In some cases, the content creator may stamp his content.

For example in one embodiment of (B2B—business to business) configuration 1.4, a website uses the system for content management, association service, streaming services and possibly external (web toolkit) services. In this example, the files and management are maintained at the system.

For example in one embodiment of (B2B) configuration 1.5, a website uses the system to associate content and transform associated content into unified content. In this example, the system does not provide hosting, managing, streaming, or external services. In this example, the website manages the unified content and may post-report to the system, for example in order to claim revenues in the case of transmission of advertisements within the unified content.

For example, in one embodiment of (B2B) configuration 1.6, a website acting as a distribution channel presents selected and/or categorized content, for example unified content which may in some cases be domain specific-content.

For example, in one embodiment of configuration 1.7, external services open for community development are configured as part of the system. There may be published an application programming interface API or other type of interface for external modules that can be implemented (for example added as plug-ins). Continuing with the example, in some case the following two services may be provided by the system: a) token based e-commerce where advertisers and/or creators of other types of content can actively sell relevant products using token-partners (for example eBay™) while the system is streaming content. b) search engine for sophisticated searches using the association capabilities of the system.

For example, in one embodiment of (B2B) configuration 1.8, a website uses the system for association services without transformation of content. In this example, the system does not provide hosting, managing, streaming, or external services.

In some embodiments of the present invention, system services may be accessible via the Internet, by any other network, and/or by any other communication means or method, electronic or otherwise. In some embodiments of the invention, various entities can access system services using any of a wide assortment of protocols and using any of a wide array of devices and communication means, present or future ones, including but not limited to, personal computers, web servers, mobile telephones, television sets and any other device able to interface with electronic data.

The various solutions shown in FIG. 1 are expanded upon further below.

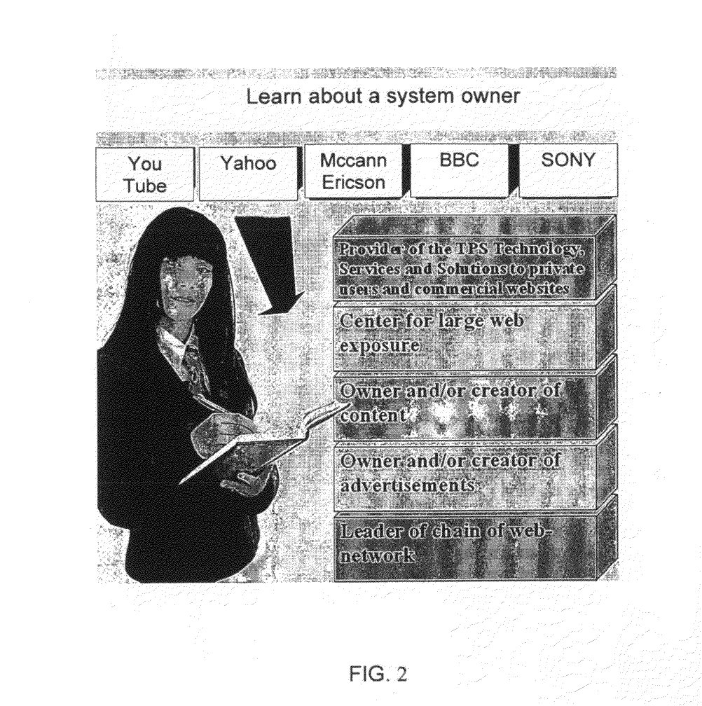

FIG. 2 illustrates possible owners of the system, according to various embodiments of the present invention. In various embodiments, a system may be owned for example by any of the following: a leader of a chain of web-network, an owner and/or creator of advertisements, an owner and/or creator of content, a center for large web exposure, a provider of technology services and solutions to private users and commercial websites, etc. In other embodiments, instead of owning the system, one or more of the above may instead be a virtual owner or may receive services from an owner or virtual owner of the system.

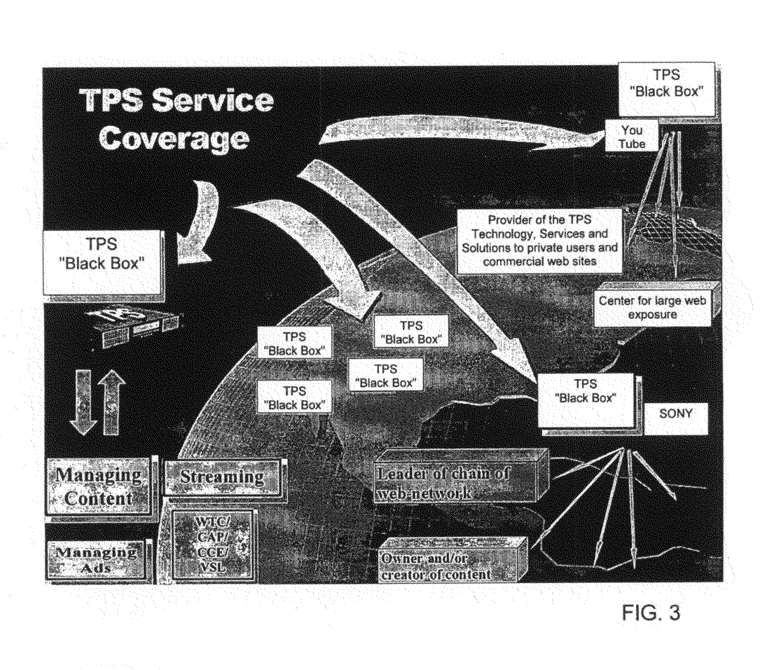

FIG. 3 illustrates an example of service coverage, according to an embodiment of the present invention. This embodiment demonstrates global service coverage by system owners (and/or virtual owners). The concept in this embodiment is that leading enterprises found all around the world can leverage their functionality using the system of the invention. In some cases, the various dispersed systems are nurtured by the same center of technology system holding central software and firmware batches-update, configuration batches-proposals, etc.

In one embodiment, FIG. 3 additionally or alternatively illustrates the power of sharing content and information between dispersed systems (if the system owners or virtual owners so desire), thus creating a sort of global content warehouse.

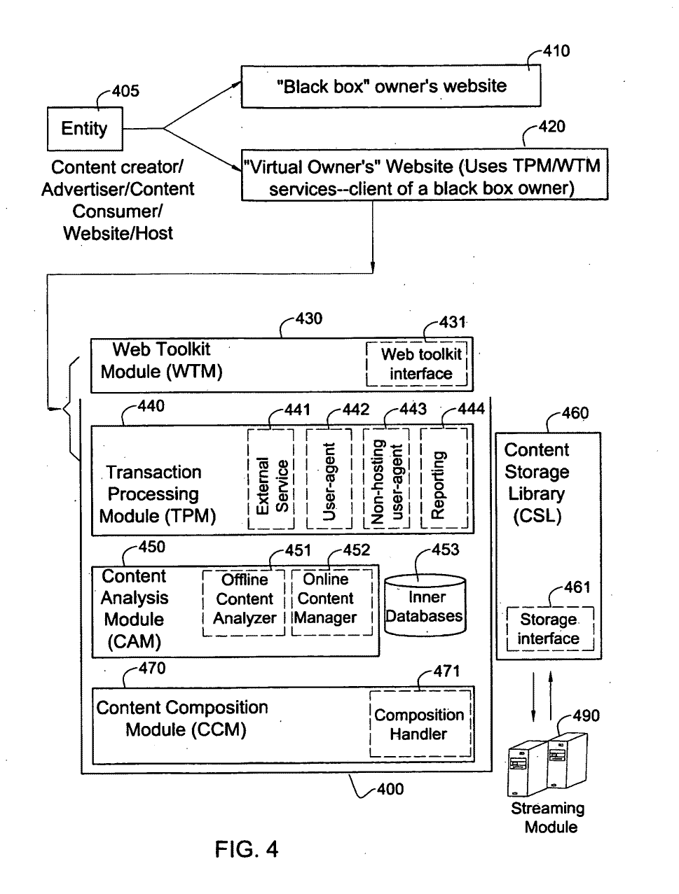

Turning to FIG. 4, FIG. 4 illustrates an architecture of a system 400 of the present invention, in accordance with an embodiment.

In the illustrated embodiment, an entity 405 requesting services accesses a website 410 which owns system 400 (or a variation thereof) or a website of a virtual owner 420 (where the virtual owner is a client of the owner of system 400 or a variation thereof). The website which owns system 400 (or a variation thereof) or which is a virtual owner of the system directs service requests from entity 405 to the system. The virtual owner may in some cases be considered to function as a mediator (intermediary) for entity 405, with entity 405 unaware of the mediation. Entity 405 may be for example, a content creator, an advertiser, a content consumer, a host, a website which is not an owner or virtual owner of the system (for example a website acting as a distribution channel, a website which accesses a virtual owner or owner on its own behalf), etc.

In one embodiment, system 400 includes the following modules: Web Toolkit Module (WTM) 430, Transaction Processing Module (TPM) 440, Content Analysis Module (CAM) 450, Content composition Module (CCM) 470, Content Storage Library (CSL) 460, databases 453, and Streaming module 490.

As shown, by this embodiment, system 400 is built in a layers architecture wherein every layer uses only the layer near it and does not skip layers. In the illustrated embodiment, there are the following layers: 430, 440, 450, 460, 470, and 490. In this way, the interaction between layers is organized, thus greater capabilities are possible such as performance and modularity (e.g. layers can be replaced by others without near layers being affected, for instance by a vendor of database 453 or by a storage (CSL) vendor).

In one embodiment, each of layers 430, 440, 450, 460, 470, and 490 includes APIs or other types of interfaces that allow one layer to utilize its capabilities for another layer. In one embodiment, the framework hides inner implementation of one layer from another and only exposes compatible interfaces that the layer needs to enforce. In one embodiment, a layer can be easily replaced (modularity) without affecting the other layers.

In some embodiments, a variant system of the invention may include less, more and/or different layers than shown in FIG. 4, and/or the technology may be built in a different architecture. In some embodiments, a variant system of the invention may include more, less and/or different modules than shown in FIG. 4. Some variations of system 400 will be described further below.

Each layer or module of system 400 (or of a variant of system 400) may comprise any combination of software, hardware and/or firmware which performs the functions that are defined and explained herein.

In one embodiment, system 400 or a variation thereof demonstrates the Technology high standard of service methodology SOA (“Service Oriented Architecture”) with only the TPM/WTM exposed to the outer world and therefore any external entity (e.g. client, advertiser, website, etc) doesn't need to be familiar with the system concrete implementation of the exposed interfaces. This embodiment may in some cases result in reaching a high quality of abstraction and SLA (“Service Layer Assurance”) towards the external client. As mentioned, in some cases, system 400 or variation thereof can replace layers and vendors without interfering with the functioning of the system.

In accordance with certain embodiments, system 400 or a variation thereof may take the form of a “black box” or the form of a “virtual-host”, when performing any of the following services, inter-alia: managing/monitoring the content, associating content (with or without transformation), streaming content, and/or web-toolkits (external services). When system 400 (or a variation thereof) is installed at an owner, the system is considered a “black box” performing services for the owner. When system 400 (or a variation thereof) provides services to a non-owner, then the non-owner is considered a virtual owner/virtual host. In some cases, the owner or virtual owner of system 400 (or a variation thereof) can leverage and bolster his business by becoming a reseller of the technology, offering it to his network of clients.

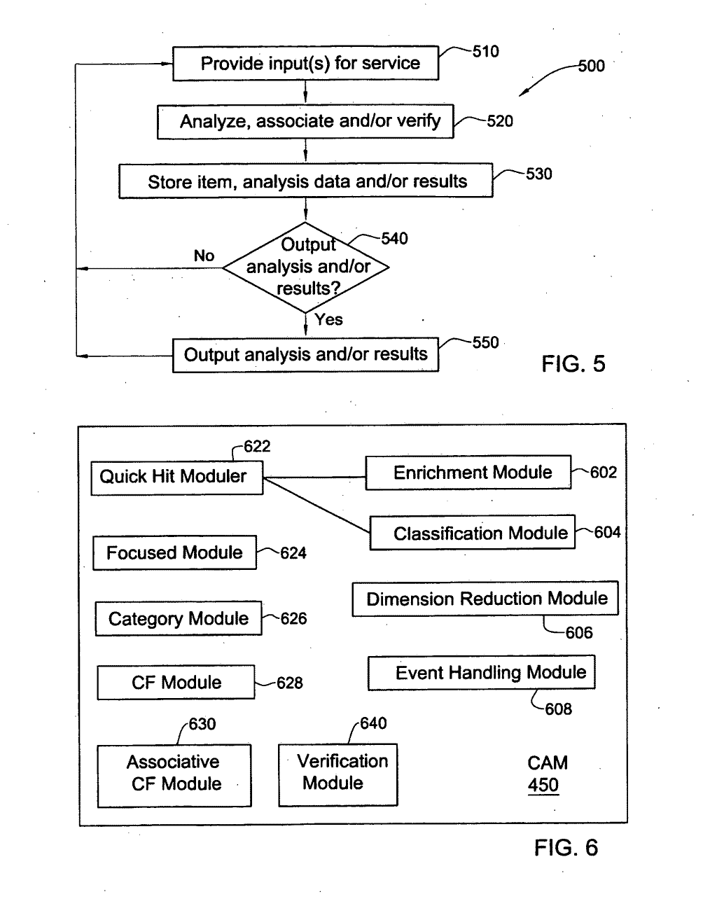

Before describing in more detail system 400, a flow diagram is presented in FIG. 5 of a method 500 of associating content, according to an embodiment of the present invention. In other embodiments, method 500 comprises more, less and/or different stages than illustrated in FIG. 5. In other embodiments, one or more stages in method 500 may be performed in a different order, and/or two or more stages may be performed simultaneously.

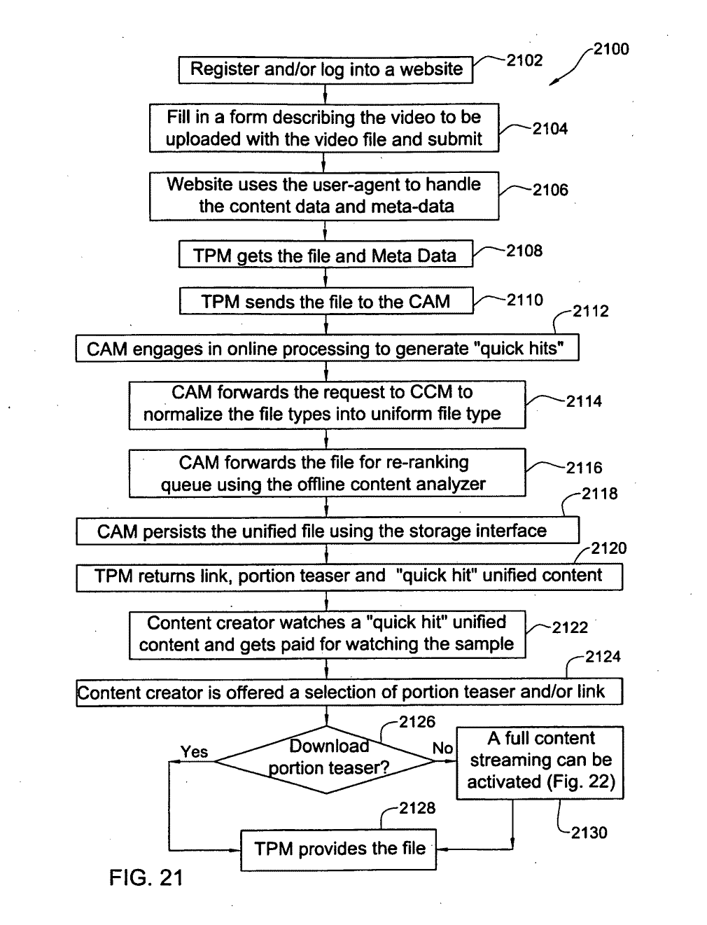

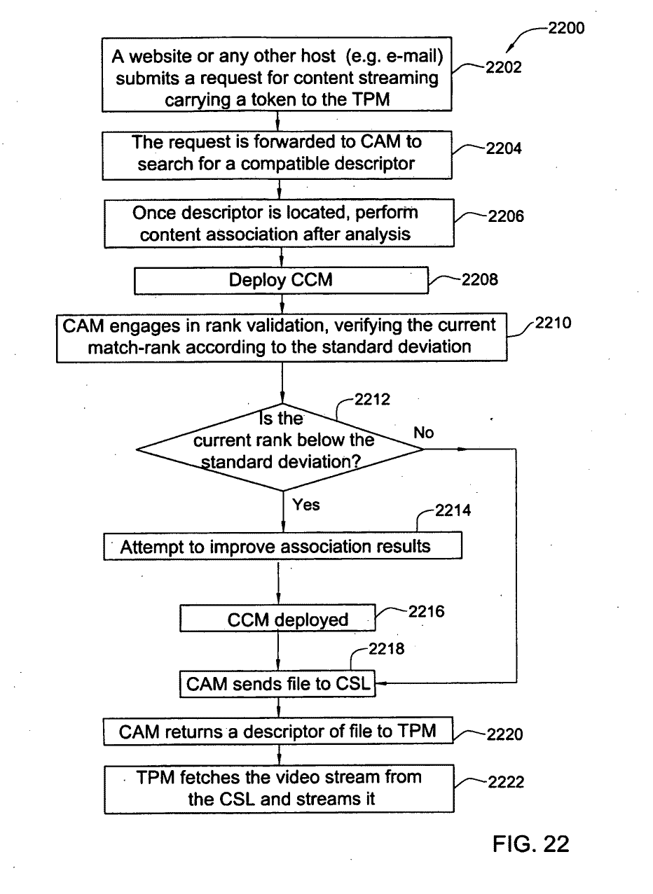

As illustrated in stage 510, one or more inputs is/are provided to system 400 (or to a variation thereof) which will be used for providing services, for example to TPM 440. In various embodiments of providing, the system may pull input(s), for example by crawling an item source, and/or input(s) may be pushed to the system. Examples of inputs which may be provided in various embodiments include any of the following inter-alia: a request, a notification, a content item, a part of a content item, an identifier of a content item, an identifier of unified content including the content item (which thereby inherently also identifies the content item), an identifier of a portion teaser (which inherently also identifies the content item—see below inter-alia description of FIGS. 21 and 22), identification of current consumer of a content item, static meta data related to a content item, data on the item source (for example subject matter of item source), data (for example subject matter) on the mediator (if any), an identifier of a field of content items (e.g. identifier of a distribution channel to be described further below), events, a combination of any of the above, etc. In embodiments where a content item (or part thereof) is provided, the content item (or part thereof) may be provided separately or as part of a batch of content items, depending on the embodiment. In embodiments where the system pulls some or all of the inputs, the system may or may not request approval of what was pulled.

In cases with a content item identifier, in one embodiment the identifier may be a static identifier of the content item which corresponds to the item from the time of creation. In another embodiment, the content item identifier may be assigned by another entity, subsequent to item creation, for example a publisher of the content item. In another embodiment, the content item identifier may be assigned by the system, for example the first time method 500 is performed for that content item.

In cases with a unified content identifier or portion teaser identifier, in one embodiment, the unified content identifier or portion teaser identifier is assigned by the system when the system produces the unified content or the portion teaser.

In cases where content consumer identification is provided to the system in stage 510, the identification may be short term (such as the session identifier) or a long term identifier of the content consumer, depending on the embodiment. Depending on the embodiment, the identification may be provided in different ways, such as directly by the content consumer or through a mediator (such as the user-ID of that user at the distributor's or publisher's website), or the consumer identification may be an internal identification assigned and maintained by system 400 or a variation thereof.

In one embodiment where an identifier is assigned by the system, the identifier may be provided to an entity appropriate for the configuration and that entity is responsible for providing the identifier to interested parties.

More details on some embodiments of stage 510 are provided below.

As illustrated in stage 520, system 400 (or a variation thereof), for example CAM 450 and/or CCM module 470, performs analysis, association and/or verification (e.g. checking of association performed in this iteration of stage 520 or in a previous iteration of stage 520). For example, in one embodiment the system may analyze a content item or a part thereof which was provided in stage 510. As another example, in one embodiment the system may additionally or alternatively, determine which content (for example unified content) corresponds to a field identifier inputted in stage 510. As another example, in one embodiment the system may additionally or alternatively analyze events.

As another example, in some embodiments of stage 520, the system may additionally or alternatively determine which content items to associate with a content item (or a part thereof) which was provided or whose identifier was provided (or inherently provided) in stage 510. As mentioned above, depending on the embodiment the associated content items may or may not be limited to content from the same item source. As will be described in more detail below, in some of these embodiments there may be multiple approaches for associating content items with a specified content item and not all approaches necessarily relate to characteristics of the associated content items. In some cases, the association may be an updated association (for example the current match may be more highly ranked than a previously determined match).

Depending on the embodiment any of the analysis, association, and/or checking may be performed online and/or offline. In one embodiment, the manner of performing stage 520 is affected by the answer to stage 540 (i.e. performance of stage 520 varies depending on whether output is currently expected or not). More details on some embodiments of stage 520 are provided further below.

As illustrated in stage 530, the content item (or part thereof), analysis-data and/or association results from stage 520 is/are stored. For example the association results may include unified content which is stored in CSL 460. As another example, additionally or alternatively, analysis-data and/or association results may in some cases be stored in inner databases 453. As another example, additionally or alternatively the content item (or part thereof) may be stored in CSL 460. In this example, the storage of the content item may in some cases occur prior to stage 520. In embodiments where association results are stored, the results may be stored in any appropriate format (which may or may not be similar to the format in which results are outputted). More details on some embodiments of stage 530 are provided further below.

In some embodiment, stage 530 is omitted. For example, stage 530 may be omitted if association is performed in stage 520 each time a content item is provided which does not consider data or results from earlier analysis or association, and the content item does not need to be stored. As another example, stage 530 may be omitted if no new analysis data or association results were generated in stage 520 (for example in some cases when the input provided in stage 510 was a field identifier) and the content item does not need to be stored.

As illustrated in stage 540 it is determined whether association results (and/or analysis data) are to be currently outputted from system 400 (or from a variation thereof). If analysis data and/or association results are to be outputted, then in stage 550 the analysis data and/or association results (or part of the analysis data and/or association results) are outputted in any appropriate format. For example in one embodiment where association results are outputted, the associated content (or a part thereof) and the content item (or a part thereof) may be outputted as unified content by streaming module 490 and/or TPM 440 and/or TPM 440 may output an identifier (e.g. uniform resource identifier URI) which enables downloading of the unified content. As another example, in some embodiments where association results are outputted, an indication of associated content (for example the associated content item(s) and/or list(s) of the associated content item(s), possibly with links to those item(s)) may be alternatively or additionally, outputted by TPM 450 and/or streaming module 490 Continuing with the example, in one of these embodiments, associated video content item(s) may be integrated into a video player or presented as a list.

More details on some embodiments of stages 540 and 550 are provided further below.

In an embodiment where analysis data and association results are not to be outputted, stage 550 is skipped in method 500. In another embodiment stages 540 and 550 are performed in parallel with stage 530 in method 500.

In the illustrated embodiment, once stage 550 is performed or is omitted (because the answer to stage 540 is “no”), method 500 repeats the next time an input is provided.

In one embodiment, in some cases when an input is next received in stage 510, analysis data or association results from a previous iteration of stage 520 (or a part thereof) may in some cases be retrieved from storage and outputted in stage 550 without an additional iteration of stages 520 and 530 (i.e. with no additional analysis, association, verification, and storage). For example, if the next input is the field identifier, in some cases, stored appropriate unified content or a downloading identifier may be outputted.

In one embodiment, the first time method 500 is performed for a particular content item, the content item itself is provided to system 400 (or to a variation thereof), and analysis data and/or association results are stored but not outputted, unless specifically requested (for example in order to demonstrate the capabilities of the system, in some cases if a content consumer is currently consuming the item, etc). In this embodiment, method 500 is next performed for that particular content item when association results are requested to be outputted for the item (for example in some cases when a content consumer is consuming the content item). For example, during this subsequent iteration the content item identifier (or another identifier which inherently identifies the content item) and possibly an identifier of a content consumer may be provided to system 400 (or to a variation thereof).

In one embodiment, association results (for example unified content or a downloading identifier) for a particular content item may be outputted in stage 550 even though association results for that particular item have not been specifically requested, for example when an appropriate field identifier was inputted in stage 510.

Now that some embodiments of a general method have been presented, there follows a more detailed discussion of the system architecture of FIG. 4 in accordance with various embodiments.

Attention is first drawn to the Content Analysis Module (CAM) 450. In one embodiment, The Content Analysis Module is the main consumer and producer of meta-data in system 400 (or in a variation thereof). In one embodiment, the CAM 450 receives incoming content along with (static) meta-data describing same (when available). For example the static meta data received by CAM 450 for a content item can include any of the following inter-alia: previously assigned categoryies for the item, language of the content item, text/tags corresponding to the item, data on the item source or item producer (for example country of origin, history etc), and/or any additional meta-data. In one embodiment, CAM 450 generates additional metadata based on analysis as will be described in more detail below. Assuming embodiments where content is stored at the system, then depending on the embodiment the meta-data (received by CAM 450 and/or generated by CAM 450) may or may not be stored (in CSL 460 or databases 453) as a context for the content item that is sent to the CSL for storage. In embodiments where content is not stored at the system, then depending on the embodiment the meta-data (received by CAM 450 and/or generated by CAM 450) may or may not be stored in databases 453.

In some embodiments, CAM 450 includes Automatic and Autonomous “Decision Making” Techniques (“AADMT”) in order to associate content. In some of these embodiments, in order to optimize association performance (for example in order to bring a content item creator(advertiser or other) to maximal and optimal exploitation), CAM 450 may hold some rational decision making capabilities on how to deal with every association request. For example, in one of these embodiments Content Analysis Module (“CAM”) 450 may include one or more keyword based synthesis, analysis and matching algorithm(s) which uses human submitted details (or hints) as well as automated content based identification (for instance in some cases an algorithm can analyze the database that store all the details relating to the videos or the web pages presenting their details and automatically reaching an identification, characterization and localization of the content subjects). As another example, in one of these embodiments, CAM 450 may additionally or alternatively rank its matching success and may choose a certain match over another using this rank (for example thereby consolidating and strengthening the matching of ad-hoc content). As another example, in one of these embodiments, the system owner or virtual owner can additionally or alternatively decide that every matching performed by CAM 450 will be of a certain level to assure SLA (Service Layer Assurance).

In some embodiments the AADMT are divided into an offline content analyzer 451 and an online content manager 452. (However in other embodiment there may be either offline content analyzer 451 or online content analyzer 452). In one embodiment with online content manage 452, on-line processing and matching of content by CAM 450 is requested by TPM 440. For example, online content manager 452 may include an API or any other type of interface and all online approaches and maintenance requests from TPM 440 towards CAM 450 may be directed through this API/other type of interface. In one embodiment with online content manager 452, online content manager 452 is additionally or alternatively responsible for managing the content, for example finding unified content corresponding to a specified unified content identifier/other type of identifier (content item, portion teaser, etc) or unified content appropriate for a specified field identifier. In one embodiment with offline content analyzer 451, in off-line mode CAM 450 uses offline content analyzer 451 to reach high-quality content-association (including in some cases contextual keyword based banner Ads resources (as needed), for example through analysis and consolidation of input meta-data, generated meta-data, and in-depth statistical data. Depending on the embodiment, offline-mode may be performed by offline content analyzer 451 in addition to or instead of online association performed by online content manager 452.

In one embodiment, CAM 450 can be used online for generating association results subject to immediate user feed-back, enabling an interactive look and feel for entities such as non-advertisement content providers, content consumers, advertisers, etc. In another embodiment, CAM 450 may be used additionally or alternatively in offline processing when immediate user feedback is not desired.

In some embodiments, using CAM 450, the association of content may comprise (non-parallel) multiple phases (for example multiple iterations of stage 520). For example in some of these embodiments, the first time a content item is analyzed there may be a first attempt (quick hit) to find one or more matches for the content item (where a match, as the term is used in this description, may not necessarily be based on similarity of content, since in some cases there may be additional or alternative approaches used in associating content). In these embodiments, this first attempt is followed by offline and/or online attempt(s) to find one or more better matches. In some embodiments with multiple phases, the content item may be analyzed in between phases. Considering an example of matching between audio/visual content and ads, one of these embodiments enables sophisticated matching between audio/visual content and targeted revenue generating advertisements (“Ads”) online as first-version-matching and offline (and/or online) as bettering apparatus for the current matching, where the system and method tries to improve commercial exploitation, better the coupling rank, and reach maximum satisfaction of the creator and advertiser, for example by way of a statistical/probability mechanism. Continuing with the example, in some cases where the matching is between a video and an ad, the matching may take into account the statistical likelihood of a consumer clicking on an ad, given the video he is watching. In other embodiments, the association for a content item may comprise only one phase (for example, all association algorithms for stage 520 may be performed in parallel).

More details on various embodiments of CAM 450 will be provided further below.

Attention is drawn to the Content Composition Module (“CCM”) 470. In some embodiments, CCM 470 is responsible for preparing the results of the association for output. For example, in some of these embodiments, CCM 470 can act as a conversion point for different multimedia content manipulations, such as codec conversion, content sanitizing, thumbnailing, or text to video (for example, for embedding banner Ads in video content). Continuing with the example, in one of these embodiments, CCM 470 works according to the system dynamic profile (“on the fly”) while picking the compatible matter of handling a request for transforming content from one standard to another; i.e. how to do it, how much resources to put in it, who to report failure and more are all examples of the profile capable of being set by the System owner.

As another example, in some of these embodiments, additionally or alternatively, CCM 470 may take into consideration constraints and/or other considerations (e.g. stored in database(s) 453), while preparing the results for output, for example by performing an optimization process for a target function.

As another example, in some of these embodiments, additionally or alternatively, matches determined by CAM 450 are used by CCM 570 to produce the final Unified Content streams, with the heavy lifting of Unified Content stream production and editing done by CCM 470. In one of these embodiments, CCM 440 takes content input and composes the media items according to strict compositing descriptors to generate the final Unified Content. In this embodiment, for example, CCM 470 may take into account constraints defined by a publisher such as the types and sources of ads he wants used. In one of these embodiments, CCM can create a unified content for a content item by attaching some kind of embedded code in the content item. In this embodiment, assuming the unified content includes a non-advertisement content item and ad(s), an ad may be embedded at the beginning, middle or end. In some cases the unified content stream may include both non-advertisement content and advertisement content whereas in other cases, the unified content stream may include only non-advertisement content or only advertisement content.

As another example, in some of these embodiments, additionally or alternatively, CCM 470 aggregates (for example combines, prunes, adjusts, enhances, etc) one or more lists of associated content compiled by one or more methods executed by CAM 450 so that an indication of associated content (for example associated content items remaining after the aggregation on one or more “aggregated” lists and/or the aggregated list(s) possibly with links to those content items) may be outputted. Depending on the embodiment, CCM 470 may or may not aggregate all the lists compiled by various methods executed by CAM 450. For instance, CCM 470 may only aggregate a subset of the lists generated by the various methods of CAM 450, see an example further below. In some embodiments, CCM 470 may separately aggregate two or more subsets of lists generated by CAM 450.

In some embodiments, CCM 470 may not prepare the results of the association for output. For instance, if the results have been previously prepared for output CCM 470 and stored, CCM 470 may not need to perform further preparation.

In some embodiments, based on associations performed by CAM 450, CCM 470 may generate batches of unified content streams (for example each including different Ads for the same content item) or may generate different aggregated lists of associated content (e.g. recommendation lists). In one embodiment where batches of unified content streams or different aggregated lists are generated, system 400 or a variation thereof may selectively output a subset of the generated unified content streams) (or provide URIs to a subset of generated unified content), or system 400 or a variation thereof may selectively output a subset of the aggregated list(s), possibly with links to the content items (or the content items in the subset of aggregated list(s)) based, for example, on the distribution channel and/or content consumer, thereby supporting context awareness of the arena where the content is streamed. For example, the subject of a website which is publishing or distributing the content, (say a website dealing with “animals” or “dogs”), may serve as an additional factor in selecting unified content stream(s) (for example including which ad(s)) and/or aggregated list(s). As another example, additionally or alternatively, the unified content stream(s) (for example the ads within) or the aggregated list(s) may be customized for a particular content-consumer, based for instance, on GeoIP, referrals, etc.

In one embodiment, all approaches requests towards CCM 470 are directed through a CCM composition-handler API or other type of interface 471, included in CCM 470.

More details on various embodiments of CCM 470 are provided further below. In one embodiment, CCM 470 may be omitted from the system if preparation of results for output is not required, for example if the results had previously been prepared.

Attention is drawn to one or more inner databases (AKA datastores) 453. In one embodiment, inner database(s) 453 include data used by CAM 450 and/or by CCM 470. For simplicity of description, different types of data are described as being stored in different datastores (with the name of each datastore corresponding to the type of data), however the description contemplates embodiments with separate datastores for different types of data as well as embodiments with one or more datastores, each including a plurality of types of data.

Attention is drawn to module Transaction Processing Module (TPM) 440. In the illustrated embodiment. TPM 440 includes inter-alia any of the following API's or other types of interfaces: external service 441, user agent 442, non-hosting user agent 443, and/or reporting 444.

In some embodiments, TPM 440 is the main entry point and management facility of system 400 or a variation thereof (i.e. TPM 440 provides a uniform access portal for the various entities that are able to interact with it). In some of these embodiments, content is provided to system 400 or a variation thereof through TPM 440. For example, in one of these embodiments TPM 440 serves as the gateway for system (400 or a variation thereof) by allowing content to be received by CAM 450 along with the relevant (static) meta-data. In some embodiments, in addition to or instead of content and static metadata thereof, other inputs such as requests for content association, consumer identification, requests for appropriate content for distribution channels, and/or notifications (for example of new content items and/or events) may be provided to system 400 or a variation thereof through TPM 440. (The content, metadata and/or other inputs may be pushed to and/or pulled by TPM 440).

For example, in some embodiments where TPM 440 is an entry point, TPM 440 may receive requests for associated content. Continuing with the example, in one of these embodiments a request may contain an identification of the item currently being consumed (for which associated content is requested) and optionally additional data such as content consumer identification (including in some cases relevant demographic data), data on the item source, data on the mediator if any, specified list(s), etc. Depending on the embodiment, the request can arrive from any entity, for example from the content consumer, from a publisher of the content item that the consumer is using or from any other form of mediator. In embodiments where the request can arrive from a variety of communication devices and can be transmitted via various protocol, the request may in some cases be translated from its native form into an internal format and forwarded to CAM 450.

As another example, additionally or alternatively in some embodiments where TPM 440 is an entry point, TPM 440 holds the responsibility for identifying the consumer (e.g. viewer) of the content in order to provide CAM 450 with information to be able to improve the matching between content items. For instance if a particular viewer saw five Unified Content with the same Ads and did not react to the ads (for example by pressing the content to activate the Ads) then CAM 450 may in some cases conclude that the Ads are not efficient with regard to that specific viewer, and that the ads should be replaced. In another instance, a viewer of an ad who speaks German might be more influenced by ads in German than in English. In various embodiments, TPM 440 may use, inter alia, various parameters in addition to or instead of IP identification/other user identifier in order to locate the geographical location of the user and to characterize his profile, for instance demographic data which arrived with the request.

As another example, additionally or alternatively in some embodiments where TPM 440 is an entry point, TPM 440 may supply advertisers with online campaign construction, whereby TPM 440 gathers the advertiser campaign parameters so that CAM 440 can associate non-advertisement content with the ad. In one of these embodiments, the technology's online-matching capabilities can provide the advertiser with the notion of a demonstration of the matching, for example CAM 450 may use the online content manager to match and return that match to TPM 440. A match can be presented to the advertiser as an example of how the technology created a first version matching which will in some cases later be automatically re-matched to reach a higher matching rank.

As another example, additionally or alternatively in some embodiments where

TPM 440 is an entry point, TPM 440 holds the responsibility of creating and managing on-the-fly the Distribution Channels. For instance, if a sport portal installs a system black box, a Distribution Channel can be a basketball or soccer channel. In one of these embodiments, these channels can be created automatically by analyzing the database or the web pages content and description, while for instance, spotting key words that constellate into a subject, having the potential to constitute a Distribution Channel or by configuring the system to create Distribution Channels according to some rules and criteria. In one of these embodiments, TPM 440 recognizes these Distribution Channels and supports live-streaming of Unified Content to suppliers of such Distribution Channels (for instance other websites). In one of these embodiments, TPM 440 requests that CAM 450 select any Unified Content fitting the distribution profile and make intelligent and automatic decisions, relating to which Unified Content is more suitable than another. For instance, in some cases, a high ranked distributor (for instance website) should get higher ranked material than another.

In some embodiments, TPM 440 may be an exit point from system 400 or a variation thereof, for example for outputting request and/or notification acknowledgement and/or for outputting association results.

For example in some embodiments where TPM 440 is an exit point, after CCM 470 has prepared the results of the association for output and assuming that TPM 440 outputs the association results to the content consumer, TPM 440 may in some cases translate the internal representation of the association results into a representation understandable by the device and/or software the consumer is using. As another example, if the association results are instead provided to a mediator, TPM 440 may in some cases translate the internal representation of the association results into a representation understandable by the mediator and the mediator may re-format the representation if needed to suit the consumer.

In various embodiments, TPM 440 may perform any of the following inter-alia: managing content output statistics (e.g. most popular videos shown each day), managing user data and profile, managing syndication channels, managing entity interaction models, credit management and charging through external party clearing houses, transaction accounting and/or handling virtual hosting information for virtual owners.

For example, assume an embodiment with a configuration as in 1.3 where system 400 (or a variation thereof) is in charge of performing the streaming of certain content (for example unified content) to a (non-advertisement) content creator that “stamped” his content and emailed it to a friend. In this embodiment, it is assumed that TPM 440 will receive the request to stream the content, and system 400 (or a variation thereof) will operate its layers to achieve this request, for example finding the compatible content (for example Unified Content), updating and/or verifying the matching, etc. In this embodiment, optionally, the system may save statistics for this request. Assuming unified content of matched non-advertisement and advertisement content, the statistics for example, may reflect, what Ad(s) was coupled with that content, how the content consumer (e.g. viewer) of that Unified content acted/reacted, etc. In this embodiment, the requests for content retrieval (multimedia streaming) may in some cases be fulfilled by retrieving media from CSL 460 using content descriptors provided by CAM 450.

In accordance with certain embodiments, TPM 440 allows the entities serviced by TPM 440 (for example content producers, advertisers, distributors, etc) to access and edit their media resources, meta-data and/or additional information elements using secure logins and with full compartmentalization of data between virtual TPM services and within said services, according to the permissions set for each entity. In one of these embodiments, TPM 440 also has full access to CAM 450 meta-data through a CAM-TPM interface mentioned above, and TPM 440 allows various entities (for example content producers, advertisers, distributors, etc) to examine the CAM generated meta-data, for example for creating filters and sorting criteria useful for managing content.

More information on various embodiments of TPM 440 is provided further below.

Attention is drawn to Web Toolkit Module (WTM) 430. In various embodiments, based on the data and APIs (or other types of interfaces) made available by TPM 440, system 400 or a variation thereof allows the creation of sophisticated and engaging websites. To support this common use, in some of these embodiments, website support toolkit module 430 is offered that contains portable and modular components available for web developers to access and manage the data in system 400 or a variation thereof. For example, in some cases WTM 430 integrates web aware components and tools that can be easily used to build modern community websites centralized around the concept of video and audio content production and consumption.

In one embodiment, WTM 430 supports advanced web technologies such as active content (AJAX) and data driven web page generation with support for multiple back-end technologies such as Java, PHP and Ruby.

In one embodiment WTM 430 offers a WTM API or other type of interface, 431 that enables partial or full access (under effective permissions) to system user data and allows the easy manipulation of all external APIs/other types of interfaces offered by the system, where permitted. For example, WTM 430 may use external service API (or other type of interface) 441 to implement a service engine, token based e-commerce and/or any other services offered by system 400 or a variation thereof.

In various embodiments, components of WTM 430 may include, inter alia any of the following:
User management: register, edit/add/remove users. Users can be aggregated by groups (ad-hoc or preset) or types (content owners, content producers, advertisers, campaign managers, etc.).
User interaction: messaging, relationships, forums, online-chats.
personal storage spaces (blogs, personal sites, personal syndication with RSS, ATOM, etc.).
Content upload, tagging, editing and removing.
Content streaming
Content download, browsing and searching.
Credit management and charging.
Meta-data and statistical reporting and/or filtering, for Distribution Channels or consumption reports.
Assorted information storage: personal file space, personal web pages, site local meta-data, etc.

In accordance with certain embodiments, WTM 430 acts as an outer online constellation of web components capable of being implemented in outer websites instead of re-developing it. Because system 400 (or a variation thereof) is specialized in content management (analyzing, statistics gathering, etc) it is sometimes important that the system also provide tools that handle common web needs.

In one embodiment, WTM 430 is virtualized allowing the re-branding of the technology to provide low-cost, zero-installation immediately deployable solutions. In one embodiment, WTM 430 provides Online oriented tools for external entities to use.

In accordance with certain embodiments, additional services can be provided on top of the association services through the usage of WTM 430, such as token based e-commerce or advance search engine for the content. For example, in one of these embodiments, assuming TPM 440 tracks individual content items that are consumed, the tracking information and/or meta-data, can be used in additional services (such as on-line shopping carts, “one click buy”, pay-per-view systems, or other e-commerce solutions). These capabilities allow advertisement content producers and/or advertisers to develop unique business models on top of the services provided by system 400 or a variation thereof.

In another embodiment, WTM 430 is omitted from the system.

Attention is drawn to module Content Storage Library (CSL) 460. In some embodiments, system 400 or a variation thereof utilizes large scale storage services in order to store content. For example, in some of these embodiments, the Unified Content streams are stored in CSL 460 so that a unified content stream can be made immediately available on request to one or more entities. As another example, in some of these embodiments (non-unified) content items may additionally or alternatively be stored in CSL 460. In one embodiment, CCM 470 or CAM 450 stores content in CSL 460 and TPM 440 retrieves content from CSL 460 for delivery to clients when requested, or TPM 440 provides a downloading link so that clients can download the content from CSL 460. (Below, CAM 450 rather than CCM 470 is described as storing content in CSL 460 for simplicity of description, but it should be understood that in some cases CCM 470 may alternatively or additionally store content in CSL 460) In one embodiment, there is a possibility of pluggable CSL back-ends to support multiple storage providers independently, simultaneously and/or in aggregate.

In some embodiments, CSL 460 includes a storage API (plug in) or other type of interface 461 for integration of streaming/storage that is external to the system. In some of these embodiments, any interaction with the external storage supplier is via CSL interface 461. In some of these embodiments, system 400 or a variation thereof does not make presumptions about available streaming/storage means (i.e. not limited to specific streaming/storage means) and therefore system 400 (or a variation thereof) provides one or more interface 461 for integrating different external storage/streaming facilities with the inner layers of system 400 (or variation thereof). In one of these embodiments, there may be various available interfaces 461 which can integrate with system 400 or a variation thereof, and once the system is installed, the system automatically detects the available storage/streaming facilities and activates the compatible interface 461.

Assume embodiments where CSL 460 is in charge of providing storage services such as store file and retrieve file. In some of these embodiments an external storage supplier is chosen to commit the technology demands and a compatible interface (plug-in) 461 is developed to implement and integrate the technology interface with the external supplier. In one of these embodiments, the flow is as follows:
1. CSL 460 is requested to store content using storage interface 461 (for example by TPM 440 or CAM 450)
2. Storage interface 461 looks for a compatible external content storage services (there could be more than one) to fulfill the request
3. The content storage services that is chosen will fulfill the request according to its implementation. (Different storage vendors may have different implementations)
4. CSL 460 generates an acknowledgement that the request has been accomplished

In another embodiment, CSL 460 is omitted from the system, for example in some cases where the system does not host content.

Attention is drawn to streaming module 490 which in some cases reflects another example of technology sterile behavior performing separation. In one embodiment streaming module 490 includes one or more file servers and/or streaming servers. In some embodiments, system 400 or a variation thereof does not rely on one certain implementation of streaming module 490 but rather assumes that there is one (or more) vendors with different implementations. In these embodiments, CSL 460 uses a storage interface 461 which is appropriate for a particular vendor to interact with streaming module 490. For example, in one of these embodiments, CSL 460 chooses a concrete storage/streaming implementation in run-time, for example the “best” streaming module 490 in case there is more than one, or the only one if there is only one.

In another embodiment, streaming module 490 is omitted from the system, for example in some cases where system does not host content.

A brief description of possible input modes for system 400 (or a variation thereof) is now provided.

In some embodiments, the input mode is a basic mode, in which TPM 440 (and thus CAM 450) receives requests for association results on content items (and possibly is aware of the identity of the corresponding content item consumer and/or subject matter of the item source or mediator) and/or receives requests for distributing content appropriate to a channel. However in these embodiments, TPM 440 (and thus CAM 450) is not necessarily aware of new content items which can be associated. For example, in one of these embodiments, TPM 440 (and thus CAM 450) becomes aware of new content items only after TPM 440 crawls an item source. In one embodiment of basic mode, CAM 450 is also not aware of some or all events (as discussed below). In one embodiment of basic mode, only a possibly empty subset of notifications is sent to TPM 440 or no notifications at all. In one of the basic mode embodiments, CAM 450 attempts to associate content despite the partial data available (i.e. even though new content items and events which may possibly affect the association results are not necessarily taken into consideration).

In some embodiments, the input mode is an intermediate mode, where TPM 440 (and thus CAM 450) is aware of new content items (for example because new content items at one or more predetermined item sources are received by TPM 440 or because TPM 440 otherwise receives notification of the new content items). However in these embodiments, TPM 440 (and thus CAM 450) is not aware of some or all events which may in some cases affect the quality of the association results. (In the intermediate mode, like in the basic mode, TPM 440 receives requests for association results on content items (and possibly is aware of the identity of the corresponding content item consumer and/or subject matter of the item source or mediator) and/or receives requests for distributing content appropriate to a channel). In one of these embodiments, where CAM 450 is aware of the availability of new items, system 400 (or a variation thereof) can support items sources that are not static because the system can learn about and associate new items. Therefore, in this embodiment CAM 450 can find match(es) for the new content item or can consider the new content item when finding a match for another content item.

In some embodiments of the invention, the system supports an advanced mode. In these embodiments TPM 440 (and thus CAM 450) is aware of certain events which may in some cases affect the quality of the association results. In these embodiments, CAM may therefore in some cases take into account (i.e. consider) events when associating content—see below for examples of how events may be taken into account in some association algorithms. (In the advanced mode, like in the intermediate mode, TPM 440 is aware of new content items, and receives requests for association results on content items (and possibly is aware of the identity of the corresponding content item consumer and/or subject matter of the item source or mediator) and/or requests for distributing content appropriate to a channel). For example in some of these embodiments, TPM 440 may receive notification of events or may sense events. In some of these embodiments, events may be user-events, representing for example operations performed by the content consumer. For example, assuming a video content item, examples of content-consumer-events may include inter-alia: playing/stopping/pausing a video clip, search operation, writing a comment, rating an item or giving some other explicit feedback, choosing a recommended item (i.e. choosing an item which was associated by the system with another content item), logging in/out a publisher website and so on. In some cases, depending on whether the user (e.g. content consumer) is interacting with the system directly or indirectly, TPM 440 may sense the user-event or may be notified of the user event. In some of these embodiments, additionally or alternatively, events may also refer to other kinds of events, such as important world news, a beginning of a holiday or some other relevant special time, changes in a publisher's site and so on.

In the various modes, inputs (relating to requests, new items, events, etc) can arrive from a variety of entities using a wide array of communication devices and protocols. In some embodiments, relevant data relating to the input is stored and an acknowledgment is returned to the entity which provided the input. In one of these embodiments, the acknowledgment is returned prior to the processing of the input (for example in some cases when the processing is performed in an offline manner), whereas in another embodiment the acknowledgement is delayed until after the processing of the input is completed (for example in some cases when the processing is performed in an online manner).

With embodiments of some possible input modes having been presented, details on various embodiments of CAM 450 can now be better appreciated.

In accordance with some embodiments, CAM 450 is capable of deploying a plurality of algorithms when associating content. In some of these embodiments, each algorithm may generate one or more lists of associated content. For example, in some cases an algorithm can generate more than one list of varying scope. In some of these embodiments, different algorithms are deployed depending on the circumstances. Depending on the embodiment, an algorithm may be computed online, offline, or partially online and partially offline. Depending on the embodiment, an algorithm may only associate content items from the same item source with one another, or may associate content items which are possibly from different item sources with one another. For example, in some cases associated advertisements may be selected from a database or provided by advertisement web suppliers.

Refer to FIG. 6 which is a block diagram of CAM 450, according to an embodiment of the present invention. In the illustrated embodiment, CAM 450 includes enrichment module 602, classification module 604, dimension reduction module 606, event handling module 608, quick hit module 622, focused module 624, category module 626, collaborative filtering CF module 628, associative collaborative filtering module 630, and verification module 640. Each of these modules may comprise any combination of software, hardware and/or firmware configured to perform the functions defined and explained herein.

In some embodiments, the modules on the left (622,624, 626, 628 and 630) output association results, and therefore are sometimes described below as “algorithm modules”, “matching algorithm modules”, or “algorithms”. In some embodiments, the modules on the right (602,604, 606, and 608) do not output association results but are instead building blocks within algorithms or perform analysis separate from the algorithms. In these embodiments, these modules are sometimes termed below “analysis tools” or “tools”. For example, in accordance with some of these embodiments, the algorithm modules of CAM 450 utilize the various analysis tools to enhance their output. Herein, tools are portrayed separately from algorithms for the simplicity of the description; however in some embodiments the algorithms and the analysis tools can be portrayed and function jointly (while feed backing and interacting one with the other) or separately in an interchangeable way. In one embodiment, verification module 640 verifies association results (outputted by one or more CAM algorithm modules and/or prepared by CCM 470). In the appropriate context in the description herein the term “techniques” includes inter-alia tools and algorithms, or more generally some or all of the procedures performed by CAM 450.

The modules shown in FIG. 6 may be divided into offline content analyzer module 451 and online content manager 452 in any appropriate manner. For example in one embodiment tools such as enrichment module 602, classification module 604, dimension reduction module 606, and event handling module 606 are included in offline content analyzer module 451, whereas verification module 640 and algorithm modules such as quick hit module 622, focused module 624, category module 626, collaborative filtering CF module 628, and associative collaborative filtering module 630 are included in online content manager 452. However, in another embodiment, for example, one or more algorithms (e.g. quick hit, focused, category, collaborative filtering, associative collaborative filtering, and/or any other algorithm) may be performed fully or partially offline. As another example, in another embodiment, additionally or alternatively, one or more tools (e.g. enrichment module, classification module, dimension reduction module event handling module and/or any other tool) may be fully or partially utilized online. As another example, in another embodiment, additionally or alternatively, verification module may be performed partly or fully offline.

In one embodiment, some or all of modules 602, 604, 606, 608, 622, 624, 626, 628, 630, and/or 640 may be considered Automatic and Autonomous “Decision Making” Techniques (“AADMT”),

In other embodiments, CAM 450 may include less, more and/or different modules than shown in FIG. 6. For example, in one embodiment association results are not verified and therefore verification module 640 may be omitted. As another example, in one embodiment additionally or alternatively, there may be less, more and/or different algorithms performed and consequently less, more and/or different algorithm modules. As another example, in one embodiment, additionally or alternatively there may be less, more and/or different tool modules.

Text analysis module for enrichment 602 will first be discussed. In one embodiment, after text enrichment, items that have no direct text association, yet would be considered related by a person, can be associated together.

In some embodiments, Text Analysis module for Enrichment 602 expands the amount of text related and associated with a given item while maintaining the general notion of the text, thereby generating additional meta-data.

For example, prior to text enrichment, certain text may correspond to the content item as part of the static meta-data which is pushed to/pulled by TPM 440. Examples of text which may be provided to (i.e. pushed to/pulled by) TPM 440 include inter-alia: title, description, tags, comments, etc. In one embodiment, a content creator/distributor/advertiser, etc, may transfer the text corresponding to the item, for example by filling out a form for the content item. In another embodiment, additionally or alternatively, TPM 440 may crawl a website or database containing meta data on the content item in order to obtain text corresponding to the content item.

In some cases, the amount of static meta-data pulled by and/or pushed to TPM 440 may be limited. For example, such a problem is highlighted in some cases in domains such as online video due to the limited amount of text associated with the item.

In some embodiments, the enrichment process relies on data sources that provide links between words, either directly in the form of a dictionary or more indirectly such as a search engine. Specifically, the enrichment module 602 in certain embodiments of the present invention utilizes several external data sources as well as internal data sources 453, specifically constructed for the type of material handled by the enrichment module 602, for performing said enrichment by intelligently analyzing, inter alia, the key words of the text explicitly associated with the item and expanding the text related to these words. Conflicts between data sources, with regard to the meaning and/or to the proper expansion of a specific term or item are resolved in certain embodiments via enrichment module 602, which digests and converts the long and noisy list of candidates and parameters into a list of few concise and representative terms, which in some cases may contain huge amount of data. In certain embodiments of the present invention, text analysis module of enrichment 602 utilizes the dimension reduction module 606 which is described below.

In certain embodiments of the present invention, the text analysis module of enrichment 602 is further capable of taking into account the roles of the different parts of textual data (title, description, tags, comments and such) that accompany content items. Each part has its own important role in giving information relevant to the content item and its own unique statistical properties, which may be different from the typical properties in other texts (such as books, articles and so on). Therefore, in embodiments where these special properties are taken into account, text analysis module of enrichment 602 may in some cases improve the quality of its output.

Furthermore, the different parts of the textual data are used, in certain embodiments of the present invention, to deduce not only about the content of the item, but also of other attributes of it, such as the seriousness, the level of provocation, the typical profile of users who wrote the text (which can be deduced from the kind of jargon used), and so on.

In some embodiments, text analysis module of enrichment 602 may be deployed when CAM 450 becomes aware of a new content item and/or periodically for all known content items. In some of these embodiments, the enrichment module 602 performs a machine learning process, which analyzes user-reactions and thus improves the assessment of which of the data sources and which of the enrichment terms are the most relevant. For example, positive user response to the associated content may in some cases influence enrichment module 602 in favor of assessing, that the sources and terms that the enrichment module used in gaining that response were relevant for that content item. On the other hand, in this example, negative user response may in some cases influence enrichment module 602 in the opposite direction.

In some embodiments, text analysis module for enrichment 602 is specifically designed for the kinds of textual material typical of the text that accompanies content items. For example, when dealing with video content items, enrichment module may in some cases be attuned to textual material typically corresponding to video content.

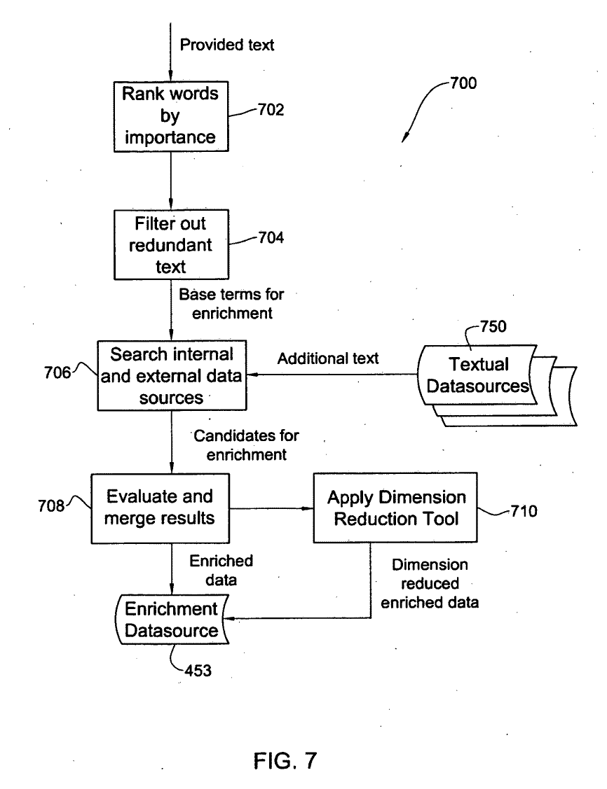

FIG. 7 illustrates one example of a method 700 performed by text analysis module for enrichment 602, according to an embodiment of the present invention. In other embodiments, enrichment module 602 may perform less, more and/or different stages than shown in FIG. 7, stages may be performed in a different order, stages shown as sequential may be performed simultaneously, and/or vice versa.

In the illustrated embodiment, in stage 702, the words in the provided text are ranked in importance. In stage 704, redundant text is filtered out to give the base terms for enrichment. In stage 706, internal data-sources (i.e. databases) 453 and external data sources, for example accessible via a network, are searched in order to get additional text. (Internal and/or external data sources are collectively labeled 750 in FIG. 7). In stage 708, candidates for enrichment are evaluated and results are merged. In stage 710, the dimension reduction tool is deployed to produce dimension reduced enriched data (see below). In another embodiment, stage 710 is omitted. The results of stage 708 and/or stage 710 are stored in an enrichment database 453.

The output of the enrichment can be represented, in some embodiments, as a set of high dimensional vectors, each vector representing an item. The dimensions of the vectors correspond to words, or more generally, textual terms. That is, the t′th coordinate of the vector representing item i measures the strength of the association between item i and textual term number t. In some embodiments of the invention, the high dimensional vectors representing the items (for example output from stage 708) are reduced to lower dimensional vectors in stage 710. In these embodiments, similar textual terms are grouped together to correspond with the same dimension, thereby allowing a reduction in the number of dimensions. The reduction to the lower dimensional vector is done by dimension reduction module 606.

Dimension reduction module 606 is capable of performing dimension reduction techniques appropriate for an embodiment, for example Singular Value Decomposition and/or Probabilistic Latent Semantic Analysis. In one embodiment, dimension reduction module can be employed by any of the other modules comprised in CAM 450. For example, in some cases dimension reduction module 606 may be employed by any of the following: enrichment module 602, classification module 604, etc. In one embodiment, the choice to which lower dimension to reduce is made by means of an optimization process. In one embodiment, the usage of dimension reduction module 606 by another module comprised in CAM 450 improves the ability of the other module in dealing with the problem of data sparseness and in performing efficiently on large collections of items (i.e. scalability). For example, a problem of data sparseness may in some cases be alleviated by grouping together similar data. For example, a problem of dealing with large collections of items may be alleviated by reducing the dimension of the vector representing an item.

In some embodiments of the invention, dimension reduction module 606 supplies a numerical and graphical showcase of its output. In one of these embodiments, the graphical view of the results is done by presenting the set of vectors (representing items as described above) in the plane or the 3-dimensional space, where the values' two or three coordinates and the colour of the points are determined by choosing which dimensions to view from among the set of dimensions which are the result of the process of dimension reduction.

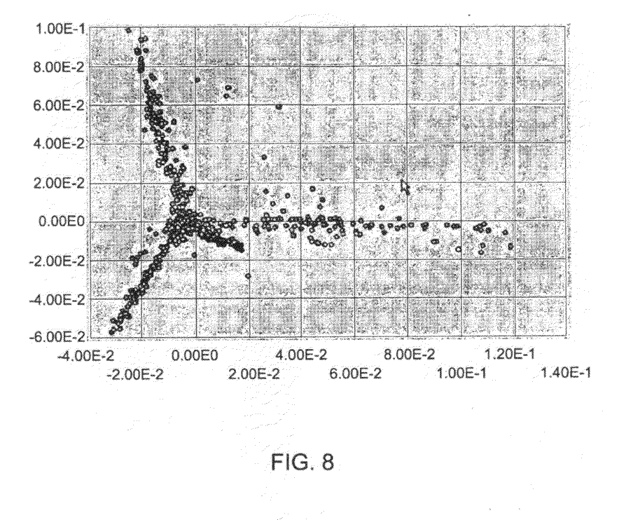

FIG. 8 depicts an example of a two-dimensional graphical view generated by dimension reduction module 606, when applied to vectors generated by text analysis module for enrichment 602 according to an embodiment of the current invention. In the illustrated embodiment, the spikes in the graph represent distinguished fields of content—that is the items positioned in one spike are typically related to each other in their content. This graph are can thus serve as a tool, which can be used by the publisher, for example, to get an impression of the patterns of content in his repository of items. Moreover, in some cases, by viewing the graph at different points of time, one may identify trends—that is—fields of content which have been rapidly growing in the near past.

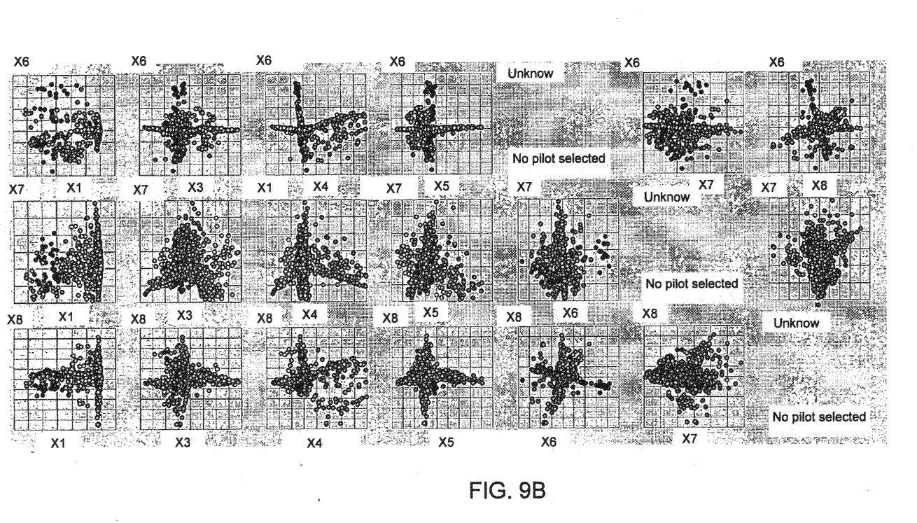

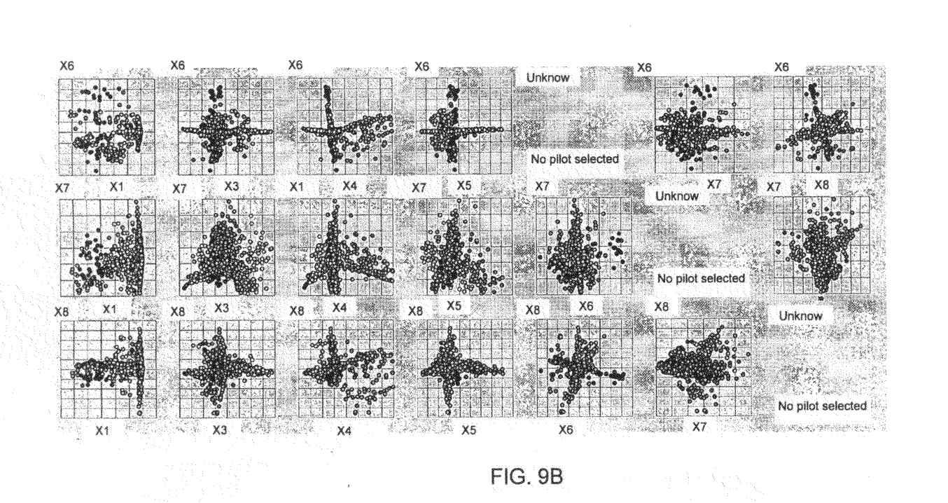

In one embodiment, different choices of the dimensions enable the viewing of the same multi dimensional populations of items from different perspectives, and thus the visualization of different patterns of content (e.g., one dimension measures the association of items to the field of humour, another to the field of sports, and so on). FIG. 9 depicts an example of graphs generated by multiple choices of dimensions in dimension reduction module 606, when applied to vectors generated by text analysis module for enrichment 602, according to an embodiment of the present invention.

The text analysis module of classification 604 is concerned with associating items with categories, thereby generating meta-data relating to classification.

For example, in some embodiments, prior to the deployment of classification module 604, a content item may be associated with one of more categories and the categories may be provided to (i.e. pushed to/pulled by) TPM 440 as part of the static meta-data. In one embodiment, a content creator/distributor/advertiser, etc may transfer the category/ies corresponding to the item, for example by filling out a form for the content item. As another example, TPM 440 may crawl a website or database containing meta data on the content item in order to obtain (pull) category/categories corresponding to the content item.

In one embodiment, beginning with the category/ies provided to TPM 440, classification module 604 refines the classification, where the act of categorizing an item is called classification. An item may be classified into more than one category. In some cases an analyzing measure is also outputted by classification module 604 which defines how well an item belongs in category. In one embodiment, categories are not necessarily limited to categories relating to the subject matter of the content item. In this embodiment, categories may additionally or alternatively reflect one or more other properties of the content item including, for example, the target audience of the content item, the quality of the content item, the popularity of the content, any combination of properties, etc. In some embodiments, classification of an item into a particular category can be either indirect or direct. For example an item may be categorized into a particular category via a surrogate category while using the link and structure between the categories themselves. Continuing with the example, in one of these embodiments, an item may be categorized into a particular category via a subcategory of the particular category.

In some embodiments, an item may be classified into a category by any appropriate means, including for example, text analysis and utilization of internal and external data sources. For example, in some embodiments, classification module 604 is called upon to decide which of the many possible categorizations offered by the various data sources it utilizes should be selected. In one of these embodiments, the decision is made by means of intelligently and automatically appraising the data sources as well as the categories themselves and the decision—making process may in some cases be intelligent, dynamic, self-learning, self-progressing and self-updating based, for example, upon user actions, omissions, reactions, behavior etc., providing explicit and implicit feedback and references. In this embodiment, classification module 604 may use such feedback in some cases to perform a reevaluation of its classifications when needed, enhancing the quality of the classifications performed by the module. In certain embodiments, text analysis module of classification 604 employs enrichment module 602 and/or dimension reduction module 606, described above.

In various embodiments, text analysis module of enrichment 602 may be deployed when CAM 450 becomes aware of a new content item and/or periodically for all known content items.

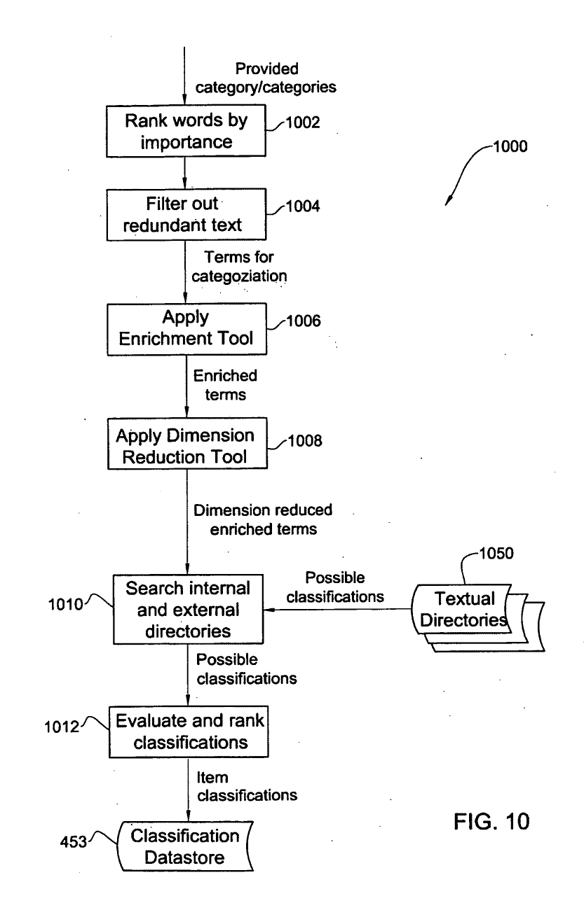

FIG. 10 illustrates one example of a method 1000 performed by classification module 604, in accordance with an embodiment of the invention. In other embodiments, classification module 604 may perform less, more and/or different stages than shown in FIG. 10, stages may be performed in a different order, stages shown as sequential may be performed simultaneously, and/or vice versa.

In the illustrated embodiment, in stage 1002,classification module 604 takes the category/categories provided to TPM 440 and ranks the words in the category/categories by importance. In stage 1004, classification module 604 filters out redundant text in the category/categories. In stage 1006, enrichment module 602 is applied to the resulting terms for categorization. The enriched terms for categorization (for example outputted by stage 708 of the applied enrichment process) are reduced by dimension reduction module 606 in stage 1008. In another embodiment, stage 1008 is omitted. In various other embodiments, any of stages 1002 to 1008 are omitted in processing the provided category/categories. In stage 1010 classification module 604 uses the dimension reduced enriched terms (or in other embodiments the provided category/ies or outputs from any earlier stage of method 1000) to search internal databases 453 and external databases for possible classifications. (Internal and/or external data sources are collectively labeled 1050 in FIG. 10). In stage 1012 the classifications are evaluated, ranked and stored in classification datastore 453.

As discussed above, the enrichment module 602, classification module 604 and/or dimension reduction module 606 can be used inter-alia to analyze a content item. In certain embodiments of the advanced mode, CAM 450 takes into account (considers) additional information on events to improve the quality of the associations. This is done, inter alia, by Event Handling Module 608.

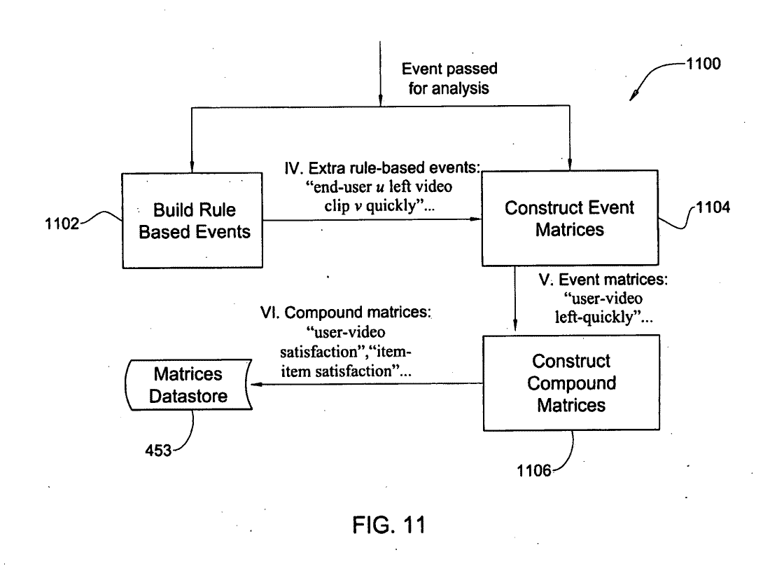

FIG. 11 depicts a method 1100 performed by event handling module 608, according to an embodiment of the present invention. In other embodiments, event handling module 608 may perform less, more and/or different stages than shown in FIG. 11, stages may be performed in a different order, stages shown as sequential may be performed simultaneously, and/or vice versa.

In some embodiments of the invention, events are handled by Event Handling Module 608, where the access to Event Handling Module 608 is controlled by TPM 440.

In the illustrated embodiment, an event (“simple event”) is passed for analysis to event handling module 608. In some cases, an event when transferred to Event Handling Module 608 is accompanied by a timestamp. In stage 1102, event handling module 608 combines several “simple” events with their timestamps using predefined rules, so that more Rule-Based events can be defined. For example, assuming a content item is a video clip watched by a user (e.g. content consumer), the Rule-Based event “user u left video clip v quickly” may be defined by “user u watches video clip v but leaves it after less than 10% of the clip has played”. This event might indicate in some cases that u was not satisfied with v.

In the illustrated embodiment, in stage 1104, the history of events (“simple” events and Rule-Based events) is collected and kept in event-matrices, which represent connections between the subjects involved. In one example of many relating to a user (e.g. content consumer) watching a content item that is a video clip, the event-matrix “user-video left-quickly” keeps in its (u,v) entry, for every user u and video clip v, a bit that indicates, whether the event “user u left video clip v quickly” (as defined above) has occurred, or not. In this example the two kinds of subjects involved were users (in this case video consumers) and video-clips. In some embodiments of the invention, the example can be expanded by using in addition several other matrices, which are constructed and handled analogously, for several other kinds of subjects, like other content items, textual terms, etc. In one of these embodiments, for instance, a search operation may influence an event-matrix that connects between users (e.g. content consumers) and textual terms. In some embodiments of the invention, event-matrices need not necessarily include all possible events. For example, in one of these embodiments, events may be defined, for example, for only part of the population of content consumers.

In stage 1106, compound matrices are defined by combinations (e.g., weighted sums, combinations by polynomial formulae, and so on) of event-matrices. For example assuming that content items are videos, the matrix “user-video satisfaction” may be defined in some embodiments as a weighted sum of several event-matrices, defined by events that give indications about the satisfaction of users (e.g. content consumers) with video clips. Continuing with this example, in one of these embodiments an event-matrix in this weighted sum may be the above described “user-video left-quickly” event-matrix. This matrix would get a negative weight in the weighted sum, as it represents indications of dissatisfaction. In embodiments with a weighted sum, the optimal choice of the weights in the sum may depend on any relevant factors, including inter-alia any of the following: the relevant type of items involved, the relevant properties of the user-interface, etc. In some embodiments, it is possible to specify the weights manually, for example, according to offline research of the relevant material. In some embodiments, additionally or alternatively, the weights may be specified automatically, by applying, for example, Linear Regression, and/or for example a more complex Machine Learning algorithm to some training data. The training data may be provided in any appropriate manner. For example, for the “user-video satisfaction” matrix, the training data may be generated in some cases by a survey on satisfaction of content consumers.

Given a matrix, which represents relations between entities as mentioned above, for example the “user-video satisfaction” matrix, Event Handling Module 608 may in some embodiments attach rows or columns of the matrix to the relevant subjects. For example, in one embodiment rows of the “user-video satisfaction” matrix correspond to users, while columns correspond to video clips. Each row or column can be represented as a vector. In various embodiments, the correspondence to subjects may be used as a way to classify subjects or to measure the similarity between the subjects, by applying appropriate clustering algorithms to the abovementioned row or column vectors. In one example of many, in some embodiments, the rows representing users in the “user-video satisfaction” matrix may be used to measures the similarity between users, and in some cases this measurement can be the similarity measure which is used by the CF Algorithm (see below). Continuing with the example, in some cases the similarity between two users can be measured as the cosine of the angle between their corresponding vectors. As another example, in one embodiment the CF Algorithm additionally or alternatively can also use the “user-video satisfaction” matrix for determining which items the user liked, as described further below.

As another example of a compound matrix, the “item-item satisfaction” matrix, may be defined, in some embodiments of the invention, as follows assuming the content items are video clips: for video clips i1 and i2, the (i1,i2) entry represents the average satisfaction of users, when they use item i2 after (alternatively, in some embodiments: before/closely before/closely after, or a union of some of these cases) using i1. In some of these embodiments, satisfaction is measured by similar means to those described above in the definition of the “user-video satisfaction” matrix.

In the illustrated embodiment, the compound matrices defined in stage 1106 are stored in matrices datastore 453. In some embodiments, prior to being stored in matrices datastore 453, the event-matrices and compound matrices may be optionally processed by dimension reduction module. Analogously to the description above, dimension reduction module 606 may be optionally used to handle problems of data sparseness and of scalability performance relating to events, and the dimension reduction module may alternatively or additionally be used to generate numerical and/or graphical showcases, and/or in order to discover patterns and trends in the data For example, a problem of data sparseness may in some cases be alleviated by grouping together similar subjects such as similar content items and/or similar users. For example, a scalability performance problem may in some cases be alleviated by reducing the dimension of a vector in a matrix.

Now will be described methods performed by algorithm modules in CAM 450 for associating content. As will be understood from the description below, a content item may be associated with another content item by a particular algorithm not necessarily because of the characteristics of these items. As mentioned above, the methods (algorithms) described herein should not be considered limiting. For example in some cases there may be additional methods, fewer methods, and/or different methods performed by CAM 450 in order to associate content items. Depending on the embodiment, there may or may not be rules on how many content items may be associated with a given content item by a given algorithm (for example per list generated by the algorithm, or total assuming more than one list generated). For example in various embodiments with rules on how many, there may be a predetermined number, a maximum number, a minimum number, or a number range of content items which can be associated with a given content item. Various internal rules of the algorithms according to some embodiments may be understood from the description of the algorithms below.

Considering first quick hit module 622, in some embodiments quick hit module 622 at least uses existing available meta-data (i.e. meta-data pushed to and/or pulled by TPM 440) to generate “Quick Hits” for a content item. In one of these embodiments, quick hit module 622 generates the quick hits prior to the generation by CAM 440 (for example enrichment module 602 or classification module 604) of additional meta-data relating to the content item, and therefore does not consider generated meta-data. In one of these embodiments, once quick hits are generated, the Quick Hits are substantially immediately forwarded (or forwarded after verification by module 640) to the CCM 470, for example using composition handler 471. In this embodiment, the association results may be subsequently outputted (for example, unified content including at least part of the content item and at least part of associated content item(s), a downloading identifier for the unified content, and/or an indication of associated content). For example, in some cases, unified content or a downloading identifier thereof may be outputted which includes a “Quick Hit” coupling of non-advertisement content and embedded Ads. In some cases, the association results may be outputted as soon as the results are ready whereas in other cases the association results may be outputted only if and when requested. For example, in some cases where a coupling of non-advertisement content and ads are outputted as soon as ready, the content creator can substantially immediately participate in the technology activation (coupling ad to the non-ad content) after uploading the non-ad content, despite the demanding nature of the online matching performed by CAM 450. In another of these embodiments, data on the quick hits is stored in databases 453 and is not forwarded to CCM 470 unless association results based on quick hits need to be outputted.

Depending on the embodiment, the algorithm performed by quick hits module 622 to find one or more matches for a content item may or may not take into account some or all of the following data: meta data relating to the content item, event related data (for user events or non user events), data relating to the content consumer, data relating to the item source or mediator, etc. For example in one embodiment, the quick hit algorithm is performed prior to the analysis of the content item and therefore takes into account only static meta data (received by CAM 450) and optionally non-user events, and does not take into account generated meta-data. In another embodiment, the quick hit algorithm may be performed after the analysis of the content item and therefore may in some cases also take into account generated meta-data.

In one embodiment, quick hit module 622 utilizes strong statistics efforts and invested resources. In one embodiment, various factors are taken into consideration in the “Quick Hits” algorithm. In one embodiment, the “Quick Hits” algorithm when performed online provides an entity (for example advertiser or other content creator) with an immediate feel of the unique capabilities of CAM 450. Such capabilities ensure in some cases that the entity receives a first impression of high ranked matching (“Quick Hit”) which in some cases may be improved in later attempts online or offline. In one embodiment, there may be immediate feed-back on the association results generated by quick hit module 622, thereby enabling an interactive look and feel for advertisers and other content providers.

In one embodiment, quick hit module 622 creates a just-now matching between content items. In this embodiment, once quick hit module 622 has finished creating a just-now matching, the content item to be matched is forwarded to a queue for re-association, because it is assumed that a better match can be found (for example due to less time constraints or for example because more data will be taken into account in the re-association attempt). For example, the quick hit algorithm can create a just-now matching between video content to targeted and the best relevant ad (which may be any kind of ad for instance: dynamic ad at the start, middle or at the end, or for instance an active ad—where advertisers can sell product using video content). In this example, the video content can then be forwarded to a later processing queue to re-analyze the rank of the match, because a better match assumingly can be found.

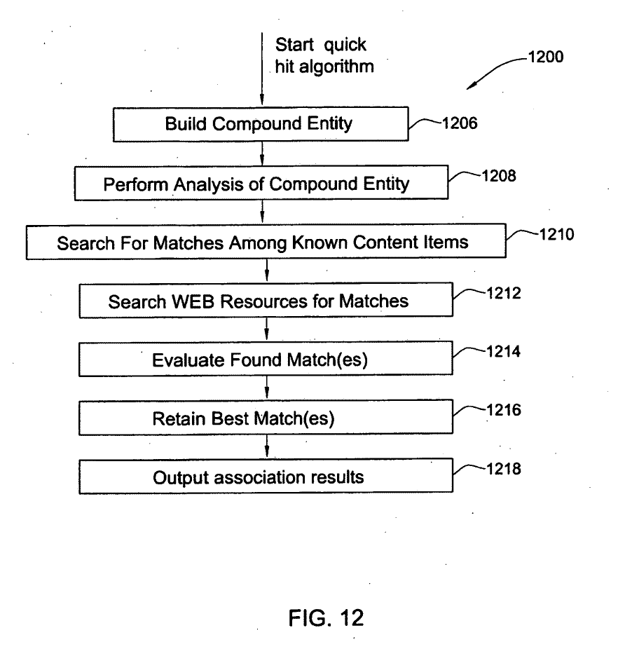

FIG. 12 is a flow diagram of a method 1200 for accomplishing Quick Hit, in accordance with an embodiment of the invention. In other embodiments, method 1200 may include less, more and/or different stages than illustrated in FIG. 12, and/or stages may be performed in a different order. In other embodiments, additionally or alternatively, stages shown as sequential may be performed in parallel and/or vice versa.

In the illustrated embodiment, quick hits module 622 performs a keyword based synthesis analysis and matching algorithm that uses meta-data given from submitted details (or hints), and optionally meta-data from automated content based identification (e.g. based on classifications generated by classification module 604). In the illustrated embodiment, the quick hit algorithm is based on a NLP (Neuro-linguistic Processing) model where every match is ranked and a standard deviation is maintained whereas if a certain match is ranked below the standard deviation that match is prioritized to be re-matched by CAM 450. (Alternatively, in another embodiment the comparison with the standard deviation may be performed by verification module 640 or may be omitted).

In the illustrated embodiment, CAM 450 is asked by TPM 440 to determine associated content for a content item, and CAM 450 deploys quick hit module 622 to handle the request and apply the NLP (quick hit) matching algorithm. In stage 1206, quick hit module 622 tries to build a compound entity based on the available meta-data. For example available meta-data in one embodiment may include static received metadata (i.e. not metadata generated by CAM 450). An example of a particular compound entity can include the following information on a video content item: the video is about basketball, the NBA playoffs are near, and the video was uploaded by a young person who is American and a native English speaker.

In the illustrated embodiment, in stage 1208, quick hit module 622 approaches cached (immediately approachable) statistical database requesting a quick analysis of the compound entity. For example, in the case of ad-matching, the statistical database may hold, for instance, statistical ad-matching information based on text. Continuing with the example, and assuming a matching ad is desired, the quick analysis may include that usually basketball videos receive high exposure when playoffs are near (which can be determined for example from non-user events known to the system) , and that last time quick analysis algorithm matched a basketball video with an ad, the ad was successful.

In the illustrated embodiment, in stage 1210, using the compound entity from stage 1204 and the quick analysis from stage 1206, quick hit module 622 finds one or more matches among known content items. For example, assuming that a matching ad is desired for a video item, a quick cached ad database may be searched for the best match. Continuing with the example, in some cases the database may include a default list of diverse ads which would satisfy most matching requests.

In the illustrated embodiment, in parallel with stage 1210, stage 1212 is executed. In stage 1212, quick hit module 622 generates key words for the content compound entity generated in stage 1206, and using the generated key words, quick hit module 622 may search web resources for one or more matches. For example, assuming that a matching ad is desired for a video content item, a list of advertisement web suppliers may be approached to find the best matching ad.

In the illustrated embodiment, in stage 1214, quick hit module 622 evaluates the match(es) found in stage 1210 or 1212 to determine which matches are retained. For example, in some cases the validity of a match can be determined by way of a standard deviation gap or other verification measure. Continuing with the example, in one embodiment a match will be considered invalid if the gap between a given content item and its matched content item is above a predetermined (for example system configured) allowed standard deviation gap. In some cases, there may be a limit on the number of valid matches which are retained. For example, in embodiments where there is a maximum number of valid matches which may be retained, then starting with the match with the lowest standard deviation gap (the best match) and continuing with the next lowest standard deviation gap, the maximum number of valid matches may be selected and retained. Continuing with the example, in one of these embodiments, only the one best match (which may have been found in stage 1210 or 1212) is not filtered out in stage 1214.

In another embodiment, stage 1214 is omitted and all matches found in stage 1210 and 1212 are retained.

In the illustrated embodiment, in stage 1216, based on the performance of quick hit module 1622 in stages 1206 to 1214, quick hit module 622 holds a decision of the quick hits best effort association attempt (i.e. the retained match(es)).

In the illustrated embodiment, in stage 1218, the association results for the quick hit algorithm are outputted from quick hit module 622, for instance to CCM 470 and/or to a rematch queue. For example, assuming that unified content is desired between two content items, for instance between a non-advertisement content item and the one best matching advertisement content item, CCM 470 may prepare a unified content stream including the two content items or parts thereof. As another example, the decision of the quick bits (i.e. the retained match(es)) may be forwarded to a re-match queue, assuming that better matching may be obtained through additional effort (for example additional statistics, analysis, algorithms, etc). In some cases matches in the re-match queue may be verified to determine whether re-matching is desirable whereas in other cases matches in the re-match queue are re-matched without first being verified.

Re-matching may be performed in certain embodiments, because the match(es) generated by quick hit module 622 may in some cases be considered insufficient. The match(es) generated by quick hit module 622 may be considered insufficient in some cases for any of the following reasons, inter-alia: insufficient data (for example meta data such as classification data generated by analysis of CAM 450 not taken into account, content consumer data not taken into account, limited or no event data taken into account, etc), high standard deviation meaning extreme distance of certain match, advertisers campaign being over (in the case of associating ads with non-ad content), etc.

In another embodiment, forwarding to a re-match queue may be omitted.

Considering now focused module 624, focused module 624 selects one or more similar items to items which a content consumer has already consumed or is currently consuming.

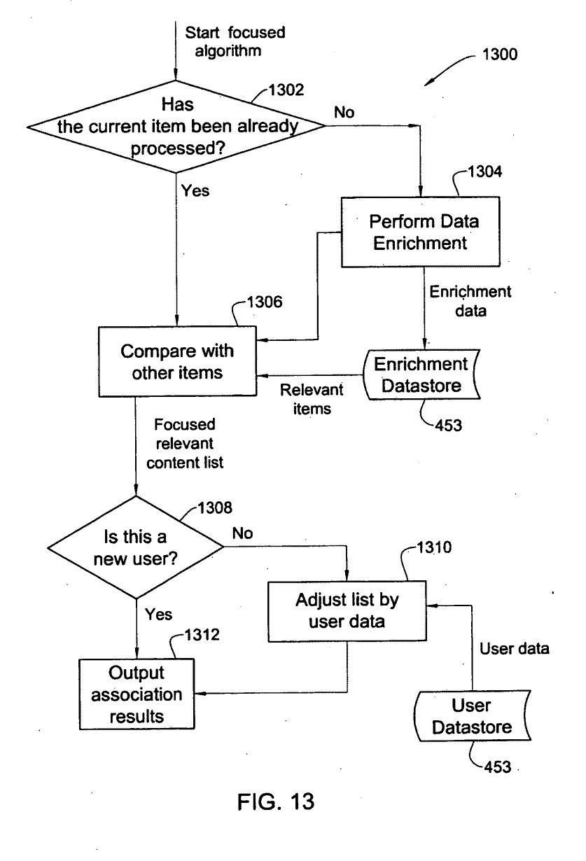

FIG. 13 is a flow diagram of a method 1300 for focused module 624 accomplishing the focused algorithm, in accordance with an embodiment of the invention. In other embodiments, method 1300 may include less, more and/or different stages than illustrated in FIG. 13, and/or stages may be performed in a different order. In other embodiments, additionally or alternatively, stages shown as sequential may be performed in parallel and/or vice versa.

In the illustrated embodiment in stage 1302, it is determined whether the particular content item for which associated content is desired has previously been processed sufficiently to perform the focused algorithm (e.g. whether sufficient meta-data has been previously generated by CAM 450). For example, in the illustrated embodiment, it is determined whether data enrichment has previously been performed by enrichment module 602. However in other embodiments, it may be determined whether other processing additionally or instead had been previously performed (for example classification, etc). If previous processing has not taken place, then in stage 1304, the appropriate processing of the content item is performed (for example data enrichment-see FIG. 7, and/or any other type of processing). In stage 1306, the processing output is stored in datastore 453, for example enrichment data may be stored in enrichment datastore 453.

If sufficient processing has previously taken place then method 1300 omits stage 1304 and proceeds directly to stage 1306.

In the illustrated embodiment, in stage 1306, similar content items for the particular content item are determined. The similarity between content items may be assessed by any appropriate similarity measure(s). One example among many for such similarity measure between two items is the number of shared words between these items in the (enriched) text corresponding with each one.

In the illustrated embodiment in stage 1308, it is determined if the content consumer is a new user (i.e. a user not known to CAM 450). If the content consumer is not a new user (i.e. has previously consumed a content item), then in stage 1310, focused module 624 may utilize its understanding about the content consumer, for example based on data in user datastore 453. For example, in some cases this knowledge may be used to adjust the ranking of the associated items. Continuing with the example, in one embodiment, focused module 624 may lower the ranking or the matching potential of items which the content consumer has recently consumed.

In the illustrated embodiment, in stage 1312, the association results for the focused algorithm are outputted from focused module 624, for example to CCM 470.

In one embodiment, stages 1302 to 1306 may be performed offline, for example when CAM 450 becomes aware of the content item or for example periodically for all known content items. In this embodiment, stages 1308 to 1312 are performed online when the content consumer is known, so that association results may be outputted. In other embodiments, all of method 1300 may be performed online or offline, or the division may be different.

In one embodiment, stages 1308 and 1310 are omitted and data on the content consumer is not taken into account.

In one embodiment, additionally or alternatively to the adjustment based on user data, focused module 624 may use its knowledge of the subject matter of the item source of the content item or the mediator through which a request for associated content arrived (if any) in order to adjust the ranking of the associated items.

In some embodiments, additionally or alternatively to the adjustment based on user data and/or item source/mediator subject matter, the associating performed by focused module 624 may be affected by events which may or may not be reflected in event matrices. For example, in the days prior to Valentine's Day, more ads relating to the holiday may be associated with the content.

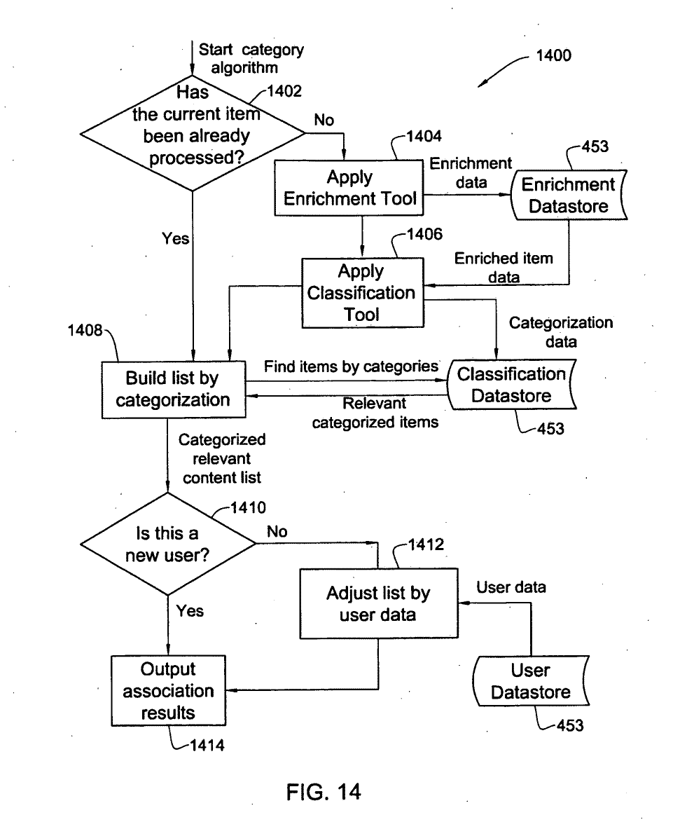

Referring now to category module 626, FIG. 14 is a flow diagram of a method 1400 for category module 626 accomplishing the category algorithm, in accordance with an embodiment of the invention. In other embodiments, method 1400 may include less, more and/or different stages than illustrated in FIG. 14, and/or stages may be performed in a different order. In other embodiments, additionally or alternatively, stages shown as sequential may be performed in parallel and/or vice versa.

In the illustrated embodiment, in stage 1402, it is determined whether a particular content item for which associated content item(s) is/are desired has previously been processed sufficiently to apply the category algorithm. If not, then in stages 1404 and 1606, category module 626 appropriately processes the content item, for example applying analysis modules such as any of enrichment module 602 (see FIG. 7) on the text corresponding to the item, classification module 604 (see FIG. 10), etc. The results of the processing are stored in datastores 453, for example enrichment datastore 453 and classification datastore 453.

If sufficient previous processing had taken place then method 1400 proceeds directly to stage 1408.

As described above with reference to classification module 604, each item may be associated with one or more categories. In one embodiment, categories can be described as nodes of a graph. In this embodiment, the edges of each such possible graph are the various links between categories. One example among many for such links is a parent-child link: Sports→Soccer.

In the illustrated embodiment, in stage 1408, associated items are determined by category module 626. In some embodiments, category module 626 searches by categories in classification datastore 454 in order to find associated content for a particular content item (i.e. associated categorized items). For example, in some of these embodiments, category module 626 traverses an items-categories graph (for example maintained in classification datastore 453), which includes all categories, all items and the links between each item to its categories and between categories. In one embodiment where traversal takes place, each such traversal ends in an item that is considered associated content. Assuming a plurality of traversals are performed, a plurality of associated content items are determined (for example a list of categorized associated content). As an example of such a traversal, assume there is a particular item associated with the Basketball category. The traversal could then move from that item to the category, from there to the Sports category and from there to the Soccer category. Finally, assume there is another item associated with the Soccer category. That other item will be eligible for consideration as associated content for the particular item based on the path.

In the illustrated embodiment, in stage 1410, it is determined if the content consumer is a new user (i.e. a user not known to CAM 450). If the content consumer is not a new user, then in stage 1412, category module 626 may utilize its understanding about the content consumer, for example based on data in user datastore 453. For example, in some cases this knowledge may be used to adjust the ranking of the associated items. In one example among many of such adjustment, category module 626 may elect to strengthen the rank of items that belong to categories the user has consumed many items from, or more generally that category module 626 believes the user likes, prefers, is satisfied with, and/or otherwise.

In the illustrated embodiment, in stage 1414, the association results for the category algorithm are outputted from category module 626, for example to CCM 470.

In one embodiment, stages 1402 to 1408 may be performed offline, for example when CAM 450 first becomes aware of the content item or for example periodically for all known content items. In this embodiment, stages 1410 to 1414 are performed online when the content consumer is known, so that association results may be outputted. In other embodiments, all of method 1400 may be performed online or offline, or the division may be different.

In one embodiment, stages 1410 and 1412 are omitted and data on the content consumer is not taken into account.

In one embodiment, additionally or alternatively to the adjustment based on user data, category module 626 may use its knowledge of the subject matter of an item source/mediator through which a request for associated content arrived (if any) in order to adjust ranking of the associated items.

In some embodiments, additionally or alternatively to the adjustment based on user data and/or item source/mediator subject matter, the associating performed by category module 626 may be affected by events (which may or may not be reflected in event matrices), for example short term interests, or trends, either globally or with regard to the specific content consumer and/or consumer group. In one of these embodiments, these interests are manifested (and may therefore be detected by system 400 or a variation thereof) by changes in item consumption and/or creation. In one example of many for such adjustment, during the World Cup month, more soccer items are detected as having been uploaded to an item source and therefore category module 626 may accordingly increase the weight of content items corresponding to the soccer category.

As mentioned above, in some cases an algorithm module may generate lists of association content of varying scope. An example will now be provided for the category algorithm. In this example, assume that the category algorithm can have several levels of categorizations (hierarchal categorization). For the narrower scope list, the category algorithm may use a lower level categorization and for the broader list, the category algorithm may use the high-level categorization. Continuing with the example, assume a video V1 is tagged under Sports→Basketball and a video V2 is tagged under Sports→Soccer. In this case, V2 may be eligible as associated content for V1 in the broader scope list but not in the narrower scope list.

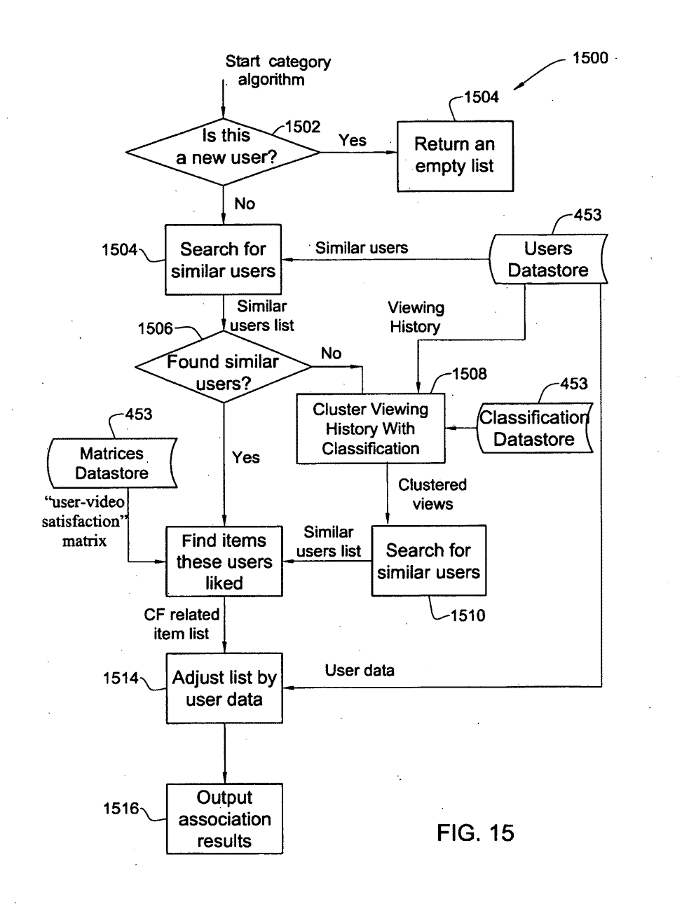

Referring now to collaborative filtering (CF) module 628, the CF Algorithm works on known (existing) content consumers, i.e. users who have previously been serviced by CAM 450. FIG. 15 is a flow diagram of a method 1500 for CF module 628 accomplishing the CF algorithm, in accordance with an embodiment of the invention. In other embodiments, method 1500 may include less, more and/or different stages than illustrated in FIG. 15, and/or stages may be performed in a different order. In other embodiments, additionally or alternatively, stages shown as sequential may be performed in parallel and/or vice versa.

In the illustrated embodiment in stage 1502, it is determined from the user identification whether or not the content consumer is a new user (i.e. whether or not the content consumer has previously consumed a content item). If the content consumer is a new user, then CF module 628 cannot perform the algorithm and in 1504, CF module 628 does not output association results (or outputs null results).

If the content consumer is not a new user then in stage 1504, CF module 628 searches for similar users in users' datastore 453. One example among many for such a similarity measure between two users is the number of items that both users have watched. As another example of an additional or alternative similarity measure, the rows representing users in the “user-video satisfaction” matrix can be used to measure similarity, for instance by taking the cosine of the angle between corresponding vectors, as described above with reference to event handling module 608. User similarity may also or alternatively be measured based on other factors such as demographic data, fields of interest (e.g. genres of videos watched), etc.

In stage 1506, it is determined if similar users were found. If yes, then method 1500 proceeds directly to stage 1512.

If similar users are not found, for example due to the sparseness of the consumption matrix, CF module 628 may use clustering methods in stage 1508 based on the content consumer's consuming (e.g. viewing) history from users database 453 and/or based on the classification of items from classification datastore 453. For example, the clustering of, items may be based on their classification as performed by the classification module 604. Using the clustered views from stage 1508, in stage 1510 CF module 628 finds similar users.

In the illustrated embodiment in stage 1512, CF module 628 selects content items based on which items these similar users liked. The assessment of whether a user likes, chooses or prefers a certain item may be based on any appropriate factor(s) including inter-alia whether the user consumed that item, whether the user ranked it favorably (where applicable) or otherwise, and/or more domain (type of content item) specific criteria. In the world of video, for example, a user who watched all the video may be considered to like the video better than a user that stopped watching midway. According to one embodiment of the invention, an assessment of user satisfaction may be made using the “user-video satisfaction” matrix from matrices datastore 453 described above with reference to event handling module 604.

In the illustrated embodiment, in stage 1514, CF module 628 may utilize its understanding about the content consumer (beyond the factor(s) taken into account by the similarity measure(s)), for example based on data in user datastore 453. For example, in some cases this knowledge may be used to adjust the ranking of the associated items. In one example among many of such adjustment, CF module 628 may elect to strengthen the rank of items which was liked by a particular user found to be similar, if that particular user and the current content consumer are both from the same country (assuming the geographical locations of the users were not taken into account when determining similarity). In another embodiment, stage 1514 may be omitted.

In one embodiment, the associating performed by CF module 628 may be affected by events which may or may not be reflected in the event matrices in addition to or instead of the adjustment based on user data. For example CF module 628 may in some cases be affected by trends in consumption and/or uploading of items, either globally or per a specific user or user group. As one example of many for such adjustments, if CF module 628 detects that a certain item is consumed by many users from the USA in the last few hours, then in some cases CF module 628 will increase this item's ranking until its popularity has diminished.

In one embodiment, additionally or alternatively to the adjustment based on user data and/or events, CF module 628 may use its knowledge of the subject matter of a item source/mediator through which a request for associated content arrived (if any) in order to adjust ranking of the associated items.

In the illustrated embodiment, in stage 1516, the association results for the CF algorithm are outputted from CF module 628, for example to CCM 470.

In one embodiment, method 1500 is performed online but in other embodiments method 1500 may be performed partially or totally offline.

Turning now to associative CF module 630, associative CF module 630 finds items which are similar to items that the current consumer liked.

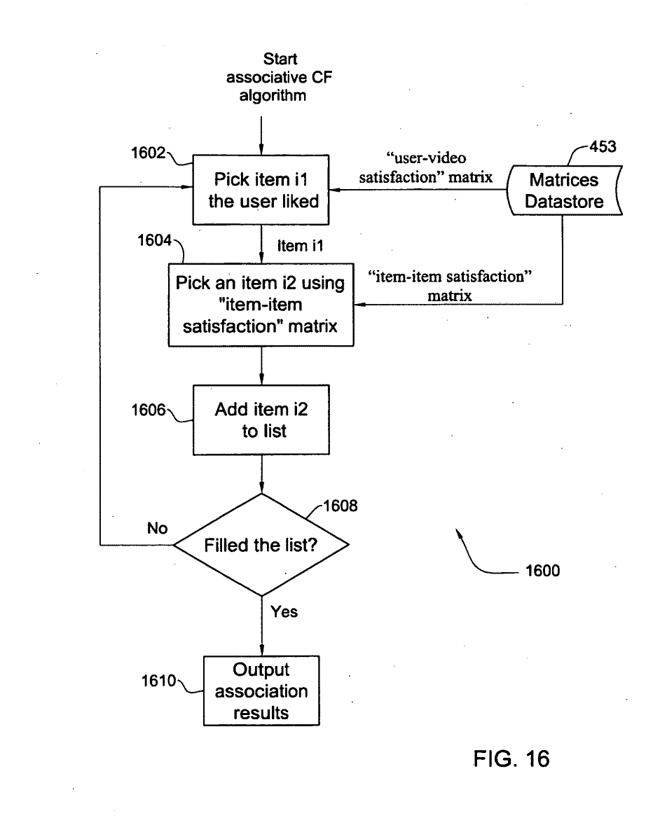

FIG. 16 is a flow diagram of a method 1600 for associative CF module 630 accomplishing the associative CF algorithm, in accordance with an embodiment of the invention. In other embodiments, method 1600 may include less, more and/or different stages than illustrated in FIG. 16, and/or stages may be performed in a different order. In other embodiments, additionally or alternatively, stages shown as sequential may be performed in parallel and/or vice versa.

In the illustrated embodiment, associates CF module 630 performs the algorithm only if the current consumer is known (has previously consumed a content item). In stage 1602, module 630 picks an item, say i₁, that the current content consumer liked, for example based on the discussed above user-video satisfaction matrix from matrices datastore 453. In stage 1604, module 630 selects another item, say i₂, for example using the discussed above item-item satisfaction matrix from matrices datastore 453. For example, module 630 may select item i₂ because the (i₁,i₂) entry in the “item-item satisfaction” matrix is high (indicating high expected satisfaction). This algorithm may be naturally generalized to triples (i₁,i₂,i₃) of items, and so on. In stage 1606, the number of associated items in augmented due to the selection of item i₂.

In the illustrated embodiment, in stage 1608, method 1600 repeats stages 1602 to 1606 if the predetermined number of item(s) (per list and/or total) has not been reached.

When the maximum predetermined number of associated item(s) has been reached, the association results for the associative CF algorithm are outputted in stage 1610 from associative CF module 630, for example to CCM 470.

In other embodiments, there may not be a predetermined number of associated item(s), for example there may be a maximum number, minimum number, number range or no limitations on the number. For example, in one of these embodiments any itemₙ whose (i₁,iₙ) entry is above a predetermined value may be selected.

In some embodiments, associative CF module 630 may adjust the selection of items (for example veto certain items picked in stage 1604) based on knowledge of the content consumer, events, and/or subject matter of the item source/mediator (if any). For example, content that is similar to content that CF module 630 knows that the consumer does not like, may be removed.

In one embodiment method 1600 is performed online but in other embodiments method 1600 may be performed partially or totally offline.

Referring now to verification module 640, in some embodiments, verification module 640 may be used to verify the association results of individual algorithm modules 622, 624, 626, 628, and/or 630. For example, in one of these embodiments, where not all algorithm modules are deployed at one time, verification module 640 may determine whether the association results from the deployed algorithm(s) are sufficient or whether additional algorithm modules will be subsequently deployed. As another example, in one of these embodiments, additionally or alternatively, verification module 640 may determine whether some or all of the results of a particular algorithm module are retained or discarded. Continuing with the example, if a result is discarded, in some cases verification module 640 may determine that a new result will be calculated by that particular algorithm module, will be calculated by another algorithm module, or will not be calculated.

In some embodiments, verification module 640, evaluates based on a standard deviation distancing methodology every associated pair of content items (e.g. match) determined by a CAM algorithm module, or alternatively less than all matches. For example, verification module 640 can check the standard deviation representing the gap between the match rank to what is allowed. In one of these embodiments, if a matching rank is too low (i.e. higher than the standard deviation) CAM 450 will try to repair the match while using, inter alia, any of the following: algorithm modules(s) (the same which produced the association or other algorithm module(s)) deployed in subsequent association attempt(s), statistical retrieved data and/or an automatically load balancing mechanism. In some cases, a subsequent association attempt will result in a closer match, and if not, the current match does not necessarily need to be replaced.

In some embodiments certain matches are prioritized to be verified by verification module 640. In some of these embodiments, verification module 640 works by de-queuing from a priority queue that handles priority-messages where every message is a link to a match that may need to be re-matched. In one of these embodiments, the queue is filled up with a new message each time a match is determined by any CAM algorithm module or by any of certain CAM algorithm module(s) (for example quick hits module 622).

For example in some embodiments, matches from certain CAM algorithm module(s) and/or on from certain CAM list(s) which are considered less reliable than others may be prioritized for verification over matches from CAM algorithm modules/lists which are considered more reliable. Continuing with the example, in some cases (“Quick Hit”) may be considered less reliable (for example if quick hits is performed prior to analysis of a content item) and therefore its matches are highly prioritized to be re-matched and to be queued into the re-match queue. Continuing with the example, in some cases each time a “Quick Hit” is determined, a message is added to the queue because it is assumed that a “Quick Hit” matching is low-ranked and needed to be re-analyzed, for example taking advantage of supplemental data such as gathered statistics, generated meta-data, etc.

As another example in one embodiment, matches from CAM algorithm module(s)/lists that are considered less reliable than others (for example, in some cases, quick hits performed prior to analysis of a content item) may have lower priority for verification or may not be verified since the default assumption may be to discard those results unless absolutely necessary (for example unless results are not available from other CAM algorithm module(s) which are considered more reliable).

As another example, in one embodiment, match(es) for content which is consumed (assumed in this example to mean viewed) more often may be prioritized for verification over match(es) for content viewed less often. Continuing with the example, matches may be listed in a queue in decreasing order of content viewing frequency and in this embodiment the re-matching queue may be superimposed over the viewing frequency queue, meaning that match(es) for a more frequently viewed content item is/are prioritized over match(es) for a less viewed content item.

In some embodiments, if verification module 640 has determined that a content item should be re-matched, CAM 450 may determine (for example using a load balancing mechanism) the amount of resources to be invested in re-matching content. For instance, in one of these embodiments based on the last time a content item was consumed, if probability shows that in another hour this content item will be viewed again, CAM 450 may want to ensure that re-matching will occur within the next hour.

In another example, CAM 450 may determine the optimal exploitation of resources. For example CAM 450 may decide whether to check for successive statistics regarding specific matching. As another example, assuming an embodiment where matching ads are sought, CAM 450 may decide whether to search thoroughly in an ads warehouse or to use advertisement web suppliers for ad-sensing. This decision for example can affect the duration of the re-matching.

In embodiments where re-matching is required (based on verification performed by verification module 640), CAM 450 may in some cases build on the spot (i.e. during run-time) a roadmap of steps, in order to complete the optimal re-matching.

In some embodiments, once a successful re-match has been made, the old match statistical information is maintained for later use and analysis. In other embodiments, the old match statistical information may be discarded.

In certain embodiments, no matches from any CAM algorithm modules, no matches from certain algorithm modules in CAM 450, and/or no matches from certain CAM lists are verified by verification module 640. For example, in some of these embodiments, a multi-phase deployment of CAM algorithm modules occurs without verifying between phases whether or not matches from earlier phase(s) were adequate. Continuing with the example, in, one of these embodiments, matches from earlier phase(s) of the matching are placed in a rematch queue, for content analysis and matching in later phase(s), without verifying between phases the adequacy of earlier-phase matching. In this example, in some cases, between phases of matching, the content item is analyzed.

In some embodiments, in addition to or instead of verification of CAM association results, verification module 640 may be used to verify the association results prepared by CCM 470 for output. For example in one of these embodiments, verification module 640 may determine whether the results prepared by CCM 470 will be retained or discarded. Continuing with the example, if the results will be discarded, in some cases, verification module 640 may determine that new results will be prepared by CCM 470 based on the same CAM outputs (for example from the same outputted CAM lists), that new results will be prepared based on different CAM outputs, or that new results will not be prepared.

In one embodiment where verification module 640 evaluates the association results prepared by CCM 470, the verification is based on a standard deviation distancing methodology. For example, as described above, verification module 640 can check the standard deviation representing the gap between the match rank to what is allowed.

In one embodiment, where verification module 640 verifies the association results prepared by CCM 470, and CCM 470 separately prepares association results corresponding to different association phases, the association results with the highest rank are verified, regardless of the timing of the corresponding phase. In another embodiment, verification module 640 verifies the prepared association results from the last phase, assuming that association results inherently improve with each phase.

In other embodiments, verification module 640 may not verify the association results prepared by CCM 470 for output.

Although verification module 640 is shown in FIG. 6 as part of CAM 450, in another embodiment, verification module 640 may be included in CCM 470 or may be divided between CAM 450 and CCM 470.

The description of FIG. 6 should not be construed as limiting CAM 450, and as stated above, not all the modules shown in FIG. 6 are necessarily included in all embodiments of CAM 450.

Additional details on some embodiments of CCM 470 are now provided. In some embodiments of the invention, CCM 470 receives the results of the association performed by algorithm modules of CAM 450 and prepares the results for output. Depending on the embodiment, these results may or may have not undergone verification by verification module 640 prior to being provided to CCM 470. Therefore, although for the sake of brevity the description does not always explicitly state that the association results of the CAM algorithm modules (for example lists of associated content outputted by the algorithm modules) may be optionally verified prior to being processed by CCM 470, it should be understood that some embodiments allow for that possibility.

As mentioned above, in some embodiments CCM 470 produces a unified content stream based on the association results from one or more algorithm modules. The unified content stream may include non-advertisement and/or advertisement content items (or parts thereof) depending on the embodiment. For example in some of these embodiments, a unified content stream may include advertisements which are hidden interlaced in non-advertisement content, with CCM 470 deciding on the position of the hidden interlacement dependent on the non-advertisement content. Continuing with the example, in one of these embodiments if the non-advertisement content is a basketball movie video and the advertisement offers NIKE™ shoes, the advertisement may be interlaced so as to be displayed when a dunk is being made and therefore draw more attention and interest than if the banner were displayed during regular play. Additionally or alternatively in this example, there might be an icon on the player who has made the dunk, where pressing on the icon initiates static and/or dynamic Ads.

As mentioned above, in some embodiments, CAM 470 additionally or alternatively aggregates (for example combine, prune, adjust, enhance, etc) some or all of the association results of various CAM algorithm modules, for example aggregating one or more lists of associated content compiled by one or more modules of CAM 450 for a given content item. In accordance with certain of these embodiments, CAM 450 comprises several algorithm modules, each of which is able to build one or more lists of associated content items (e.g. recommendation list(s)) for the given item using for example various analysis tools and/or for example using various internal rules (possibly implementation specific) which may be based inter-alia on knowledge of the specific content type being handled. In one of these embodiments, each associated content item on a list generated by a CAM algorithm module is also ranked by the algorithm module, for example indexed, weighted or otherwise numbered by the preferences of the algorithm module. In this embodiment, the order of items in the list may implicitly express the ranking, and/or the rank for each item on the list may be explicitly outputted by the algorithm module. In some cases, the various lists generated by various CAM algorithm modules are bundled together and sent as a recommendation bundle to CAM 470 for processing.

In embodiments where the various lists generated by various CAM algorithm modules are provided to CCM 470, CCM 470 aggregates (for example, combines, integrates, prunes, and/or enhances) some or all of the various lists into one or more cohesive (aggregated) associated content list(s), for example one cohesive recommendation list of items that CCM 470 predicts that the content consumer of the given content item would be interested in. In one of these embodiments, the content consumer may be provided with the associated items on any aggregated list prepared by CCM 470, with the aggregated list(s) of associated items (for example, with links to the items) and/or with any other indication(s) of the associated items.

As mentioned above, when preparing an aggregated list, in some cases, CCM 470 may ignore a particular list generated by a particular CAM algorithm (for any appropriate reason). For example, in one embodiment in a multi-phase deployment of the algorithm modules, lists from earlier phases may in some cases be ignored (although in another embodiment, earlier phase lists may not be ignored). Continuing with the example, assume the quick hit algorithm is executed first prior to analysis of the content item and then other algorithms are executed after the analysis of the content item. In this example, CCM 470, if deployed after the postanalysis association phase, may in some cases ignore the quick hit algorithm results and only aggregate the results from the later-executed algorithms. The ignored list(s) may or may not be outputted separately.

As another example, CCM 470 may ignore one or more CAM lists when preparing a particular aggregated list as specified by a content consumer, mediator or other entity. Continuing with the example, in some embodiments, the CAM algorithm modules collectively generate a plurality of content lists for any given content item. Such lists may differ from one another by the items they contain. For example, one CAM list can contain items that are deemed very similar to the given item, while another list may contain items that are from the same broad category but are less related. (As mentioned above, the CAM lists are not restricted to matching similar content; a list can contain additionally or alternatively include items that have metadata similarity with the given item—for instance the same user created both items.) It is assumed that each CAM list provided to CCM 470 is distinguishable and therefore CCM 470 can distinguish to which CAM list an associated content item belongs. In one of these embodiments, TPM 440, supports a request for associated content that specifies a certain list, or a subset of lists generated by the CAM algorithm modules. Such a request, when forwarded to CCM 470, will return only associated items that belong to the specified list(s) (i.e. an aggregated list prepared by CCM 470 will only include associated items from the specified list(s)). In some cases, the returned results will contain, for each item, an identification of the CAM list from which the item originated. Such information can be used by a client, if desired, to divide the associated results into separated lists for display purposes. Assuming embodiments where not all CAM lists are aggregated, the aggregated list may include only content items from various lists generated by a particular algorithm module, or the aggregated list may include content items from various lists generated by various algorithm modules (where for each of the various algorithm modules all of the lists or only some of the lists generated by that algorithm module may be aggregated depending on the embodiment).

Additionally or alternatively, in some cases, CCM 470 may generate a plurality of aggregated lists each aggregating various lists from CAM algorithm modules (there may or may not be overlap between the CAM lists that are aggregated into each aggregated list). The decision to generate more than one aggregated list may be made for any appropriate reason.

Additionally or alternatively, CCM 470 in some cases aggregates all the available CAM lists (or all available CAM lists from the same phase) into one or more aggregated lists.

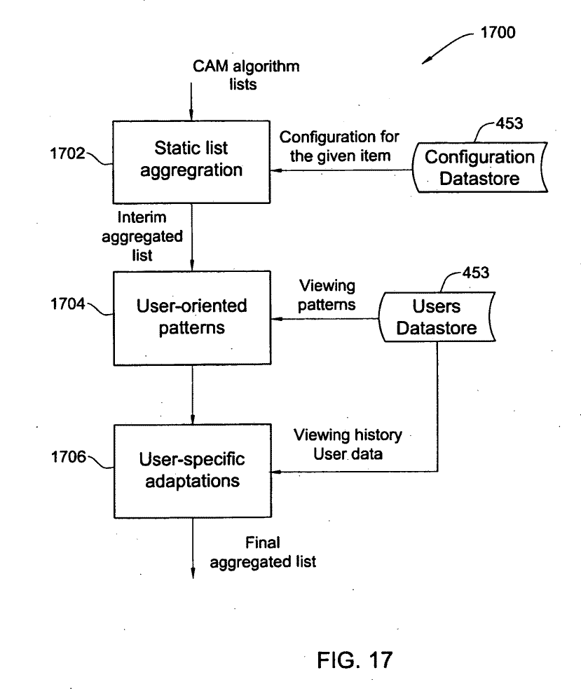

Refer to FIG. 17 which is a flow diagram of a method 1700 for CCM 470 producing an aggregated list of associated content, in accordance with an embodiment of the invention. In the illustrated embodiment, for simplicity of description, it is assumed that one aggregated list is generated by CCM 470. In other embodiments, method 1700 may include less, more and/or different stages than illustrated in FIG. 17, and/or stages may be performed in a different order. In other embodiments, additionally or alternatively, stages shown as sequential may be performed in parallel and/or vice versa.

In the illustrated embodiment, in stage 1702, CCM 470 aggregates some or all of the available lists outputted by some or all of the CAM algorithm modules using a static configuration from configuration datastore 453. For example, CCM 470 may determine the base weight of each included list based on static (configuration) parameters including inter alia: the algorithm that generated the list, the length of the list, etc. In this embodiment, the score of each associated content item, which was initially given by the algorithm module that generated the list, is adjusted by the weight of the list as determined by the configuration. In this embodiment, CCM 470 then generates an interim (aggregated) list, for example where the order of the associated content items on the list is determined based on the adjusted score. In some cases, the static configuration may vary from item to item, for example because a particular CAM algorithm may provide a better list of associated content for one content item than for another.

In the illustrated embodiment in stage 1704, the consuming (e.g. viewing) patterns of the content consumer and optionally of other similar users (from users datastore 453) are taken into account. One example of many for such adjustment is determining which lists recommended in the past items that the content consumer picked, and increasing the rank of items these lists are suggesting now.

In the illustrated embodiment in stage 1706, adjustments to the list are made based on the consuming (e.g. viewing) history of the content consumer (e.g. specific items the user consumed or is consuming now) and/or based on other relevant user data about the content consumer, from users datastore 453. One example of many for such adjustments is removing items that are not appropriate for the content consumer, based on his or her age. Another example is removing items that have previously been consumed. Depending on the embodiment, the order of associated content items on the aggregated list may implicitly express the ranking and/or the rank for each associated content item on the list may be explicitly outputted by the algorithm module.

In one embodiment, the aggregated list(s) (for example as generated by method 1700) may be used in generating unified content. For example, CCM 470 may aggregate some or all of the available CAM lists into one or more aggregated list(s). Continuing with the example, CCM 470 may then unify some or all of the content items on one or more of the aggregated list(s) with the content item for which association was executed. Continuing with the example, in some cases different unified streams may be created, each unifying one or more associated content items from a different aggregated list with the content item for which association was executed.

In one embodiment, CCM 470 unifies content based on best matches (i.e. one or more highest ranked matches), for example as determined by one or more algorithm modules or as determined during the aggregation process (for example in method 1700).

In some cases, CCM 470 is capable of machine learning. For example, CCM 470 may determine that the content items on a certain association list outputted by a certain algorithm module are not well received or very well received and may accordingly adjust the base weight given to that list. As another example, CCM 470 may determine that a particular group of similar content consumers or a particular content consumer reacts positively or negatively to items on a certain association list outputted by a certain algorithm module and may accordingly in stage 1704 or 1706 adjust the base weight of content items on that association list.

As mentioned above, in certain embodiments, CCM 470 is capable of preparing association results for output in a way that takes into consideration one or more kinds of constraints. For example, in embodiments where advertisement content is matched to non-advertisement content (for example videos), CCM 470 may in some cases take into consideration several kinds of constraints, such as budget constraints of advertisers, time constraints of publishers, etc. In these embodiments, under these constraints, CCM 470 performs an optimization process for a target function, for example in order to achieve an optimal expected response rate of users to advertisements.

As mentioned above, in some embodiments, CCM 470 is capable of performing an optimization process with respect to specified criteria which are not necessarily constraints, when preparing association results for output. For example, CCM may in one of these embodiments perform optimization for a target function, for example to optimize the expected time a content consumer will stay in a publisher's site, the number of items consumed, the average rating provided to items and/or other satisfaction measures of a content consumer (for example as discussed above with respect to event handling module 608), etc. As another example, in embodiments where advertisement content is matched to non-advertisement content, the criteria may additionally or alternatively include advertiser/publisher requests (such as genres of videos which should or should not be matched to particular ads, or how to match non-advertiser content with various popularity levels to ads with various levels of system compensation).

In other embodiments, CCM 470 may not take into account constraints, other types of criteria and/or target functions, when preparing association results for output.

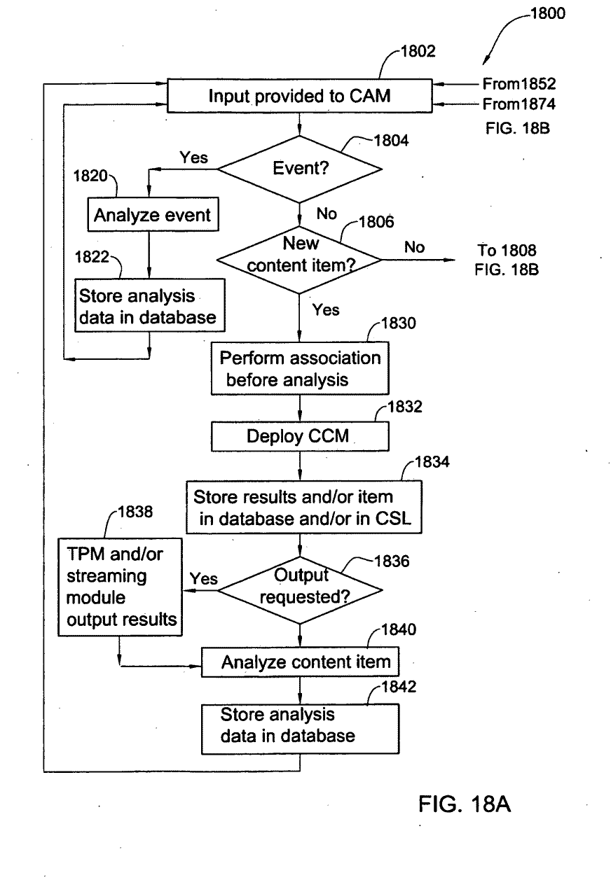

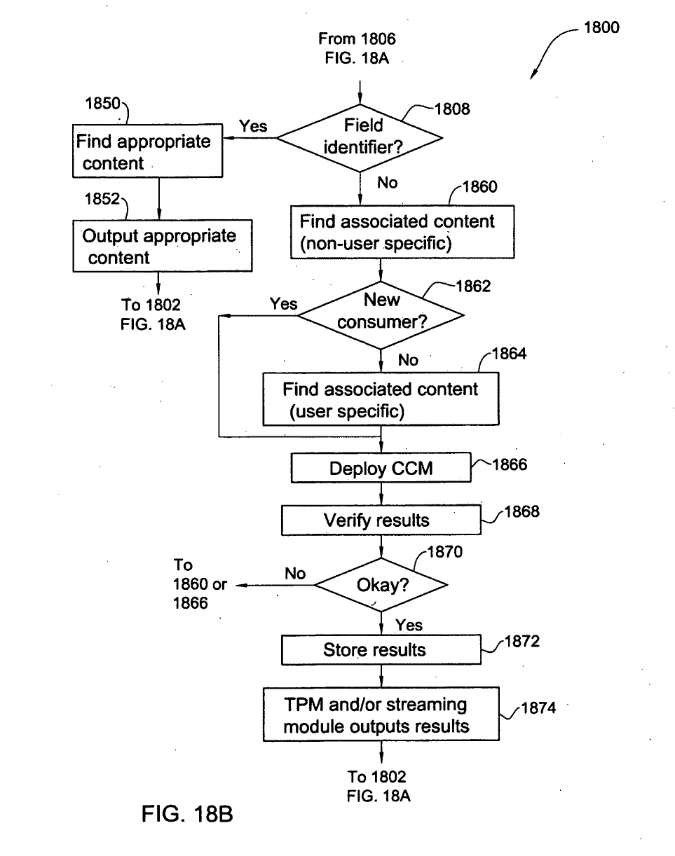

FIG. 18 illustrates a flow diagram of a method 1800 of associating content, according to an embodiment of the present invention. For ease of understanding, a correspondence will be provided between stages of method 1800 (FIG. 18) and stages of method 500 (FIG. 5). It should be understood however that method 1800 describes but one example of implementation of method 500.

In the illustrated embodiment in stage 1802 an input is recognized by CAM 450, for example after being pulled by or pushed to TPM 440. This stage corresponds to one embodiment of stage 510 of method 500.

It is assumed for the sake of simplicity in the illustrated embodiment that the input may include inter-alia any of the following: a new content item or a part thereof (and corresponding meta-data), an event, a field identifier (e.g. distribution channel identifier), or a request for association results for a previously analyzed content item (with the request for example indicated by inputting an item identifier or other inherent identification of the content item such as an identifier of unified content including the content item or an identifier of a portion teaser). Depending on the embodiment, the new content item may or may not be accompanied by a request for outputting results. Depending on the embodiment, the new content item may or may not be part of a batch of newly received items. Depending on the embodiment, a request for association results may or may not be accompanied by an identifier of a content consumer or a specification of CAM list(s) from which association results should originate. In some embodiments, not all of these inputs may be relevant, for example depending on the input mode (basic, intermediate or advanced).

Therefore in the illustrated embodiment stages 1804, 1806 and 1808 determine subsequent stages based on the type of provided input (corresponding to one embodiment of stage 510).

In the illustrated embodiment, assuming that the input is an event (yes to stage 1804), in stage 1820 the event is analyzed, for example using event handing module 608 as described above. This stage corresponds to one embodiment of stage 520. In one embodiment stage 1820 may be performed by execution of method 1100. In stage 1822, analysis data relating to the event is stored in database 453. This stage corresponds to one embodiment of stage 530. In one embodiment stages 1820 and 1822 may be performed offline, but in another embodiment stage 1820 and/or 1822 may be performed partly or fully online. As explained above, the analyzed event may be considered (taken into account) when associating content. Following stage 1822, method 1800 iterates to stage 1802 for the next input.

Assume instead that the input provided to CAM 450 in stage 1802 is a new content item (yes to stage 1806) i.e. a content item which is unknown to CAM 450 (e.g. which has never been processed by CAM 450 or whose processing cannot be accessed by CAM 450) and which CAM 450 now becomes aware of. In some cases, static meta data is assumed to also have been received by CAM 450. In the illustrated embodiment, in stage 1830 association for the new content item is performed prior to analyzing the item. For example quick hit module 622 may be deployed with quick hit module 622 basing the association attempt on available meta-data received by CAM 450 (and possibly also based on events known to CAM 450) without the benefit of additional meta data generation by CAM 450. This stage corresponds to one embodiment of stage 520 of method 500. In one embodiment, stage 1830 may be performed by execution of method 1200 of FIG. 12.

In the illustrated embodiment in stage 1832, CCM 470 may be deployed to prepare the association results from stage 1830 for output, where the preparation may for example include inter-alia the production of unified content and/or the aggregation of results from some or all of the available CAM lists (in one embodiment the lists specified in the request). For example, assuming the quick hit algorithm was performed in stage 1830, CCM 470 may in some cases generate unified content based on the results of a quick hits algorithm. Optionally CCM 470 may take into account constraints and/or other criteria as described above. This stage corresponds in one embodiment of stage 520 of method 500. In another embodiment, stage 1832 may be deferred in case results do not need to be outputted. In another embodiment, stage 1832 may be omitted, for example because the results from stage 1830 may be outputted as is or not outputted.

In the illustrated embodiment, in stage 1834 association results (as generated in stage 1830 or as prepared in stage 1832) are stored. For example assuming the quick hits module was executed in stage 1832, unified content based on the results of the quick hits module, and/or an indication of the associated content determined by the quick hit module may be stored in databases 453 and/or CSL 460. In one embodiment, alternatively or additionally the content item is stored in stage 1834, for example in CSL 460. Stage 1834 corresponds to one embodiment of stage 530.

In the illustrated embodiment in stage 1836, it is determined if association results from stage 1830 or 1832 should be outputted. This stage corresponds to one embodiment of stage 540.

In the illustrated embodiment, in stage 1838, if association results should be outputted, the results, or partial results, as generated in stage 1830 or prepared in stage 1832 are outputted by TPM 440 and/or streaming module 490, if necessary after translation into an appropriate representation. This stage corresponds to one embodiment of stage 550. For example assuming the quick hits algorithm was executed in stage 1830, unified content based on the results of the quick hits module, a downloading identifier of the unified content, and/or an indication of the associated content determined by the quick hit module may be outputted or a part thereof (for instance only part of the unified content) may be outputted by streaming module 490 and/or TPM 440. In some embodiments, the association results are only outputted if further analysis did not take place prior to the time that output of results is expected. For example, in one of these embodiments, if association results are requested prior to stage 1840 being completed, then stage 1838 is executed. In other embodiments, the association results may always be expected to be outputted when completed, for example in order to demonstrate the capabilities of system 400 or a variation thereof, because the input in stage 1802 included a request to output association results for the new content item as soon as available, because the content item is currently being consumed, and/or for any other appropriate reason.

In one embodiment stages 1830 to 1838 are performed online, but in another embodiment any of stages 1830 to 1838 may be performed partly or fully offline.

In one embodiment stages 1830 to 1838 are omitted and after stage 1806 (and optionally storage of the content item), method 1800 proceeds directly to stage 1840.

In the illustrated embodiment, in stage 1840, the new content item is analyzed. For example, enrichment module 602 and/or classification module 604 may be deployed. This stage corresponds to one embodiment of stage 520 of method 500. In one embodiment, stage 1840 may be performed by execution of method 700 of FIG. 7 and/or method 1000 of FIG. 10 (with optional deployment of dimension reduction module 606 as described above).

In the illustrated embodiment, in stage 1842, the analysis-data of stage 1840 and is stored in database 453. This stage corresponds to one embodiment of stage 530 in method 500. As an alternative to the order illustrated in FIG. 18, in one embodiment stage 1840 and/or 1842 may not be delayed until after stage 1838 but may be performed in parallel to any of stages 1830 to 1838.

In one embodiment, stages 1840 and 1842 are performed offline, but in another embodiment stages 1840 and/or 1842 may be performed partially or fully online. In one embodiment, CAM 450 may consider the new content item when determining associated content for another content item. Following stage 1842, method 1800 iterates to stage 1802 for the next input.

Assume instead that a field identifier (e.g. distribution channel identifier) is received (yes to stage 1808). In the illustrated embodiment, in stage 1850, CAM 450 finds stored association results (for example unified content) which are appropriate for the field identifier. Stage 1850 corresponds in one embodiment to stage 520 of method 500. In stage 1852, the appropriate association results are outputted. For example, CAM 450 may provide a list of identifiers (descriptors) of appropriate unified content files stored in CSL 460 to TPM 440, and TPM 440 may cause streaming module 490 to stream those files. Stage 1852 corresponds to one embodiment of stage 550. Depending on the embodiment, stages 1850 and 1852 may be performed online or offline. Following stage 1852, method 1800 iterates to stage 1802 for the next input.

Assume instead that a request for association results (post-analysis) for a known content item is received in stage 1802. (For example, a content item identifier for a known content item, an identifier of unified content including the known content item, or an identifier of a portion teaser, may be received whenever association results are desired). In one embodiment, association results are requested for a content item each time the content item is being consumed by a content consumer. However in other embodiments results may be requested even if the item is not currently being consumed, and/or results may not be requested each time the item is consumed. For example, in some cases, a newly received content item may implicitly or explicitly include a request for post-analysis association results on a one time basis or on a periodic updated basis. In this example any of stages 1860 to 1874 would be executed after stage 1842 and possibly periodically re-executed (for example off-line) without necessarily separately receiving further input.

In the illustrated embodiment in stage 1860 assuming post analysis association results were requested, non-user specific association algorithms are performed. For example, in stage 1860, there may be a partial deployment of focused module 624 and/or category module 626. For example, in one embodiment stage 1860 may be performed by execution of stages 1302 to 1306 of method 1300 and/or stage 1402 to 1408 of method 1400. Stage 1860 corresponds to one embodiment of stage 520 of method 500.

In the illustrated embodiment, in stage 1862 it is determined whether or not the current consumer (if any) is known to CAM 450. If there is no current consumer or the current consumer is new (i.e. there is no previously accumulated data relating to the user which CAM 450 may access), then stage 1864 which represents the execution of user specific association algorithms is skipped. If there is a current consumer who is known then stage 1864 is executed where user specific association algorithms take into account previously accumulated data relating to the user.

In the illustrated embodiment in stage 1864, association of the content item using one or more user specific algorithms is performed. For example, in one embodiment, where the content consumer is not a new user, any of CF module 628 (method 1500), associative CF module 630 (method 1600), completion of category module 626 (stages 1410 to 1414), and/or completion of focused module 624 (stages 1308 to 1312) may be deployed in stage 1864. Stage 1864 corresponds in one embodiment of stage 520 of method 500.

In the illustrated embodiment in stage 1866, CCM 470 is deployed to prepare the association results for output. The preparation may include for example inter-alia the production of unified content and/or the aggregation of results from some or all of the lists generated by the CAM algorithms (in one embodiment, the lists specified in the request). Optionally CCM 470 may take into account constraints and/or other criteria as described above. Stage 1864 corresponds to one embodiment of stage 520 of method 500. In another embodiment where it is assumed that verification will take place, at least part of stage 1866 may be deferred until after verification. For example in some cases when stage 1866 includes production of unified content, the production of the unified content may be deferred until after that the matching of the content items comprised in the unified content has been verified.

In the illustrated embodiment in stage 1868, verification module 640 is deployed to verify the association results, for example using a standard deviation distancing methodology. For example, assuming the preparation includes results aggregation and/or production of unified content, the verification may occur after aggregation, if any, of results, and before production, if any, of unified content. Stage 1868 corresponds to one embodiment of stage 520 of method 500.

In the illustrated embodiment in stage 1870 it is determined whether the verification deemed the association results satisfactory or not. If based on the verification, the results are not satisfactory (no to stage 1870) then depending on the embodiment method 1800 may iterate, for example to stage 1860 or 1866 in order to generate results with an improved satisfaction level. If the results are satisfactory then method 1800 continues with stage 1872. In another embodiment stages 1868 and 1870 may be omitted, for example because it is assumed that the prepared association results are satisfactory, and stage 1872 follows directly after stage 1866.

In other embodiments, verification may additionally or alternatively occur at one or more other points in method 1800. For example, in various embodiments, verification may occur after between the pre-analysis association phase (1830) and post analysis association phase (1860/1864), or between periodic post analysis association phases (iterations of 1860/1864), in order to determine whether the next association phase should take place or the results from the previous phase were satisfactory.

In the illustrated embodiment in stage 1872, association results (as generated by the CAM algorithm modules and/or as prepared by CCM 470 (optionally after having been verified)) are stored. For example, unified content and/or an indication of the associated content (for example the associated content item(s) and/or list(s) of associated content item(s) possibly with link(s) to the associated content item(s)) may be stored in databases 453 and/or CSL 460. This stage corresponds to one embodiment of stage 530.

In the illustrated embodiment in stage 1874, association results (as generated by the CAM algorithm modules and/or as prepared by CCM 470 (optionally after having been verified)) are outputted by TPM 440 and/or streaming module 490, if necessary after translation into an appropriate representation. This stage corresponds to one embodiment of stage 550. For example, unified content, a downloading identifier thereof, and/or an indication of the associated content (for example the associated content item(s) and/or list(s) of associated content item(s) possibly with link(s) to the associated content item(s)) may be outputted by streaming module 490 and/or TPM 440. In another embodiment, partial association results may be outputted. For example if unified content was produced, then in some cases only part of the unified content may be outputted.

In one embodiment, stages 1860 to 1874 are performed online. In another embodiment, any of stages 1860 to 1874 may be performed partly or fully offline.

In another embodiment, stages 1862 to 1866 may be omitted, and optionally stages 1868 to 1870 may be omitted. In this embodiment, the association results stored in stage 1834 may be passed for verification in stage 1868 and outputted if verified in stage 1874, or the association results stored in stage 1834 may be outputted without prior verification in stage 1874. For example, in some cases, stored unified content from stage 1834 may be verified and/or outputted.

In one embodiment, the association results that are verified in stage 1868 may be the post analysis association results (from stages 1860 to 1866) or the pre-analysis association results (from stages 1830 to 1832), depending on which results were ranked higher. In this embodiment, if the results (from pre-analysis or post analysis) were deemed satisfactory, the results are partially or fully stored and/or outputted. In another embodiment, the association results that are verified in stage 1868 are the post analysis association results (from stages 1860 to 1866), and if deemed satisfactory these results are partially or fully stored and/or outputted.

In the illustrated embodiment, following stage 1874 method 1800 iterates to stage 1802 for the next input.

In some embodiments, method 1800 may include less, more and/or different stages than illustrated in FIG. 18, and/or stages may be performed in a different order. For example, depending on the input mode (see above discussion), some stages may or may not be relevant. Continuing with the example, handling of some or all event inputs (stages 1820 to 1822) may only be relevant in advanced mode. In other embodiments, additionally or alternatively, stages shown as sequential may be performed in parallel and/or vice versa.

Method 1800 may be used in various contexts depending on the embodiment. For example, assuming it is desired to match ads with video content, in one embodiment, CAM 450 may decide on-the-fly (i.e. online) and/or offline, for example during execution of any of stages 1830, 1840, 1860 and/or 1864, which ads to match with which videos, based for example on any of the following inter-alia: the viewer profile (for instance where the viewer is from, whether the viewer already saw the ad and did not respond positively to the ad, etc), attributes of the content (language of the ad, language of the video, etc) and the request (profile) that the advertiser set when the advertiser created the ad campaign. (The request profile could be considered part of the meta-data received for an ad content item). Continuing with the example, in some cases CCM 470 may decide in stage 1806 or 1844 that a highly paid campaign should be coupled with video that is highly ranked, frequently watched and was uploaded/created by a highly ranked user/creator. Continuing with the example, in some cases, if the creator of a the video has in the past had high ranking hits (i.e. content by the creator was viewed many times) then a video item by the creator may be expected to provide a high return on investment for an advertiser whose advertisement is coupled with the video item.

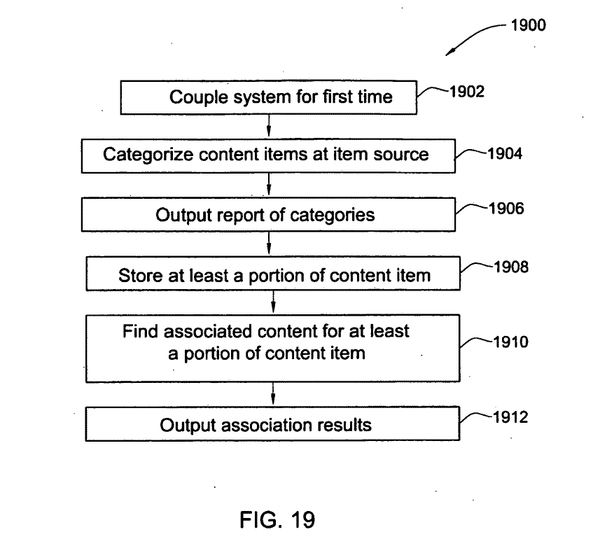

FIG. 19 illustrates a flow diagram of a method 1900 of associating content, according to an embodiment of the present invention. In other embodiments, method 1900 may include less, more and/or different stages than illustrated in FIG. 19, and/or stages may be performed in a different order. In other embodiments, additionally or alternatively, stages shown as sequential may be performed in parallel and/or vice versa. For ease of understanding, a correspondence will be provided between stages of method 1900 (FIG. 19) and stages of method 500 (FIG. 5). It should be understood however that method 1900 describes but one example of implementation of method 500.

Method 1900, in the illustrated embodiment, is executed when an entity with an item source is first coupled to system 400 or to a variation thereof, and therefore none of the content items in the item source is yet known to the system. In accordance with certain embodiments, system 400 (or a variation thereof) supports, inter-alia “plug and play” or any other type of coupling. In some of these embodiments, once installed at an entity including an item source, the system will automatically analyze and characterize the kind of content according to its description (for instance by analyzing its database or its web pages description), the streaming servers used (if any), and so on in order to establish a targeted solution for the entity. For example, assuming unified content is desired where the unified content includes non-advertisement content (say videos) and advertisement content. In this example, once plugged in or otherwise coupled, the system can in some cases automatically decide what is the best way to automatically transform video content to video coupled with Ads video. If in this example it is further assumed that distribution channels for the unified content is desired, the system can in some cases propose categorized Distribution Channels, according to key words spotted at the video description. Continuing with this example, once the system has proposed a solution, the entity can (optionally) adopt the solution, in order to meet the entity's needs. In one embodiment, if the entity chooses to complete the installation process (i.e. to adopt the proposed solution), the system can interlace within the entity, for example executing method 1800 when necessary (e.g. when relevant input is provided to the system).

In one embodiment, method 1900 is executed online but in another embodiment method 1900 may be executed partially or fully offline.

In the illustrated embodiment in stage 1902, system 400 or a variation thereof is plugged in to/installed (or otherwise coupled with) a certain entity with an item source, for the first time. This stage corresponds to one embodiment of stage 510, with content items at the item source included in the entity therefore becoming available to system 400 or a variation thereof.

In the illustrated embodiment, in stage 1904, TPM 440 examines the content items at the item source of the entity. For example, TPM 440 may use user agent 442 to examine initial parameters such as the website (domain) of the entity and/or a database of the entity which includes a table containing meta-data on the content items at the item source. In some cases, TPM 440 may perform an analysis of the entity's website and/or entity's database (containing meta-data on the content items) in order to determine the scope (i.e. subject matter) of content at the item source and more specifically categories suitable, for categorizing content at the item source. For example, in some embodiments the website examination may include TPM 440 crawling the entire domain, using keywords that may in some cases be distinct from the meta data web-html pages description (i.e. keywords that are not necessarily explicitly written on the WebPages). Continuing with the example, an item may be categorized by a website in the sports category, but TPM 440 will try to deduce more specific information based on keywords, for example whether the item relates to basketball, soccer, etc, so that the item can be categorized into one of the various types of sports. As another example, in some embodiments the database analysis can include TPM 440 logging into the database and querying all tables for information that may in some cases be distinct from the meta-data tables. Continuing with the example, in one of these embodiments, the database table may hold information related to sports and which can be categorized into various types of sports such as basketball and soccer. Stage 1904 corresponds to a continuation of one embodiment of stage 510 of method 500, where static meta data such as categories relating to the items at the item source are pulled by TPM 440.

In another embodiment stage 1904 may be performed by CAM 450.

In the illustrated embodiment in stage 1906, TPM 440 generates and outputs a quick report with the examination data, for example so that a representative of the entity can approve the categories. Stage 1906 corresponds to a continuation of one embodiment of stage 510 of method 500, where TPM 440 requests approval of the pulled information.

In the illustrated embodiment in stage 1908, TPM 440 grabs at least a portion of a content item (for example at least a portion of a live video) at the item source of the entity and stores the “grabbed content” locally, for example so at to later be able to demonstrate system streaming capabilities. Stage 1908 corresponds to one embodiment of stages 510 and 530, where at least a portion of specific content item is provided and stored.

In the illustrated embodiment in stage 1910, TPM 440 requests that CAM 450 deploy one or more algorithm modules to find one or more associated content items for the grabbed content. For example, in one embodiment, CAM 450 deploys quick hit module 622 to provide quick hits, for example by performing method 1200. Stage 1910 corresponds to one embodiment of stage 520 of method 500.

For example, assume embodiments where CAM 450 may associate the grabbed content with content items that are not necessarily at the item source analyzed in stage 1904 but may possibly be at other item sources. Continuing with the example, assume the content items at the item source of the entity are non-advertisement content items, such as videos and that matches with advertisements are desired. Also assume in this example that CAM 450 is not aware of advertisements (for example because no ad campaign had been launched at the system) or that CAM 450 is aware of advertisements but does not want to limit the search for matches only to known advertisements. In this example and depending on the embodiment, CAM 450 may have ads gathered relating to the approved categories determined in stage 1906, or CAM 450 may generate keywords for the grabbed content (see for example the description of stage 1212) so that ads may be gathered relating to the keywords. In this example, the ad gathering may use any appropriate mechanism, for instance automatic advertisement web suppliers. In this example, CAM 450 may decide on the best match among the gathered ads (see for example description of stage 1214).

In a similar example, assume embodiments where CAM 450 may search among known ads, for ad(s) related to the grabbed content (see for example the description of stages 1206 to 1210), in addition to or instead of the ad gathering described in the previous example. In this example, CAM 450 may then decide on the best match among the found known ads. In this example, CAM 450 may alternatively decide on the best match among the found known ads and the ads gathered by the ad suppliers which are provided to CAM 450 (see for example the description of stage 1214).

In the illustrated embodiment in stage 1912, TPM 440 launches a local website page showing the results of the association performed in stage 1910. In some cases unified content including the grabbed content and the match(es) may be shown on the webpage, for example at least a portion of the live video and matched ad(s). Stage 1912 corresponds to one embodiment of stage 550 of method 500.

An example of stages in one implementation of method 1900 is now provided:
1. In stage 1902 sport portal that has sports video content online installs system 400 or a variation thereof. (In this example, the system takes the form of a “black box”);
2. For the sake of the example, it is assumed that the sport portal holds video content of Michael Jordan's famous dunk, the video content holds meta-data containing general description, user talk-backs and “basketball” tag;
3. TPM 440 will conclude initial distinct subjects such as “basketball”, “playoffs”, “ball game” and “Chicago”, in stage 1904;
4. TPM 440 requests that CAM 450 perform Ads matching in order to create Unified Content, in stage 1910;
5. There are 2 options: a. The system holds private Ads (for example uploaded by advertisers) and/or b. The system does not hold private Ads (for example uploaded by advertisers). In both cases, CAM will initiate all mechanisms (for instance statistical information) to obtain the best-matching Ads;
6. In the case that CAM 450 holds no private Ads CAM 450 will automatically generate a robust list of relevant words matching the needs of the specific content. This list will be forwarded to a list of automatic Ads suppliers (for instance Google™ AdSense or Yahoo!™ publisher) to go and retrieve one or more compatible Ads;
7. CAM 450 will continue its matching action and further actions in order to fulfill the TPM request;
8. Unified Content is ready to be presented live in stage 1912.
   a. Fore instance, assume that previously Nike™ created, at the system, an Ads campaign for advertising Michael Jordan endorsed shoes. In addition, Nike™ requested that when relevant within the video—a proposal to buy the shoes be forwarded to their e-commerce website, should the proposal be selected;
   b. Continuing with this instance, assume that Ads could be coupled with a Michael Jordan original movie, if CAM 450 decides that the match is highly ranked and compatible. (It is possible that in some cases an actual banner/video-ad was never before coupled with that original video, while in other cases a banner/video ad had been previously coupled with the original video but a better match is attempted);
   c. Continuing with this instance, every time that Unified Content (including ad(s), the Michael Jordan famous dunk and the described strip) is played, the strip of “want to buy the new Nike Michael Jordan shoes” is shown in the bottom of the original movie. Watchers of that Unified Content can click on the strip and be forwarded to Nike e-commerce website;
   d. That movie can be distributed in any appropriate method.

Referring back to the illustrated embodiment of FIG. 4, more details on variants (i.e. variations) of system 400 will now be provided. These variants may not necessarily include all the modules illustrated in FIG. 4. Additionally or alternatively, variants of system 400 may include additional modules and/or different modules than shown in FIG. 4. For example, in some cases the differences between different systems of the invention may be due to the entity requesting service, for example (non-ad) content creator, advertiser, content consumer, etc. As another example, in some cases the differences between different systems may be alternatively or additionally due to differences in configurations not necessarily related to which entity is requesting service. As another example, the differences may be additionally or alternatively due to any relevant reason.

It will now be briefly described how system 400 can be adjusted for some of the different configurations referred to in FIG. 1. The examples presented here represent some of the possible embodiments and therefore not be construed as exhaustive.

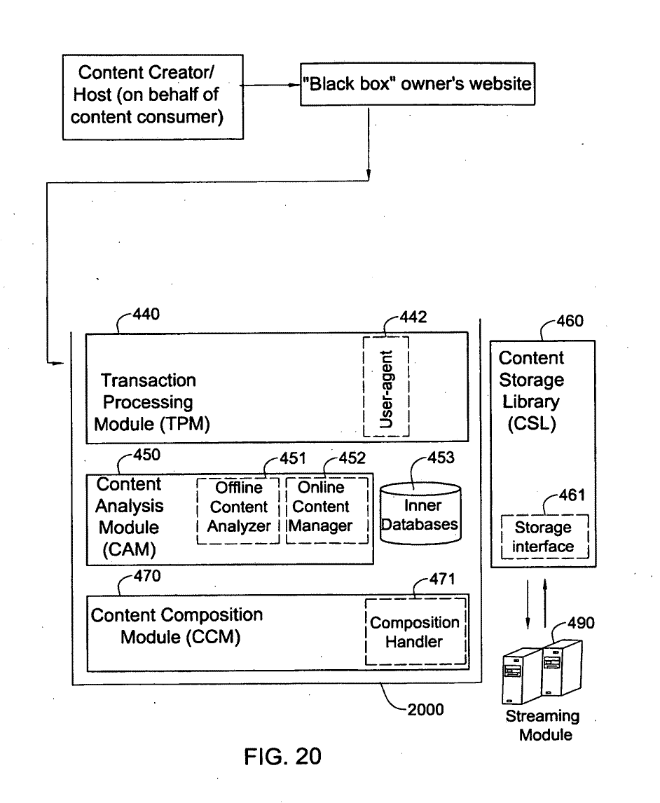

In some embodiments corresponding to configuration 1.3, the system (which is a variant of system 400) provides content management, matching services, streaming services and possibly WTM (external) services. In these embodiments a (non-advertisement) content creator using a supported content streaming client, accesses TPM 440, using user-agent API 442. In some of these embodiments, user agent 442 allows consistent accounting of media consumption and also allows TPM 440 to provide additional contexts for external services (utilized by compatible content streaming user-agents, that are provided by other systems 400 (or variations thereof) or otherwise). In one of these embodiments, the content creator can distribute content (for example by email attachment, personal webpage, blog, etc). In one embodiment, system 400 plays content, for example Unified Content, when a request is received from a client distribution means such as a blog, personal webpage or email. In some embodiments corresponding to configuration 1.3, any of WTM 430, external service interface 441, non-hosting user agent interface 443 and/or reporting interface 444 may be omitted from the system. More details on some embodiments corresponding to configuration 1.3 are provided further below with respect to FIGS. 20 to 22.

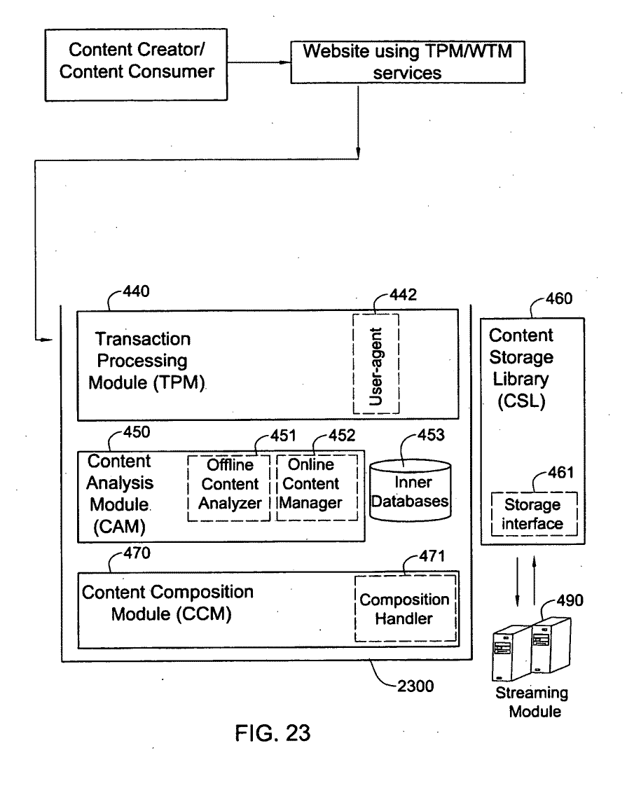

In some embodiments corresponding to configuration 1.4, the system (which is a variant of system 400) provides content management, matching services, streaming services and possibly WTM (external) services. In these embodiments, a website accesses TPM 440 via hosting user-agent 442. In some embodiments of this configuration, therefore, the website (business) does not need to invest heavily in expensive video streaming infrastructures. In some of these embodiments, the system is required, when the system is fully used, to manage the content, and the streaming of content. In one of these embodiments, the system stores the outer website content, operates online and/or offline matching in order to find associated content, manages the rank, status, usage, etc. of content, and streams content when demanded. In some embodiments corresponding to configuration 1.4, any of WTM 430, external service 441, non-hosting user agent 443 and/or reporting 444 may be omitted from the system. More details on some embodiments corresponding to configuration 1.3 are provided further below with respect to FIGS. 23 to 25.

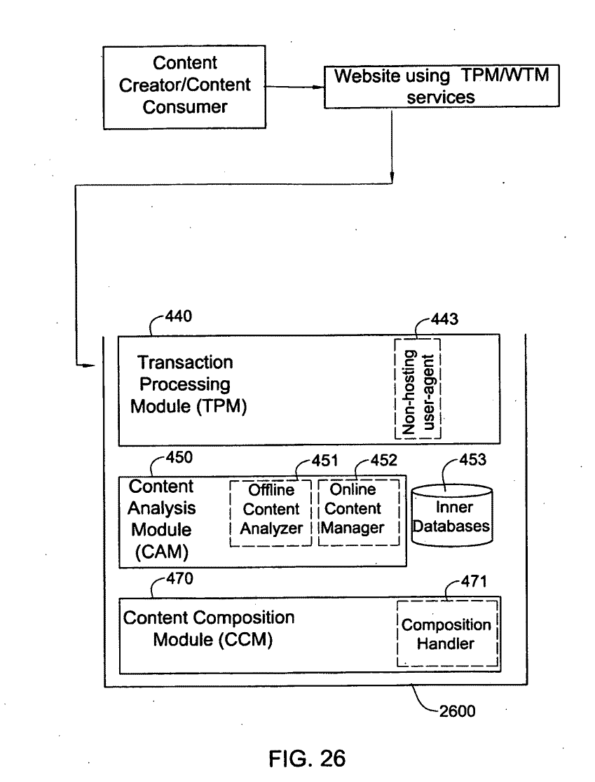

In some embodiments corresponding to configuration 1.8 where the system (which is a variant of system 400) does not provide hosting, managing, or streaming services, a website uses the system for content association without transformation of content. In these embodiments the system may or may not provide external (WTM) services. In one of these embodiments, through non-hosting user agent 443, TPM 440 offers the website indications (e.g. recommendations) of associated content. In some embodiments corresponding to configuration 1.8, any of external service interface 441, hosting user agent 442, reporting module 444, WTM 430, CSL 460, and/or streaming module 490 may be omitted from the system. More details on some embodiments corresponding to configuration 1.8 are provided below with respect to FIGS. 26 to 28.

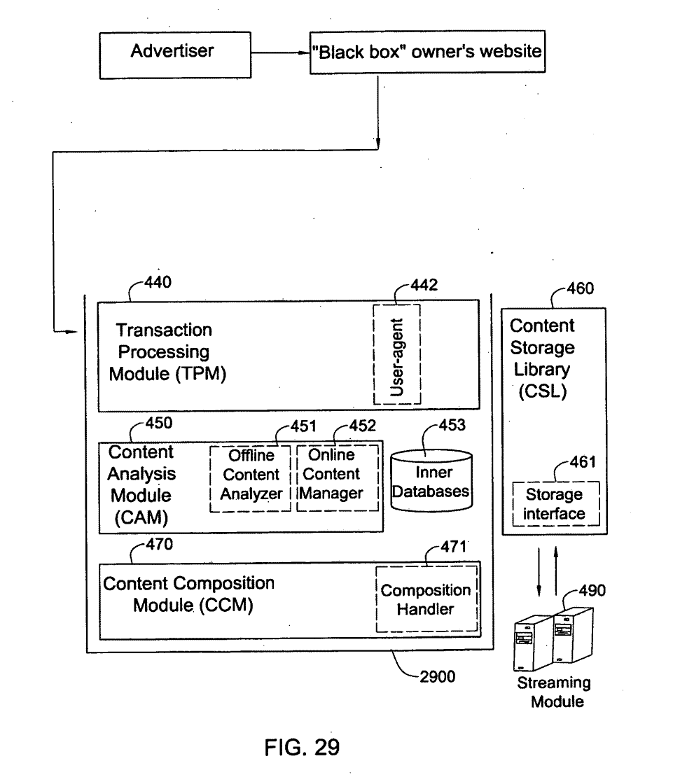

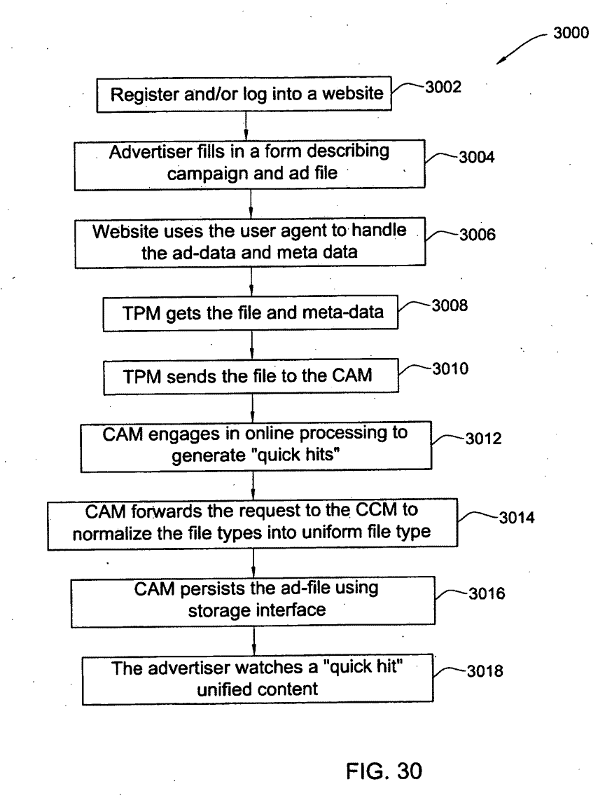

In some embodiments corresponding to configuration 1.2, the system (which is a variant of system 400) provides ad matching services, content management, streaming services and possibly WTM (external) services. In these embodiments, an advertiser accesses TPM 440 via hosting user-agent 442. In one of these embodiments, the system operates online and/or offline matching in order to match ads, and streams unified content when demanded. In some embodiments corresponding to configuration 1.2, any of WTM 430, external service 441, non-hosting user agent 443 and/or reporting 444 may be omitted from the system. More details on some embodiments corresponding to configuration 1.2 are provided further below with respect to FIGS. 29 to 30.

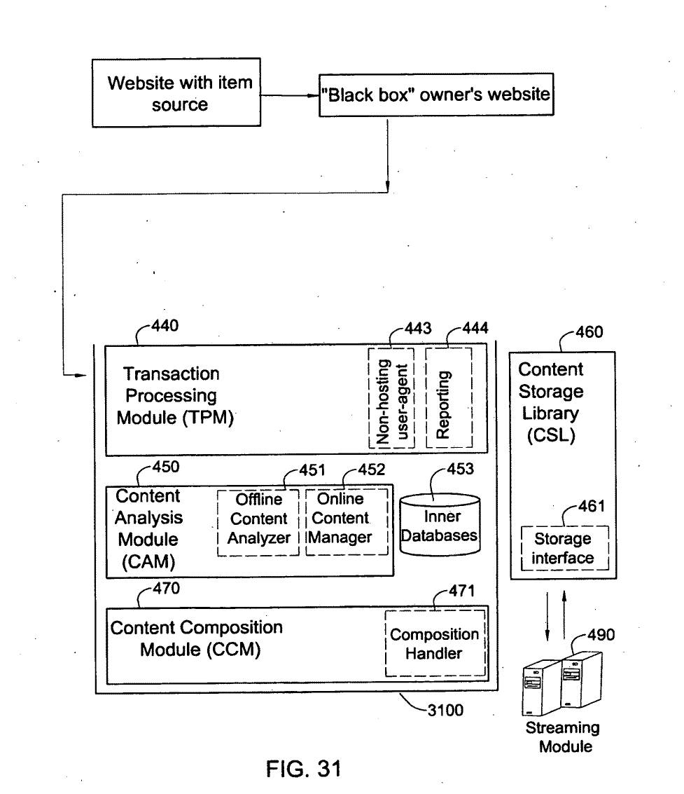

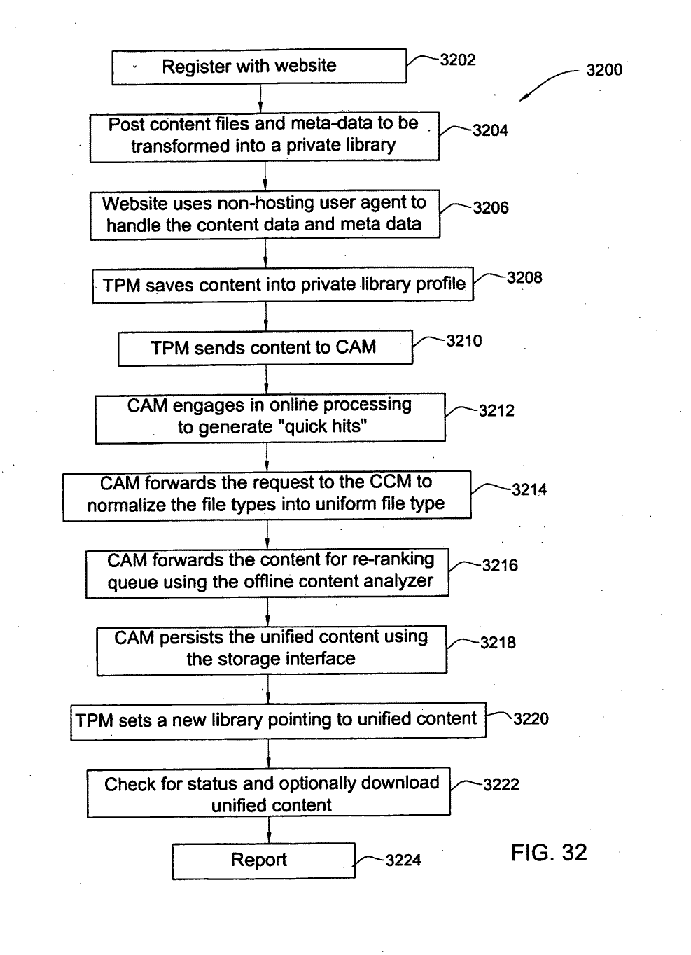

In some embodiments corresponding to configuration 1.5 where the system (which is a variant of system 400) does not provide hosting, managing, or streaming services, a website which includes an item source uses the system to transform the website's content to Unified Content. In these embodiments the system may or may not provide external (WTM) services. In one of these embodiments, through non-hosting user agent 443, TPM 440 offers the website downloads of Unified Content streams. In one of these embodiments, a reporting API or other interface 444 is offered by TPM 440 to such a website to allow reporting of media views of Unified Content, served by such websites' external streaming servers. Since, in one of these embodiments, the system does not manage the website content nor store it for later streaming, the association capabilities may in some cases be streamlined. For example in some cases, the system may not retain matching statistics, and may limit expectations for online matching (which could be compensated for in some cases by the offline matching). In another embodiment, the association capabilities are not streamlined. In some embodiments corresponding to configuration 1.5, any of WTM 430, external service 441, streaming module 490, and/or user agent 442 may be omitted from the system. More details on some embodiments corresponding to configuration 1.5 are provided below with respect to FIGS. 31 to 32.

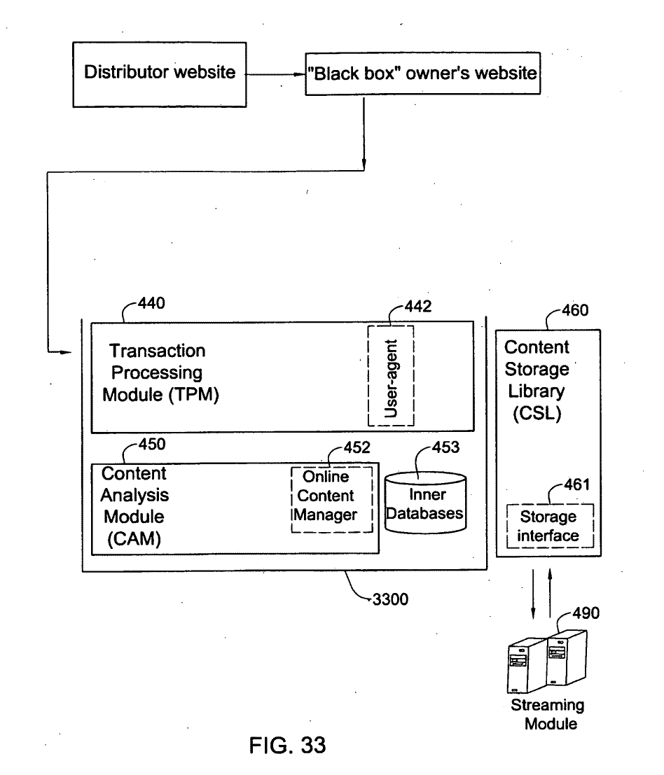

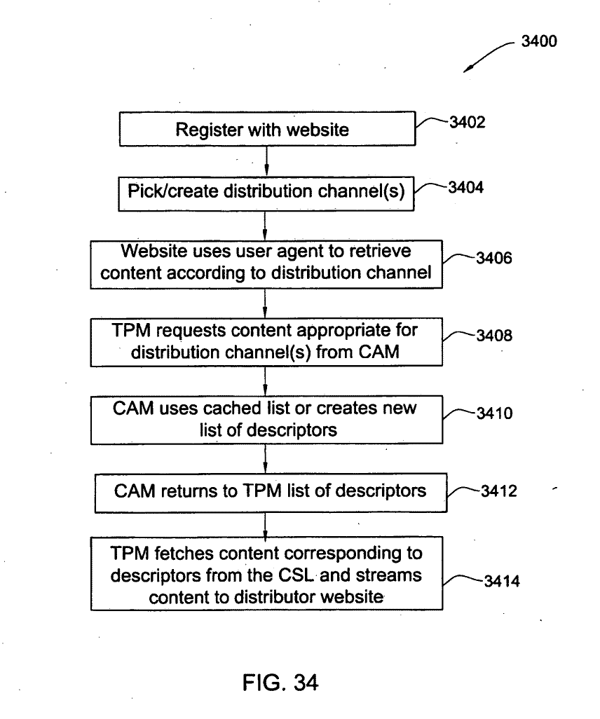

In some embodiments corresponding to configuration 1.6, the system (which is a variant of system 400) provides streaming services. In these embodiments, a (distributor) website accesses TPM 440 via hosting user-agent 442. In some embodiments corresponding to configuration 1.6, any of WTM 430, external service 441, non-hosting user agent 443, reporting 444, offline content analyzer 451 and/or CCM 470 may be omitted from the system. More details on some embodiments corresponding to configuration 1.6 are provided further below with respect to FIGS. 33 to 34.

There follows now details on some embodiments of the configurations 1.2, 1.3, 1.4, 1.5, 1.6, and 1.8. The embodiments of these configurations discussed herein should not be construed as the sole possibilities and other embodiments of these configurations may differ from what is described herein.

FIG. 20 illustrates a system architecture 2000 that is variation of system 400 and that is utilized in accordance with a certain mode of operation of configuration 1.3, in accordance with an embodiment of the invention. In accordance with one embodiment, FIG. 21 illustrates a flow diagram of a sequence of operations in accordance with the system architecture 2000 of FIG. 20, and FIG. 22 illustrates yet another flow diagram of a sequence of operations, related to FIG. 21, in accordance with the system architecture 2000 of FIG. 20. Method 2100 and 2200 of FIGS. 21 and 22 correspond to one implementation of method 1800.

More specifically, FIG. 20 elaborates on the system architecture and FIGS. 21 and 22 elaborate on two related flow figures. The architecture FIG. 20 details the use of layers and API or other types of interfaces compatible with the described scenario, i.e. (non-advertisement) content creator “stamping” his content (i.e. converting his content to unified content) at system 2000 and self distributing content. FIGS. 21 and 22 illustrate inter-alia the usage of the layers and/or interfaces in FIG. 20 taking an active part in the flow, and the correlation between these layers/interfaces. This scenario does not use the WTM layer and several interfaces that were described with reference to FIG. 4. As illustrated in FIG. 20 system 2000 includes TPM 440 (which includes user agent 442), CAM 450 (including offline content analyzer 451 and online content manager 452), databases 453, CCM 470 (including composition handler 471), CSL 460 (including storage interface 461), and streaming module 490. In the illustrated embodiment, system 2000 is owned by the owner of a website (black boxed) which is accessed by a content creator. However in another embodiment, system 2000 may be virtually hosted, with the virtual owner website being accessed by the content creator.

In one embodiment a website built on system 2000 (virtually hosted or black-boxed) is made available to allow (non-advertisement) content creators to distribute content to be shared over the Internet (for example unified video content carrying paid-for Ads). In one embodiment, the content creator is expected to publish the content through his own resources and means (e.g., e-Mail mailing lists, personal webpage, blog, etc.) while using the technology. In an embodiment where the content creator distributes unified content including ads, the content creator may in some cases receive revenues on such distribution which combines his own (non-advertisement) content with content (that tracks impressions) related paid-for Ads.

Referring to FIG. 21, in the illustrated embodiment, in stage 2102 the content creator registers and/or logs into a “black box” or “virtual owner” website. In stage 2104 the content creator fills in a form describing the content item (in this example assumed to be a video file) to be uploaded, thus creating meta-data. The content creator submits (uploads) the form along with the content item (“uploaded content item”) to the website. In stage 2106 the website submits the uploaded content item and the meta-data (e.g. tags) to TPM 440, using user agent 442. In stage 2108, TPM 440 receives the uploaded content item and metadata. In stage 2110, TPM 440 submits the uploaded content item to CAM 450. For instance, TPM 440 may submit an interactive content comment to CAM 450 (i.e. request for outputting of results), which triggers an association attempt, for example a “Quick Hits” look-up.

In the illustrated embodiment in stage 2112, CAM 450 engages in on line association before analysis of the content item, see for example description of stage 1830. For example, the associating may include the quick hits algorithm, with quick hits determined between a relevant ad and the uploaded (non-ad) content item and/or between other non-ad content items and the uploaded content item. Continuing with the example, in some embodiments, the uploaded non-advertisement content may be divided into a portion “teaser” and the remainder of the content item (i.e. the part that was not divided out as the portion teaser), and assuming association with relevant ads, a given ad may be associated with the portion teaser or with the remainder of the uploaded content item, depending on the embodiment. In this example, in other embodiments, a portion teaser may instead be a replication of a portion of the uploaded content item, and assuming association with relevant ads a given ad may be associated with the portion teaser or with the uploaded content item, depending on the embodiment.

In the illustrated embodiment in stage 2114, CAM 450 forwards to CCM 470 the uploaded content item (or portion thereof) and associated content item(s), for example “Quick Hits” Ads resource results, to be unified into unified content. Alternatively or additionally in stage 2114, CAM 450 may forward other CAM association results to CCM 470. If unified content is to be produced, CCM 470 normalizes the file types into uniform file type and returns unified content to CAM 450, for example a composite content item (i.e. standard unified stream file) containing a plurality of content items (for example the uploaded content item or portion thereof and one or more associated content items). In some instances where there is unification with ad resources, the unified content may include the remainder of the uploaded content (i.e. the part which is not the portion teaser) and the associated ad resource(s), the portion teaser and the associated ad resources, and/or the uploaded content item and the associated ad resource(s). In some cases where appropriate, in stage 2114, CCM 470 may additionally or alternatively aggregate association results.

As an example of ad location in a unified content stream, assuming that the unified content stream includes the remaining portion of the uploaded content item and ads (after the separation out of the teaser portion), an ad may be placed before, in the middle, or after the remaining portion of the content. As another example, assuming that the unified content stream includes the entire uploaded content item and ads, an ad may be placed before, in the middle, or after the content item.

In an alternative embodiment stages 2112 and 2114 may be omitted.

In the illustrated embodiment, in stage 2116, CAM 450 forwards the uploaded content item to a re-ranking (re-match) queue using offline content analyzer 451. For example, offline content analyzer 451 may in one embodiment analyze the uploaded content item offline, for example as described for stage 1840, so that perhaps better matching may subsequently be made for the uploaded content item. This example may be relevant regardless of whether or not stages 2112 and 2114 were performed. As an alternative to the illustrated order, in some cases the analysis of the content item may wait until after method 2100 is completed or may be executed in parallel to the remainder of method 2100.

In the illustrated embodiment, in stage 2118, CAM 450 stores the (remaining portion of and/or entire) uploaded content item (converted to a standard format) and/or the resulting unified content to CSL 460 using storage interface 461. CAM 450 may also or instead store other association results in database 453. If unified content was produced, CAM 450 returns a descriptor (identifier) of the Unified Content to TPM 440 so that TPM 440 can retrieve the unified content item. If the uploaded content is stored, CAM 450 returns a descriptor of the (remaining portion and/or entire) uploaded content item so that TPM 440 can retrieve the (remaining and/or entire) content item.

Assuming that unified content was produced, in the illustrated embodiment in stage 2120, TPM 440 acknowledges the submission and provides output (for example, a link, portion teaser and/or a unified content). In stage 2122, the content creator consumes (for example watches) some or all of the unified content and possibly gets paid for the consumption. For example, the content creator may be forwarded to a presentation page where part or all of the resulting Unified Content is being played.

Assuming as in the illustrated embodiment that unified content was generated (where the unified content may includes ad(s) unified with either the remainder of the uploaded content item or with the entire content item), the content creator may be offered in stage 2124 the following items: a. Portion teaser of the full movie (as a file that can be downloaded), or b. identifiable link to a streaming media that plays the full Unified Content stream. If the content creator chooses to download the portion teaser (yes to stage 2126), then in stage 2128, TPM 440 provides the file. If not, then in stage 2130 the unified content streaming may be activated as described in method 2200 of FIG. 22.

In another embodiment, for example when unified content is not produced for an uploaded content item (assumed to be an uploaded video file), the content creator may be offered in stage 2124 the following items: a. Portion teaser of the full movie (as a file that can be downloaded) or b. identifiable link to a streaming media that plays the uploaded content item (or the remainder of the uploaded content item). If the content creator chooses to download the portion teaser (yes to stage 2126), then in stage 2128, TPM 440 provides the file. If not, then in stage 2130 the video file streaming of the full uploaded content or the remainder content may be activated as described in method 2200 of FIG. 22.

The content creator can then distribute the teaser and/or content as she wishes. In the illustrated embodiment, teasers do not carry revenue generating Ads, and thus are mostly useful as a marketing tool for the content creator. The unified content stream (for example carrying paid-for Ads) or the uploaded content item (full or remainder) can be put on a personal web page or blog, sent in an e-Mail, etc. As another example, the link may be put on a personal web page or blog, sent in an email, etc.

In some embodiments, the link provided by TPM 440 in stage 2120 in the case of production or non-production of unified content may contain an identifying token which uniquely identifies this specific “distribution campaign” (which is bound to this specific content item by this specific content creator). In one of these embodiments, the content creator can optionally ask to generate a new identifying token for this content item, so that multiple “distribution campaigns” can be tracked for a single content item. In some cases the user may wish to change the current embedded token to another or to have more than two versions of the content which could be differently distributed.

In one embodiment with a portion teaser, the link (provided in the case of production or non-production of unified content) includes an activation module and a portion teaser identifier associated with the portion teaser, rather than an identifier of the remaining or entire uploaded content, and rather than an identifier of the unified content (if produced). (Depending on the embodiment, the portion teaser identifier may be incorporated or may be separate from the activation module). The portion teaser identifier facilitates the correlation between the teaser portion and the remaining portion of the content item, or between the teaser portion and the entire uploaded content item. In this embodiment, TPM 440 provides a link including the activation module and portion teaser identifier to the content creator in stage 2120. The content creator may then distribute the link as he wishes. The activation module, when triggered, transmits the portion teaser identifier to the system (in stage 2202).

FIG. 22 completes FIG. 21 whereas once the content creator has distributed the link, the content item (or remaining portion) can be consumed separately and/or within the unified content depending on the embodiment. FIG. 22 illustrates a method 2200 which occurs when the unified content (including inter-alia the remaining portion or the entire uploaded content item) or the uploaded content item (entire or remaining portion) is requested to be streamed, according to an embodiment of the present invention. For example in the case that the unified content or uploaded content item is a video, the video may be played using an external media player or an internal website embedded player.

In the illustrated embodiment in stage 2202 a website or any other host (e.g. email) submits an identifiable token to TPM 440 using hosting user agent 442, thereby requesting the streaming of the corresponding unified content or the uploaded content item. TPM 440 locates the original content item context. For example, the identifiable token can be an identifier of the unified content, an identifier of the uploaded content item, an identifier of the portion teaser or any other identifier which can be processed by the system to perform method 2200. In an embodiment where the identifier is of the portion teaser, the request for the streaming of the corresponding unified content or the uploaded content item can relate to streaming the entire or remaining portion of the uploaded content item, separately or within the unified content, depending on the embodiment.

In the illustrated embodiment in stage 2204, TPM 440 forwards the request to CAM online content manager 452. For example, TPM 440 may ask CAM online content manager 452 for a descriptor for a Unified Content stream containing the (entire or remaining portion of the) uploaded content item (e.g. video file) or for a descriptor for the (entire or remaining portion of the) uploaded content item (e.g. video file). CAM online content manager 452 searches for a compatible descriptor among the unified content or uploaded content items stored in CSL 460. For example, the allocation of the compatible Unified Content may be done using a sophisticated caching mechanism that dynamically decides what content should be better available than others. In this example, furthermore, the exact retrieval algorithm matches the compatible Unified Content according to the compatible embedded code.

In the illustrated embodiment in stage 2206, once the descriptor is located for the unified content or uploaded content item, CAM online content manager 452 tries to improve the association for the uploaded content item which had been previously analyzed in stage 2116—see for example the description of stage 1860 and/or 1864. Depending on the embodiment the association for the uploaded content item may be with ad and/or non-ad content. In stage 2208, CCM 470 is deployed to normalize the file types of the new match (for example video file and ad(s)) into a unified content type (i.e. to create a standard unified stream file). In some cases, production of a unified content stream may instead be deferred until the new match is verified. Additionally or alternatively, CCM 470 may in some cases aggregate CAM association results in stage 2208. In another embodiment, stages 2206 and 2208 are omitted.

In the illustrated embodiment, in stage 2210, CAM 450 engages in a validation attempt, for example to verify the current match-rank of the associated content from stage 2206 or 2208 according to the standard deviation. In stage 2212, as part of the verification it is determined whether the current rank is below the standard deviation. If yes, then in stage 2214, CAM online content manager 452 tries again to improve the matching for the content item. In stage 2216, CCM 470 is deployed to create a standard unified stream file and/or to aggregate results.

In the illustrated embodiment, if the current rank is not below the standard deviation, then stages 2214 and 2216 are omitted.

In an alternative embodiment where stages 2206 and 2208 are omitted, stage 2210 instead refers to CAM 450 engaging in a validation attempt of the associated content from stage 2112 or 2114, for example to verify the current match-rank according to the standard deviation.

In an alternative embodiment where verification is not performed, stages 2210 to 2216 are omitted and stage 2218 directly follows after stage 2208 or 2204.

Assuming unified file production, in the illustrated embodiment in stage 2218 CAM 450 sends the unified file (from stage 2208 or 2216 depending on the outcome of the verification) to CSL 460. In stage 2220, CAM 450 returns a descriptor of the unified file (produced in stage 2114, 2208, or 2216, depending on the embodiment) to TPM 440. In stage 2222, TPM 440 retrieves the unified stream corresponding to the descriptor from CSL 460 and streams the unified stream (for example using streaming module 490) through the website or other host. In an embodiment with the portion teaser identifier, the unified stream, for example can include inter-alia the entire or remaining portion of the content item.

In another embodiment where a unified file is not produced, stage 2218 and 2220 may be omitted. In this embodiment in stage 2222, TPM 440 retrieves the uploaded file, streams the entire or remaining portion of the uploaded file (for example using streaming module 490), and outputs an indication of associated content (for example the associated content item(s) or aggregated list(s) of associated content item(s) possibly with link(s) to the associated content item(s)) through the website or other host.

In some embodiments, method 2100 and/or 2200 may include less, more and/or different stages than illustrated in FIGS. 21 and 22 respectively, and/or stages may be performed in a different order. In other embodiments, additionally or alternatively, stages shown as sequential may be performed in parallel and/or vice versa.

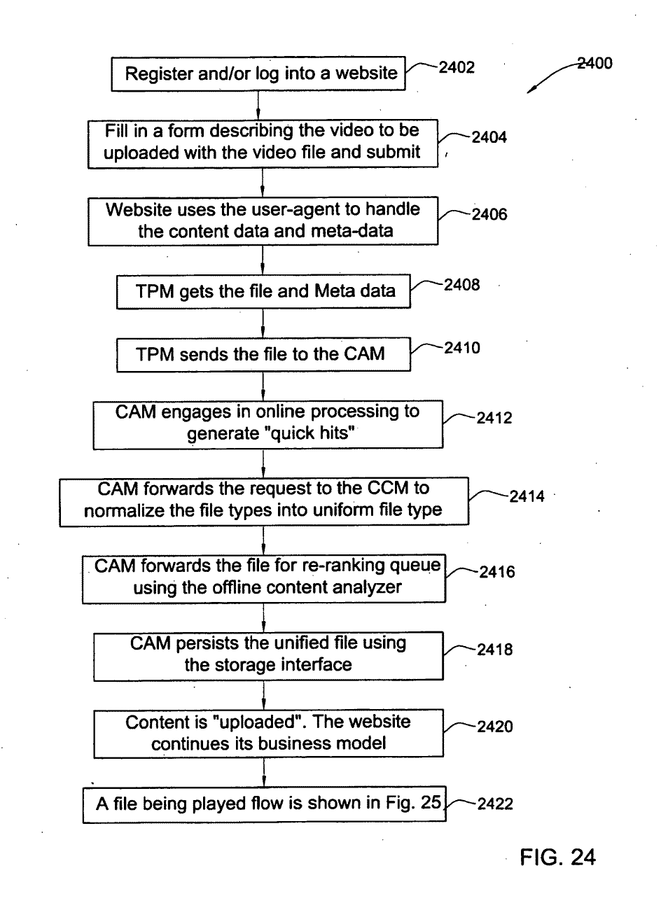

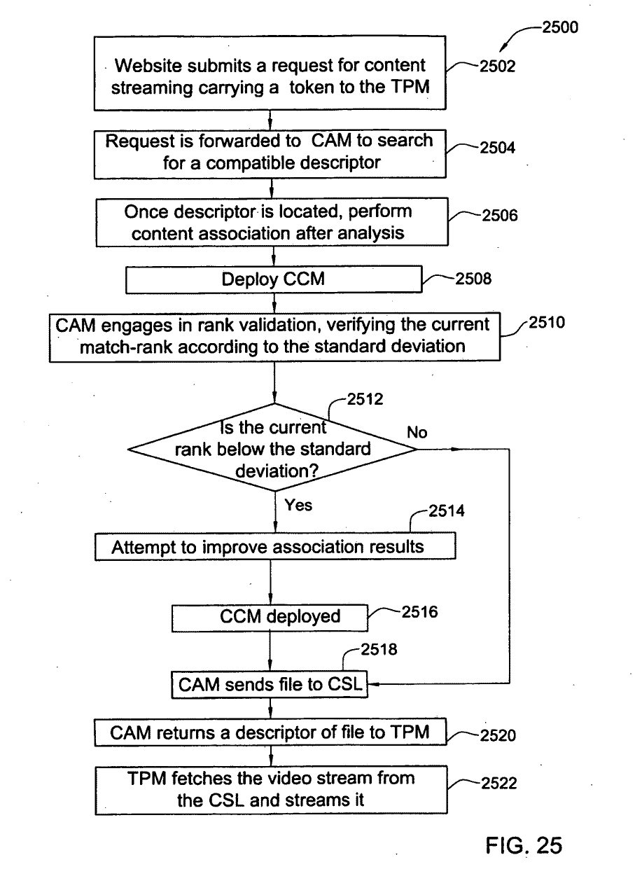

Turning now to FIG. 23, FIG. 23 illustrates a system architecture 2300 that is a variation of system 400 and that is utilized in accordance with certain mode of operation of configuration 1.4, in accordance with an embodiment of the invention. In accordance with one embodiment, FIG. 24 illustrates a flow diagram of a sequence of operations, in accordance with the system architecture 2300 of FIG. 23, and FIG. 25, illustrates yet another flow diagram of a sequence of operations, related to FIG. 24, in accordance with the system architecture of FIG. 23. Methods 2400 and 2500 of FIGS. 24 and 25 correspond to one implementation of method 1800.

More specifically, FIG. 23 elaborates on the system architecture and FIGS. 24 and 25 elaborate on two related flow figures. In architecture 2300, as opposed to architecture 2000 a content creator is not in charge of the distribution and the system does not need to support this kind of operation (as described earlier) but rather system 2300 handles the content management, the Unified Content creation (if any) and later, the actual playing within a website.

The architecture FIG. 23 details the use of layers and API or other types of interfaces compatible with the flow illustrated in FIGS. 24 and 25. This flow does not use several interfaces that were described with reference to FIG. 4 and may or may not use WTM 430. As illustrated in FIG. 23 system 2300 includes TPM 440 (which includes user agent 442), CAM 450 (including offline content analyzer 451 and online content manager 452), databases 453, CCM 470 (including composition handler 471), CSL 460 (including storage interface 461), and streaming module 490. System 2300 hosts, manages and streams the content for the website, in accordance with certain embodiments of the invention. In the illustrated embodiment, system 2300 is virtually hosted by the website. However in another embodiment system 2300 may be owned by the owner of the website (black boxed).

FIGS. 24 and 25 are flow diagrams illustrating the usage of the layers and/or interfaces in FIG. 23 taking an active part in the flow, and the correlation between these layers/interfaces. In particular, FIGS. 24 and 25 explain how a content creator can give away his content to a website using system 2300, for instance a content creator can upload his content to YouTube™, Google Video™ MySpace.com™ or any other website which owns or is a virtual owner of system 2300. In this example, system 2300 will receive and sophisticatedly manage the content, possibly immediately create a “Quick Hit” match (for example with a compatible ad) and possibly further analyze the ranking of that matching for later improvement.

In method 2400 and 2500 of FIGS. 24 and 25 respectively, it is assumed for the sake of example that the content creator is participating in a content sharing community website. In this example, the website can be implemented using the system (virtually hosted or black-boxed) including optionally WTM 430 technology, services and solutions. In this example, the website may own system 2300 or may have a contract with a system owner to provide such services (i.e. may be a virtual owner). For example, assuming that system 2300 includes WTM 430, the content creator may have several resources available on a personal login basis, such as a “movies that I uploaded” page, in addition to web-site wide content pages that follow categories, tagging or allow search for content.

Referring to FIG. 24, in the illustrated embodiment in stage 2402, a content creator registers and/or logs in to a black box or virtual owner website, to use the system services (optionally including WTM services). In stage 2404, the content creator fills in a form describing the content item (in this example assumed to be a video file) to be uploaded, thus creating meta-data. The content creator then submits (uploads) the form along with the content item (“uploaded content item”) to the website. In stage 2406, the website submits the uploaded content item and the meta-data (e.g. tags) to TPM 440, using user agent 442. In stage 2408, TPM 440 receives the uploaded content item and metadata. In stage 2410, TPM 440 submits the uploaded content item to CAM 450. For example, TPM 440 may submit an interactive content comment to CAM 450 (i.e. request for outputting of results), which triggers an association attempt, for example “Quick Hits” look-up.

In the illustrated embodiment in stage 2412, CAM 450 engages in on line association before analysis of the content item—see for example description of stage 1830. For example, the associating may include the quick hits algorithm, with quick hits determined between a relevant ad and the uploaded non-ad content item or between other non-ad content items and the uploaded content item. In stage 2414, CAM 450 forwards to CCM 470, the uploaded content item and associated content items, for example “Quick Hits” Ads resource results, to be unified into unified content. Alternatively or additionally, in stage 2414 CAM 450 may forward other CAM association results to CCM 470. If unified content is to be produced, CCM 470 normalizes the file types into uniform file type and returns unified content to CAM 450, in this case a composite video file (i.e. standard unified stream file) containing a plurality of content items. In some cases, CCM 470 may additionally or alternatively aggregate association results. In another embodiment, stages 2412 and 2414 may be omitted and offline analysis (stage 2416) may follow directly after stage 2410.

In stage 2416, CAM 450 forwards the uploaded content item to a re-ranking (re-match) queue using offline content analyzer 451. For example, offline content analyzer 451 may in one embodiment analyze the uploaded content item offline (see for instance the description of stage 1840) so that perhaps better matching may subsequently be made for the uploaded content item. This example may be relevant regardless of whether or not stages 2412 and 2414 were performed. As an alternative to the illustrated order, in some cases the analysis of the content item may wait until after method 2400 is completed or may be executed in parallel to the remainder of method 2400.

In the illustrated embodiment in stage 2418, CAM 450 stores the uploaded content item (converted to a standard format) and/or the resulting unified content to CSL 460 using storage interface 461. CAM 450 may also or instead store other association results in database 453. If unified content was produced, CAM 450 returns a descriptor (identifier) of the Unified Content to TPM 440 so that TPM 440 can retrieve the unified content item. If the uploaded content is stored, CAM 450 returns a descriptor of the uploaded content item so that TPM 440 can retrieve the content item.

In the illustrated embodiment in stage 2420, the unified content (if any) and/or standardized uploaded content item is uploaded to the website (actually persisted at streaming module 490). The website can continue its business model, for example putting the newly available unified content and/or uploaded content item in the front page as “just uploaded”. In one embodiment, the content creator is forwarded to the creator's personal webpage where the new content item is available, as well as older items. The new item can be previewed in stage 2422 by the content creator or by other users of the website as described in method 2500 of FIG. 25. For example, assuming unified content with ad(s) is generated, older items on the web site may have pre-generated Ads composed in (i.e. ads that were associated to the content item by the website and not by system 2200), whereas newer items on the website which benefited from system 2200 matching may have ads resulting from the association of stage 2412 (e.g. “Quick Hits”) or improved matching results composed in the unified content.

FIG. 25 completes FIG. 24 whereas once method 2400 has been executed, content can be played within the website. How the system handles the streaming is illustrated in flow 2500 of FIG. 25.

In the illustrated embodiment, in stage 2502 a user (content consumer) browses the website for content, and attempts to consume (e.g. view) the uploaded content item. The website therefore submits a content streaming request with an identifiable token to TPM 440 using hosting agent 442. (For example the identifiable token can be an identifier of the unified content or an identifier of the uploaded content item). TPM 440 locates the original content item context. In stage 2504, TPM 440 forwards the request to CAM online content manager 452. For example, TPM 440 may ask CAM online content manager 452 for a descriptor for a Unified Content stream containing the uploaded content item or for a descriptor for the uploaded content item. CAM online content manager 452 searches for a compatible descriptor among the unified content or uploaded content items stored in CSL 460. For example, the allocation of the compatible Unified Content may be done using a sophisticated caching mechanism that dynamically decides what content should be better available than others. In this example, furthermore the exact retrieval algorithm matches the compatible Unified Content according to the compatible embedded code.

In the illustrated embodiment in stage 2506, once the descriptor is located for the unified content or uploaded content item, CAM online content manager 452 tried to match or improve matching for the uploaded content item which has been previously analyzed in stage 2416—see for example description of stage 1860 and/or 1864. Depending on the embodiment the matching for the uploaded content item may be with ad and/or non-ad content. In stage 2508, CCM 470 is deployed to normalize the file types of the new match (for example video file and ad(s)) into a unified content type (i.e. to create a standard unified stream file). In some cases, production of a unified content stream may instead be deferred until the new match is verified. Additionally or alternatively, CCM 470 may in some cases in stage 2508 aggregate CAM association results. In another embodiment, stages 2506 and 2508 are omitted.

In the illustrated embodiment, in stage 2510, CAM 450 engages in a validation attempt, for example to verify the current match-rank of the associated content from stage 2506 or 2508 according to the standard deviation. In stage 2512, as part of the verification it is determined whether the current rank is below the standard deviation. If yes, then in stage 2514, CAM online content manager 452 tries again to improve the matching for the content item. In stage 2516, CCM 470 is deployed to create a standard unified stream file and/or to aggregate results.

In the illustrated embodiment, if the current rank is not below the standard deviation, then stages 2514 and 2516 are omitted.

In an alternative embodiment where stages 2506 and 2508 are omitted, stage 2510 instead refers to CAM 450 engaging in a validation attempt of the associated content from stage 2412 or 2414, for example verification of the current match-rank according to the standard deviation.

In another embodiment where verification does not take place, stages 2510 to 2516 may be omitted with stage 2518 directly following after stage 2508 or 2504.

Assuming unified file production, in the illustrated embodiment in stage 2518 CAM 450 sends the unified file (from stage 2508 or 2516 depending on the outcome of the verification) to CSL 460. In stage 2520, CAM 450 returns a descriptor of the unified file (produced in stage 2414, 2508 or 2516, depending on the embodiment) to TPM 440. In stage 2522, TPM 440 retrieves the unified stream corresponding to the descriptor from CSL 460 and streams the unified stream (for example using streaming module 490) through the website.

In another embodiment where a unified file is not produced, stage 2518 and 2520 may be omitted. In this embodiment in stage 2522 TPM 440 retrieves the uploaded content item, streams the uploaded content item (for example using streaming module 490), and outputs an indication of the association content (for example the associated content item(s) or aggregated list(s) of associated content item(s) possibly with link(s) to the associated content item(s)) through the website.

In some embodiments, method 2400 and/or 2500 may include less, more and/or different stages than illustrated in FIGS. 24 and 25 respectively, and/or stages may be performed in a different order. In other embodiments, additionally or alternatively, stages shown as sequential may be performed in parallel and/or vice versa.

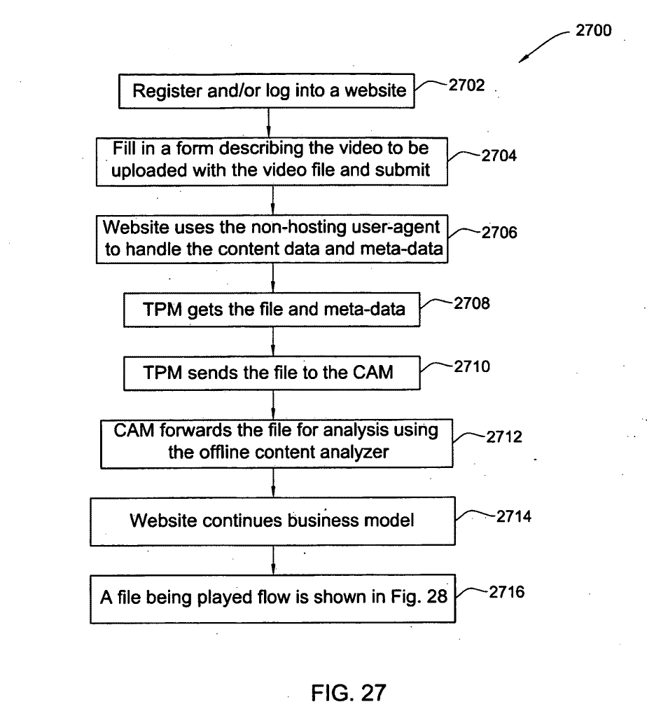

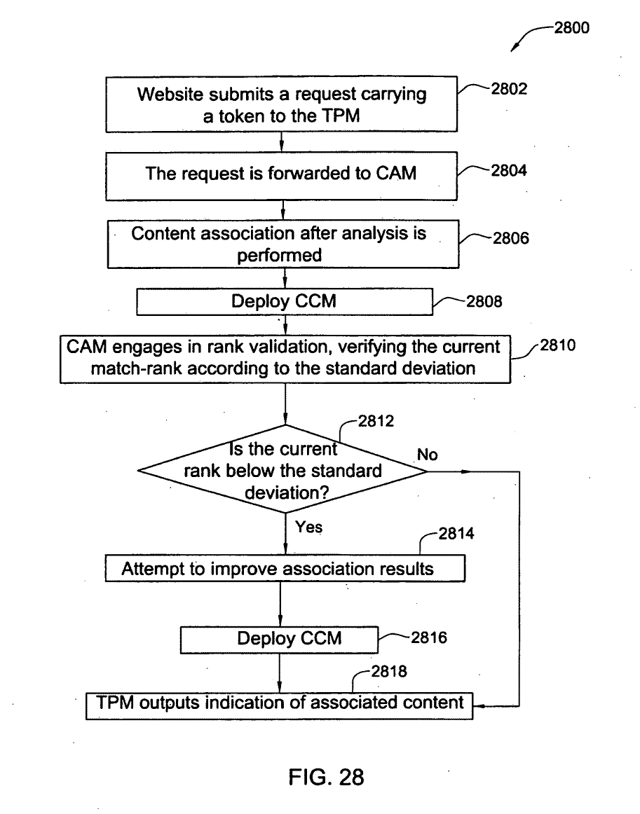

FIG. 26 illustrates a system architecture 2600 that is a variation of system 400 and that is utilized in accordance with certain mode of operation of configuration 1.8, in accordance with an embodiment of the invention. In accordance with one embodiment, FIG. 27 illustrates a flow diagram of a sequence of operations, in accordance with the system architecture 2600 of FIG. 26, and FIG. 28, illustrates yet another flow diagram of a sequence of operations, related to FIG. 27, in accordance with the system architecture of FIG. 26. Methods 2700 and 2800 of FIGS. 27 and 28 correspond to one implementation of method 1800.

More specifically, FIG. 26 elaborates on the system architecture and FIGS. 27 and 28 elaborate on two related flow figures. In architecture 2600, as opposed to architecture 2300, the system does not host or stream the content.

The architecture FIG. 26 details the use of layers and API or other types of interfaces compatible with the flow illustrated in FIGS. 27 and 28. This flow does not use several interfaces that were described with reference to FIG. 4, CSL 460, nor streaming module 490, and may or may not use WTM 430. As illustrated in FIG. 23 system 2600 includes TPM 440 (which includes non-hosting user agent 443), CAM 450 (including offline content analyzer 451 and online content manager 452), databases 453, and CCM 470 (including composition handler 471). In the illustrated embodiment, system 2600 is virtually hosted by a website. However in another embodiment, system 2600 may be owned by the owner of the website (black-boxed).

FIGS. 27 and 28 are flow diagrams illustrating the usage of the layers and/or interfaces in FIG. 26 taking an active part in the flow, and the correlation between these layers/interfaces. In particular, FIGS. 27 and 28 explain how a content creator can give away his content to a website using system 2600, for instance a content creator can upload his content to YouTube™, Google Video™ MySpace.com™ or any other website which owns or is a virtual owner of system 2600.

In method 2700 and 2800 of FIGS. 27 and 28 respectively, it is assumed for the sake of example that the content creator is participating in a content sharing community website. In this example, the website can be implemented using the system (virtually hosted or black-boxed) including optionally WTM 430 technology, services and solutions. In this example, the website may own system 2600 or may have a contract with a system owner to provide such services (i.e. may be a virtual owner). For example, assuming that system 2700 includes WTM 430, the content creator may have several resources available on a personal login basis, such as a “movies that I uploaded” page, in addition to web-site wide content pages that follow categories, tagging or allow search for content.

Referring to FIG. 27, in the illustrated embodiment in stage 2702, a content creator registers and/or logs in to a black box or virtual owner website, to use the system services (optionally including WTM services). In stage 2704, the content creator fills in a form describing the content item (in this example assumed to be a video file) to be uploaded thus creating meta-data. The content creator then submits (uploads) the form along with the content item (“uploaded content item”) to the website. In stage 2706, the website submits the uploaded content item and the meta-data (e.g. tags) to TPM 440, using non-hosting user agent 443. In stage 2708, TPM 440 receives the uploaded content item and metadata. In stage 2710, TPM 440 submits the uploaded content item to CAM 450.

In one embodiment CAM 450 then engages in on-line association before analysis of the content item—see for example description of stage 1830. For example the associating may include the quick hits algorithm, with quick hits determined between a relevant ad and the uploaded non-ad content item or between other non-ad content items and the uploaded content item. In this embodiment, CCM 470 may then be deployed, for example to aggregate association results. However in the illustrated embodiment, it is assumed that CAM omits on-line (pre-analysis) associating and proceeds directly to offline analysis of the uploaded content item in stage 2712 using offline content analyzer 451—see for example description of stage 1840. As an alternative to the illustrated order, in some cases the analysis of the content item may wait until after method 2700 is completed or may be executed in parallel to the remainder of method 2700.

In stage 2714, the website continues its business model, for example putting the newly available content item which has been uploaded to the website in the front page as “just uploaded”. In one embodiment, the content creator is forwarded to the creator's personal webpage where the new content item is available as well as older items. The new item can be previewed in stage 2716 by the content creator or by other users of the website as described in method 2800 of FIG. 28.

FIG. 28 completes the first one whereas once method 2700 has been executed, content can be played within the website. How the system handles this playing is illustrated in flow 2800 of FIG. 28.

In the illustrated embodiment, in stage 2802 a user (content consumer) browses the website for video content, and attempts to consume (e.g. view) the content item. The website therefore uses non-hosting agent 443 to submit a request for association results, identifying the requested content item (for example with an identifiable token corresponding to the uploaded content item), to TPM 440. TPM 440 locates the original content item context. In stage 2804, TPM 440 forwards the request to CAM online content manager 452.

In the illustrated embodiment in stage 2806, CAM online content manager 452 tried to match or improve matching for the video file which has previously been analyzed in stage 2712—see for example description of stage 1860 and/or 1864. Depending on the embodiment the matching for the uploaded content item may be with ad and/or non-ad content. In stage 2808, CCM 470 is deployed to aggregate CAM association results.

In the illustrated embodiment, in stage 2810, CAM 450 engages in a validation attempt, for example to verify the current match-rank according to the standard deviation. In stage 2812, as part of the verification it is determined whether the current rank is below the standard deviation. If yes, then in stage 2814, CAM online content manager 452 tries again to improve the matching for the content item. In stage 2816, CCM 470 is deployed to aggregate results.

In the illustrated embodiment, if the current rank is not below the standard deviation, then stages 2814 and 2816 are omitted.

In an alternative embodiment where stage 2806 and 2808 are omitted, stage 2810 instead refers to CAM 450 engaging in a validation attempt of the associated content determined prior to stage 2802 (for example in an offline manner).

In another embodiment where verification does not take place stages 2810 to 2816 may be omitted with stage 2818 directly following after stage 2808 (or directly following stage 2804 in cases where stages 2806 and 2808 were omitted).

In the illustrated embodiment, in stage 2818, TPM 440 outputs an indication of the associated content (for example the associated content item(s) or aggregated list(s) of associated content item(s) possibly with link(s) to the associated content item(s)) through the website.

In some embodiments, method 2700 and/or 2800 may include less, more and/or different stages than illustrated in FIGS. 27 and 28 respectively, and/or stages may be performed in a different order. In other embodiments, additionally or alternatively, stages shown as sequential may be performed in parallel and/or vice versa.

Turning now to FIG. 29, FIG. 29 illustrates a system architecture 2900 that is a variation of system 400 and that is utilized in accordance with certain mode of operation of configuration 1.2, in accordance with an embodiment of the invention. FIG. 30 illustrates a flow diagram of a sequence of operations in accordance with the system architecture of FIG. 29. Method 3000 of FIG. 30 corresponds to one implementation of method 1800.

More specifically, FIG. 29 elaborates on the system architecture and FIG. 30 elaborates on a related flow figure. The architecture of FIG. 29 details the use of layers and API or other types of interfaces compatible with the described scenario, i.e. advertiser launching an advertisement campaign. This scenario does not use the WTM layer and several interfaces that were described with reference to FIG. 4. As illustrated in FIG. 29 system 2900 includes TPM 440 (which includes user agent 442), CAM 450 (including offline content analyzer 451 and online content manager 452), databases 453, CCM 470 (including composition handler 471), CSL 460 (including storage interface 461), and streaming module 490. In the illustrated embodiment, system 2900 is owned by the owner of a website (black boxed) which is accessed by an advertiser. However in another embodiment, system 2900 may be virtually hosted, with the virtual owner website being accessed by the advertiser.

FIG. 30 is a flow diagram illustrating the usage of the layers and/or interfaces in FIG. 29 taking an active part in the flow, and the correlation between these layers/interfaces. More specifically, FIG. 30 explains the flow of an advertiser wanting to benefit from the system ad to non-ad content coupling capabilities.

In accordance with certain embodiments, the advertiser will log in, explain his campaign needs and later receive reports presenting the results (for instance what the exposure is and/or costs of the campaign). In these embodiments, the advertiser participates using his Ads within a website using the system (virtually hosted or black-boxed). In these embodiments, the advertiser holds several Ads resources and by using the system technology the advertiser can construct new advertising-campaigns while supplying the actual ad-files, meta-data, locking-in the Distribution Channels that the campaign should participate with or and/or on the contrary locking-out Distribution Channels that the campaign should not be participating. In some cases, the system technology offers a run-time management reports and tools for the advertiser to monitor the campaign progress and syndication outputs.

In accordance with certain embodiments, advertisers can create online and automatic campaigns where they should set the campaign parameters (for instance starting date, hours, opt-in and opt-out several video fields, price per watch, price per click and more). Once the campaign was constructed it can go to an approval sequence and once approved, the technology will initiate the online mechanism for coupling the ad with non-ad content.

In the illustrated embodiment, in stage 3002, the advertiser registers and/or logs into a “black box” or virtual owner website. Optionally, the website approaches the system to retrieve a list of active and fully managed distribution channels.

In the illustrated embodiment, in stage 3004, the advertiser submits a request to start a new campaign while delivering (uploading) the actual ad-file(s), the Meta data describing the ad(s), and/or locking in/out the relevant distribution lists. For example, the advertiser may in some cases fill in a form describing the campaign information (e.g. dates, locked-in/locked-out distribution channels) and/or the actual ad file to be uploaded, thereby creating meta-data.

In the illustrated embodiment, in stage 3006, the website uses user agent 442 to submit the ad file and the meta-data (e.g. tags) to TPM 440, for a quick hit matching with non-advertisement content. The advertiser will thereby be able to get an immediate feel for how a matching algorithm works.

In the illustrated embodiment in stage 3008, TPM 440 receives the file and meta data. In the illustrated embodiment in stage 3010, TPM 440 submits an interactive Ads content comment to CAM 450 (i.e. a request for outputting of results), which triggers a “Quick Hits” lookup for compatible non-advertisement content.

In the illustrated embodiment in stage 3012, CAM 450 engages in on-line processing to generate quick hits with non-advertisement content—see for example description of stage 1830. In stage 3014, CAM 450 submits the advertisement file and the “Quick Hits” content resource result to CCM 470. CCM 470 normalizes the file types into uniform file type and returns unified content to CAM 450, for example a composite video file (i.e. standard unified stream file) containing a plurality of content items. In some cases, additionally or alternatively, CCM 470 may aggregate association results. In one embodiment, CAM 450 forwards advertisement file to a re-ranking (re-match) queue using offline content analyzer 451. For example, offline content analyzer 451 may in one embodiment analyze the advertisement offline—see for example description of stage 1840, so that perhaps better matching may subsequently be made for the uploaded advertisement. In another embodiment, offline content analyzer 451 is not deployed or is deployed at a later stage (for example after method 3000 has been completed or in parallel with the remainder of method 3000).

In the illustrated embodiment, in stage 3016 CAM 450 stores the advertisement item (converted to a standard format) and optionally the unified content in the CSL 460 using storage interface 461. CAM 440 returns a descriptor of the ad file to TPM 440 so that TPM 440 can retrieve the ad file. If unified content was stored, CAM 450 returns a descriptor for the unified content to TPM 440 so that TPM 440 can retrieve the unified content.

In the illustrated embodiment, in stage 3018, TPM 440 acknowledges the submission and provides the quick hit unified content for the viewing of the advertiser. For example, the advertiser may be forwarded to the advertiser's personal page where the new Ads are composite with certain relevant content as a presentation of the technology capabilities.

In various embodiments, the advertiser can subsequently request any of the following: updated matching of the ad after the initial matching process of method 3000, for example associating as in the description of stage 1860 and/or 1864 (assuming post analysis association is desired), subsequent unification of content and/or aggregation of association results. In other embodiments, the advertiser cannot request subsequent actions, and subsequent matching of the ad occurs when a match for a non-advertisement content item is sought.

In one embodiment, the optional offline analysis of the advertisement item, if executed, may allow improved matching the next time matching for that ad is requested (or when a matching ad is sought for non-advertisement content).

In some embodiments, method 3000 may include less, more and/or different stages than illustrated in FIG. 30, and/or stages may be performed in a different order. In other embodiments than illustrated, additionally or alternatively, stages shown as sequential may be performed in parallel and/or vice versa.

Turning now to FIG. 31, FIG. 31 illustrates a system architecture 3100 that is a variation of system 400 and that is utilized in accordance with certain mode of operation of configuration 1.5, in accordance with an embodiment of the invention. FIG. 32 illustrates a flow diagram of a sequence of operations in accordance with the system sub-architecture of FIG. 31. Method 3200 of FIG. 32 corresponds to one implementation of FIG. 18.

More specifically, FIG. 31 elaborates on the system architecture layers and API interfaces which participate in a non-hosting flow where the system transforms the contents of an item source at a website into Unified Content. FIG. 32 elaborates on a related flow figure for requesting transformation into unified content. In contrast with system 2300, system 3100 does not manage the content (for example, non-advertisement content, Ads, streaming upon request, etc.) for a given website in order to provide unified content transformation.

In the illustrated embodiment, system 3100 does not provide the website with hosting, managing, streaming and external services. As illustrated in FIG. 31, system 3100 includes a transaction processing module TPM (including non-hosting user agent 443 and reporting 444), a content analysis module 450 (including offline content analyzer 451 and online content manager 452), inner databases 453, and content composition module 470 (including composition handler 471). Optionally, system 3100 may also include CSL 460 (including storage interface 461), and streaming module 490. In the illustrated embodiment, system 3100 is owned by the owner of a website (black boxed) which services the website with the item source (in this example, the client). However in another embodiment, system 3100 may be virtually hosted, with the virtual owner website servicing the client.

In one embodiment, system 3100 (virtually hosted or black-boxed) offers its technology to a client that does not need the entire enterprise solution. In order to support such a client, system 3100 manages web-accessible transformation libraries. For example, a client may desire system services that include transforming its content to a unified content but not other services. In this example, the client, once registered with the system, could post regular content files to a private library and substantially immediately receive unified content in a different library, ready for downloads (for example, supportive of protocols such as FTP, HTTP). System 3100 may also in some cases of this example provide the rank status of the unified content so that the client will know if and when, as time goes by, the system keeps normalizing the content to reach better ranked match.

In the illustrated embodiment, the client of system 3100 will not benefit from the entire solution because system 3100 will not necessarily be able to control the rank-status of the matched unified content playing at the client's website. Instead system 3100 may in some cases just be able to put higher ranked matching Unified Content at the private library for the client to download, with the client deciding if and when to download.

In one embodiment, YouTube™ or any other website with an item source (e.g. content repository) can gradually increase its use of the technology, for example first just using the system's ability to transform content into Unified Content (as in system 3100), and later using the managing, hosting, streaming, etc capabilities of some of the other described system variants to improve its service.

In the illustrated embodiment in stage 3202, the website with the item source (in this example, the client) registers with a “black box” or virtual owner website. In stage 3204, the client posts into a private library one or more content items (assumed in this example to be a batch of content items such as a batch of video files) that needs to be transformed into unified content, and corresponding meta-data using non-hosting user agent 443. In stage 3206, the website submits the posted content and the meta-data (e.g. tags) to TPM 440, using non-hosting user agent 443. In stage 3208, TPM 440 uses non-hosting user agent 443 to receive the content and meta data correlated to the uploading website and save the content into a private library profile, for example at CSL 460 or at an external service managed by the website.

In the illustrated embodiment, in stage 3210, TPM 440 submits the received content to CAM 450. For example, TPM 440 may submit an interactive content comment to CAM 450 (i.e. request for outputting of results), which triggers an association attempt, for example a “Quick Hits” lookup. In stage 3212, CAM 450 engages in association before analysis of each content item—see for example description of stage 1830. For example the associating may include the quick hits algorithm with quick hits determined between relevant ads and the content from the client or between various content items from the client. In stage 3214 CAM 450 forwards the received content and the corresponding “Quick Hits” content resource results to CCM 470. CCM 470 normalizes the files types into uniform file type and returns unified content file(s) to CAM 450. For example, assuming a batch of content items were submitted, a plurality of composite content files may be returned. In some cases, CCM 470 additionally and/or alternatively may aggregate association results.

In another embodiment, if any content items submitted by the client in stage 3204 were also previously submitted and analyzed, in stage 3210, CAM 450 may engage in post analysis association for those content items (see for example description of stage 1860 and/or 1864) in order to generate matches which can be used by CCM 470 to generate unified content in stage 3214 and/or for association result aggregation.

In the illustrated embodiment in stage 3216, CAM 450 forwards the content to a re-match queue using offline content analyzer 451. For example, offline content analyzer may in one embodiment analyze the content received from the client (see for example description of stage 1840) and/or attempt one or more times after the analysis to improve the matching (see for example description of stage 1860 and/or 1864), passing the improved matches to CCM 470 to produce better-matching unified content and/or result aggregation. In this example, additional matching attempts may or may not be subject to whether verification deemed the previous results unsatisfactory. In another embodiment, offline content analyzer may in stage 3216 only analyze the content received from the client (and not try to improve the matching). In this embodiment, the analysis can be used in matching the content items if the items are again submitted by the client for transformation. As an alternative to the illustrated order, in some cases the analysis and/or subsequent matching attempt(s) for the received content may wait until after method 3200 is completed or may be executed in parallel to the remainder of method 3200.

In the illustrated embodiment, in stage 3218, CAM 450 stores the Unified Content to the CSL 460, using storage interface 461. CAM 450 returns descriptor(s) of the unified content file(s) to TPM 440. In stage 3220, TPM 440 acknowledges the submission of the content from the client and transfers a first version of the unified content to a different private library (i.e. a different library than where the content was posted in stage 3204). For example, TPM 440 may set a new library that points to the unified content file(s) and may provide an identifier (e.g. URI) for downloading the unified content to the client. The client can now download the unified content files, for example from CSL 460. In stage 3222, assuming the unified content files were placed at the online library with matching rank percentage, the client website can check the status and decide whether to download or wait for better ranking (in later association attempts). In stage 3224, once the client website has downloaded the unified content files, the client website may use reporting 444 to report to system 3100. For example, assuming the unified content includes ads, the client website may display the unified content at the website and report to system 3100 in order to claim revenues for playing the ads.

In some embodiments, method 3200 may include less, more and/or different stages than illustrated in FIG. 32, and/or stages may be performed in a different order. In other embodiments than illustrated, additionally or alternatively, stages shown as sequential may be performed in parallel and/or vice versa.

In accordance with certain embodiments, content is made available for distributors over customized syndication channels by the system (e.g. system 400 or a variation thereof). One or more distribution Channels (“Distribution Channel”) may be created for the use of distributors by a system owner, virtual owner or a distributor using a variety of system functions that allow for example, filtering, sorting and/or merging of content meta-data generated from CAM 450 as well as (non-advertisement) content creator-centric or advertiser-centric requests that are supported by the system. In some cases, distribution channels may be used to partition the content of a virtual owner or black box website and to distribute all or part of the content through other websites (“distributor websites), for example as unified content including ad or non-ad associated content. In some of these embodiments, advertisers or (non-advertisement) content creators can be allowed to lock-out or lock-in certain Distribution Channels, based on external criteria (such as business contracts), or Distribution Channels can be locked-in (or locked-out) by a system owner or virtual owner.

Turning now to FIG. 33, FIG. 33 illustrates a system architecture 3300 that is a variation of system 400 and that is utilized in accordance with certain mode of operation of configuration 1.6, in accordance with an embodiment of the invention. FIG. 34 illustrates a flow diagram of a sequence of operations in accordance with system architecture 3300 of FIG. 33. FIG. 34 corresponds to one implementation of method 1800.

More specifically, FIG. 33 elaborates on a system architecture where system 3300 manages the content, and FIG. 34 elaborates on an online related flow of a distributor website requesting and getting content fitting its criteria from the system (where content selected in accordance with certain requested criteria is termed a distribution channel). The architecture of FIG. 33 details the use of layers and API or other types of interfaces compatible with the described scenario, i.e. compatible with the system selecting content that fits the criteria of a distributor website and the system streaming the selected content (i.e. the distribution channel) to the distributor website. (In this scenario, the distributor website is a website that streams a distribution channel). For instance a news website can request that system 3300 automatically streams content fitting the news criteria. In some cases where the unified content includes advertisements, the system owner or virtual owner might provide revenue to every website willing to stream such Distribution Channels.

As illustrated in FIG. 33, system 3300 does not use the WTM layer, CCM layer or several interfaces that were described with reference to FIG. 4. System 3300 includes TPM 440 (which includes user agent 442), CAM 450 (which includes online content manager 450), databases 453, CSL 460 (including storage interface 461), and streaming module 490. In the illustrated embodiment, system 3300 is owned by the owner of a website (black boxed) which services a website which distributes the distribution channel. However in another embodiment, system 3300 may be virtually owned, with the virtual owner website servicing the website which distributes the distribution channel.

In the illustrated embodiment, in stage 3402, a website which will act as a distributor of content registers with a black box or virtual owner website. In stage 3404, the distributor website may choose one or more distribution channels that exist for system 3300 and/or create one or more distribution channels. For example, the system owner or virtual owner, using functionality for categorizing, managing and/or ranking can create a distribution channel which is identified by a distribution channel identifier. As mentioned above, in some cases, distribution channels can be created automatically by analyzing the database or the web pages content and description, while for instance, spotting key words that constellate into a subject, having the potential to constitute a Distribution Channel or by configuring the system to create Distribution Channels according to some rules and criteria. In this example, the distributor website can select the existing distribution channel. As another example, a distributor can create his own private distribution channel, with the distribution channel identifier built up upon a combination of content-fields (i.e. encapsulating content fields), and the private distribution channel may perhaps be more suitable than the distribution channels currently existing at system 3300.

In the illustrated embodiment, in stage 3406, the black box or virtual owner website uses user agent 442 to retrieve content according to one or more distribution channels (for simplicity of explanation it is assumed according to one distribution channel). In stage 3408, TPM 440 requests content appropriate for the distribution channel from CAM 450. For example, TPM 440 may submit the distribution channel identifier (i.e. type of field identifier) to CAM online content manager 452, requesting file descriptors of content (e.g. unified content) appropriate for the distribution channel. Depending on the embodiment, CAM online content manager 452 may use in stage 3410 a cached list of relevant file descriptors or may create a new list of file descriptors of content to be played. In stage 3412, CAM 450 returns to TPM 440 the list of file descriptors whose content is to be streamed in the distribution channel.

In the illustrated embodiment in stage 3414, TPM 440 approaches CSL 460 with the file descriptors in order to start streaming (for example using streaming module 490) the content (for example unified content) into the distribution channel for the distributor website.

In one embodiment, a distributor website which streams a distribution channel of unified content including ads will be compensated for the streaming of the ads.

In some embodiments, method 3400 may include less, more and/or different stages than illustrated in FIG. 34, and/or stages may be performed in a different order. In other embodiments than illustrated, additionally or alternatively, stages shown as sequential may be performed in parallel and/or vice versa.

In some embodiments of the present invention for any appropriate configuration, the system (e.g. system 400 or a variation thereof) is capable of supplying entities such as advertisers and/or publishers with automatic and/or manually-configured reports, giving a statistical analysis of several aspects. For example, one report might concern the performance of the given associated content and the behaviour of consumers consuming the association results. Continuing with the example, in one embodiment the report may include aspects such as the user response-rate, the typical user demographical data (if present), and so on. The statistics can be computed over the whole existing historical data, or rather on parts of it, such as the set of all user events concerning one single advertisement or a set of advertisements.

It will also be understood that according to some embodiments of the invention the system may be a suitable programmed computer. Likewise, some embodiments of the invention contemplate a computer program being readable by a computer for executing the method of the invention. Some embodiments of the invention further contemplate a machine-readable memory tangibly embodying a program of instructions executable by the relevant apparatus for performing and executing the method and the subject matter of the invention.

The present invention has been described, with a certain degree of particularity, but those versed in the art will readily appreciate that various variations, alterations and modifications may be carried out, without departing from the scope of the above description and/or the following Claims:

1. A system for associating content, comprising:
a content analysis module configured to apply at least one technique in order to associate a first content item with at least one other content item, each at least one technique generating at least one list of at least one associated content item for said first content item; and
a content composition module configured to perform at least one action selected from a group comprising:
generating unified content including said first content item, or a part thereof, and at least one content item from at least one of said lists, or a part thereof; and
determining, based on a plurality of said lists, at least one aggregated list of at least one content item associated with said first content item.

2. The system of claim 1, wherein said first content item and said at least one other content item are each selected from a group comprising: video item, audio item, advertisement, visual item, multimedia item, game item, and rich media item.

3-10. (canceled)

11. The system of claim 1, wherein said at least one technique is selected from a group comprising: focused technique, category technique, collaborative filtering technique, associative CF technique, and quick hit technique.

12. (canceled)

13. The system of claim 1, wherein at least one technique applied by said content analysis module includes at least one action selected from a group comprising: associating at least one similar content item with said first content item, associating at least one content item with said first content item based on categories, associating at least one content item liked by a user similar to said consumer, with said first content item, and associating at least one content item which is similar to at least one other content item which said consumer liked, with said first content item.

14-18. (canceled)

19. The system of claim 1, wherein said content analysis module is further configured to analyze an event, and wherein said analyzed event is considered when applying at least one technique in order to associate a first content item with at least one other content item.

20. The system of claim 1, wherein said content analysis module is further configured to generate meta data from an analysis of said first content item by performing at least one action selected from a group comprising: enriching text corresponding to said first content item which was provided to said content analysis module, and determining at least one classification for said first content item.

21-25. (canceled)

26. The system of claim 20, wherein said analysis includes dimension reduction.

27. (canceled)

28. The system of claim 1, wherein said content analysis module is further configured to rank each association between a content item and said first content item.

29. The system of claim 28, wherein said content composition module is configured, when determining said at least one aggregated list, to perform at least one action from a group comprising:
adjusting a rank of an association by a configuration weight corresponding to a generated list which included said association, and adjusting a rank of an association, based on data selected from a group comprising: consuming patterns, consumer history, and other consumer data.

30-32. (canceled)

33. The system of claim 1, wherein said content composition module is configured to optimize a target function, with respect to at least one constraint or other criterion, when performing said at least one action.

34. The system of claim 33, wherein said optimized target function is selected from a group comprising: optimal expected response rate to an advertisement, optimal stay at a website, optimal number of items consumed, optimal average rating, and optimal satisfaction measure.

35-40. (canceled)

41. The system of claim 1, further comprising:
a transaction processing module configured to receive a request to associate content with said first content item, and to cause to be outputted at least one output selected from a group comprising: said unified content or a part thereof, an identifier for downloading said unified content or a part thereof, at least one of said aggregated lists or a part thereof, and at least one associated content item listed on at least one of said aggregated lists.

42-43. (canceled)

44. The system of claim 41, wherein said transaction processing module is further configured to perform at least one action from a group comprising: receiving notification of a new content item at a predetermined item source, receiving said new content item, receiving notification regarding an event, and sensing an event.

45-48. (canceled)

49. The system of claim 1, wherein said content analysis module is configured to apply said at least one technique by performing the following:
receiving said first content item which is a non-advertisement content item and dividing out from or replicating from said received item a teaser portion;
generating an activation module and a unique identifier associated with the teaser portion; the unique identifier facilitating correlation between the teaser portion and a remaining non-divided out portion of the received item, or between the teaser portion and the received item; and
associating an advertisement content item with the remaining portion or the received item; and
wherein said content composition module is configured to generate unified content including said advertisement content item and the remaining portion or the received item;
and wherein said system further comprises a transaction processing module configured to transmit at least the activation module and the unique identifier; and configured, in response to a triggering of said activation module, to receive said unique identifier;
wherein said content analysis module is further configured to use said unique identifier for finding said unified content.

50-52. (canceled)

53. A system for providing a distribution channel of unified content, comprising
a content storage library storing unified content files, each of which was generated from at least two separate content files;
a transaction processing module, configured to provide a request for unified content files appropriate for a distribution channel which will be distributed by a distributor website;
a content analysis module configured to receive said request and provide to said transaction module a list of descriptors of unified files appropriate for said distribution channel; and
a streaming module configured to stream said listed unified files to said distributor website.

54. The system of claim 53, wherein said request includes a descriptor of said distribution channel.

55. The system of claim 54, wherein said distribution channel descriptor is constructed from a combination of content fields.

56. A method for associating content, comprising:
(i) applying at least one technique in order to associate a first content item with at least one other content item, each at least one technique generating at least one list of at least one associated content item for said first content item; and
(ii) performing at least one action selected from a group comprising:
generating unified content including said first content item, or a part thereof, and at least one content item from at least one of said lists, or a part thereof; and
determining, based on a plurality of said lists, at least one aggregated list of at least one content item associated with said first content item.

57. A method of providing a distribution channel of unified content, comprising:
receiving a request for unified content files appropriate for a distribution channel which will be distributed by a distributor website;
determining a list of descriptors of stored unified content files appropriate for said distribution channel, wherein each of said unified content files was generated from at least two separate content files; and
streaming said listed unified files to said distributor website.

58. A program storage device readable by machine, tangibly embodying a program of instructions executable by the machine to perform a method for associating content, comprising:
applying at least one technique in order to associate a first content item with at least one other content item, each at least one technique generating at least one list of at least one associated content item for said first content item; and
performing at least one action selected from a group comprising:
generating unified content including said first content item, or a part thereof, and at least one content item from at least one of said lists, or a part thereof; and
determining, based on a plurality of said lists, at least one aggregated list of at least one content item associated with said first content item.

59. A computer program product comprising a computer usable medium having computer readable program code embodied therein for associating content, the computer program product comprising:
computer readable program code for causing the computer to apply at least one technique in order to associate a first content item with at least one other content item, each at least one technique generating at least one list of at least one associated content item for said first content item; and
computer readable program code for causing the computer to perform at least one action selected from a group comprising:
generate unified content including said first content item, or a part thereof, and at least one content item from at least one of said lists, or a part thereof; and
determine, based on a plurality of said lists, at least one aggregated list of at least one content item associated with said first content item.

60. A program storage device readable by machine, tangibly embodying a program of instructions executable by the machine to perform a method of providing a distribution channel of unified content, comprising:
receiving a request for unified content files appropriate for a distribution channel which will be distributed by a distributor website;
determining a list of descriptors of stored unified content files appropriate for said distribution channel, wherein each of said unified content files was generated from at least two separate content files; and
streaming said listed unified files to said distributor website.

61. A computer program product comprising a computer usable medium having computer readable program code embodied therein of providing a distribution channel of unified content, the computer program product comprising:
computer readable program code for causing the computer to receive a request for unified content files appropriate for a distribution channel which will be distributed by a distributor website;
computer readable program code for causing the computer to determine a list of descriptors of stored unified content files appropriate for said distribution channel, wherein each of said unified content files was generated from at least two separate content files; and
computer readable program code for causing the computer to stream said listed unified files to said distributor website.

62. The method of claim 56 further comprising:
an entity sending an input to a website which owns or virtually owns a system for associating content;
if due to said input, said system is to output association results or part thereof for a first content item, said system performing (i) and (ii), and
said entity receiving at least one selected from a group comprising: said unified content or a part thereof, an identifier for downloading said unified content or a part thereof, at least one of said aggregated lists or a part thereof, and at least one associated content item listed on at least one of said aggregated lists.

63. The method of claim 62, wherein said entity is selected from a group comprising: content consumer, advertiser, non-advertisement content creator, host, and website with item source.

64. The method of claim 62, further comprising:
if said input includes a new content item, said system analyzing said new content item, or if said input includes an event, said system analyzing said event.

65. (canceled)

66. A method of distributing a distribution channel of unified content, comprising:
a distributor website transmitting a request for unified content files which are appropriate for a distribution channel to a website which owns or virtually owns a system for providing a distribution channel of unified content;
said distributor website receiving from said system a stream of unified content files,
wherein each of said unified content files was generated from at least two separate content files and wherein said unified content files correspond to a list of descriptors of stored unified content files determined by said system to be appropriate for said distribution.

67. A method for obtaining an association result or a part thereof, comprising:
indicating a content item; and
receiving at least one association result or a part thereof selected from a group comprising: unified content or a part thereof, an identifier for retrieving unified content or a part thereof, at least one aggregated list including at least one content item associated with said indicated content item or a part thereof, and at least one associated content item listed on at last one aggregated list or a part thereof;
wherein said unified content, if existing, includes said indicated content item, or a part thereof, and at least one associated content item, or a part thereof, from at least one list generated by at least one technique applied to associate said indicated content item with at least one other content item; and
wherein said at least one aggregated list, if existing, is based on a plurality of lists generated by at least one technique applied to associate said indicated content item with at least one other content item.

68. The method of claim 67, wherein said indicating includes at least one action selected from a group comprising: providing said content item or a part thereof, making said content item or a part thereof available, consuming said content item or a part thereof, providing an identifier of said content item, providing an identifier of unified content which includes said content item or part thereof, providing an identifier of a portion teaser, and providing a field identifier for which said content item or unified content which includes said content item or a part thereof is appropriate.

69. The method of claim 67, further comprising:
providing an identifier of a current consumer of said indicated content item.

70. (canceled)

71. A system for obtaining an association result or a part thereof, comprising:
means for indicating a content item; and
means for receiving at least one association result or a part thereof selected from a group comprising: unified content or a part thereof, an identifier for retrieving unified content or a part thereof, at least one aggregated list including at least one content item associated with said indicated content item or a part thereof, and at least one associated content item listed on at last one aggregated list or a part thereof;
wherein said unified content, if existing, includes said indicated content item, or a part thereof, and at least one associated content item, or a part thereof, from at least one list generated by at least one technique applied to associate said indicated content item with at least one other content item; and
wherein said at least one aggregated list, if existing, is based on a plurality of lists generated by at least one technique applied to associate said indicated content item with at least one other content item.

72. The system of claim 71, wherein said system functions as an intermediary and provides to a user device at least one selected from a group comprising: unified content or a part thereof, an identifier for retrieving unified content or a part thereof, at least one aggregated list including at least one content item associated with said indicated content item or a part thereof, and at least one associated content item listed on at last one aggregated list or a part thereof.

73. The system of claim 71, wherein said system is comprised in at least one machine selected from a group comprising: personal computer, server, mobile telephone, and television set.

74-75. (canceled)

76. The system of claim 1, further comprising:
means for indicating said first content item; and
means for receiving at least one association result or a part thereof selected from a group comprising: said unified content or a part thereof, an identifier for retrieving said unified content or a part thereof, at least one of said aggregated lists or a part thereof, and at least one associated content item listed on at last one of said aggregated lists or a part thereof.

77. The system of claim 53, further comprising:
means in said distributor website for transmitting said request; and
means in said distributor website for receiving said listed unified content files.

78. A program storage device readable by machine, tangibly embodying a program of instructions executable by the machine to perform a method of distributing a distribution channel of unified content, comprising:
transmitting a request for unified content files which are appropriate for a distribution channel to a website which owns or virtually owns a system for providing a distribution channel of unified content;
receiving from said system a stream of unified content files, wherein each of said unified content files was generated from at least two separate content files and wherein said unified content files correspond to a list of descriptors of stored unified content files determined by said system to be appropriate for said distribution channel.

79. A computer program product comprising a computer usable medium having computer readable program code embodied therein of distributing a distribution channel of unified content, the computer program product comprising:
computer readable program code for causing the computer to transmit a request for unified content files which are appropriate for a distribution channel to a website which owns or virtually owns a system for providing a distribution channel of unified content;
computer readable program code for causing the computer to receive from said system a stream of unified content files, wherein each of said unified content files was generated from at least two separate content files and wherein said unified content files correspond to a list of descriptors of stored unified content files determined by said system to be appropriate for said distribution channel.

80. A program storage device readable by machine, tangibly embodying a program of instructions executable by the machine to perform a method for obtaining an association result or a part thereof, comprising:
indicating a content item; and
receiving at least one association result or a part thereof selected from a group comprising: unified content or a part thereof, an identifier for retrieving unified content or a part thereof, at least one aggregated list including at least one content item associated with said indicated content item or a part thereof, and at least one associated content item listed on at last one aggregated list or a part thereof;
wherein said unified content, if existing, includes said indicated content item, or a part thereof, and at least one associated content item, or a part thereof, from at least one list generated by at least one technique applied to associate said indicated content item with at least one other content item; and
wherein said at least one aggregated list, if existing, is based on a plurality of lists generated by at least one technique applied to associate said indicated content item with at least one other content item.

81. A computer program product comprising a computer usable medium having computer readable program code embodied therein for obtaining an association result or a part thereof, the computer program product comprising:
computer readable program code for causing the computer to indicate a content item; and
computer readable program code for causing the computer to receive at least one association result or a part thereof selected from a group comprising: unified content or a part thereof, an identifier for retrieving unified content or a part thereof, at least one aggregated list including at least one content item associated with said indicated content item or a part thereof, and at least one associated content item listed on at last one aggregated list or a part thereof;
wherein said unified content, if existing, includes said indicated content item, or a part thereof, and at least one associated content item, or a part thereof, from at least one list generated by at least one technique applied to associate said indicated content item with at least one other content item; and
wherein said at least one aggregated list, if existing, is based on a plurality of lists generated by at least one technique applied to associate said indicated content item with at least one other content item.
